(19) United States
(12) Patent Application Publication
(10) Pub. No.: US 2026/0231170 A1
(43) Pub. Date: Aug. 6, 2026

(54) TERMINAL APPARATUS, BASE STATION APPARATUS, AND COMMUNICATION METHOD

(71) Applicant: SHARP KABUSHIKI KAISHA, Sakai City, Osaka (JP)

(72) Inventors: Takahisa FUKUI, Sakai City, Osaka (JP); KAZUNARI YOKOMAKURA, Sakai City, Osaka (JP); Ryota MORIMOTO, SakaiCity, Osaka (JP)

(21) Appl. No.: 19/154,782

(22) PCT Filed: Oct. 27, 2023
(86) PCT No.: PCT/JP2023/038880

§ 371 Date: Aug. 7, 2025

(30) Foreign Application Priority Data
Feb. 13, 2023 (JP) 2023-019721

(51) Int. Cl. H04W 72/231; H04W 72/0446; H04W 72/0453; H04W 72/1268

(52) U.S. Cl. CPC H04W 72/231; H04W 72/0446; H04W 72/0453; H04W 72/1268

(57) ABSTRACT

A terminal apparatus includes a receiver configured to receive a PDCCH to which DCI is mapped, and a transmitter configured to transmit a first PUCCH scheduled by the DCI and transmit a second PUCCH, wherein a first PUCCH resource for the first PUCCH is indicated by the DCI, a second PUCCH resource for the second PUCCH is configured by a first higher layer parameter, first beam information applied to the first PUCCH is determined based on a value of a first CORESET pool index, second beam information applied to the second PUCCH is determined based on a value of a second CORESET pool index, the value of the first CORESET pool index corresponds to a CORESET for the PDCCH, and the value of the second CORESET pool index is provided for the second PUCCH resource.

### TECHNICAL FIELD

The present invention relates to a terminal apparatus, a base station apparatus, and a communication method.

This application claims priority to JP 2023-019721 filed on Feb. 13, 2023, the contents of which are incorporated herein by reference,

### BACKGROUND ART

In the 3^{rd} Generation Partnership Project (3GPP), a radio access method and a radio network for cellular mobile communications (hereinafter also referred to as “Long Term Evolution (LTE)” or “Evolved Universal Terrestrial Radio Access (EUTRA)”) have been studied. In LTE, a base station apparatus is also referred to as an evolved NodeB (eNodeB) and a terminal apparatus is also referred to as a User Equipment (UE). LTE is a cellular communication system in which multiple areas covered by base station apparatuses are arranged in a form of cells. A single base station apparatus may manage multiple serving cells.

The 3GPP has been studying a next generation standard (New Radio or NR) (NPL 1) to make a proposal for International Mobile Telecommunication (IMT)-2020, a standard for a next generation mobile communication system developed by the International Telecommunication Union (ITU). NR is to satisfy requirements for three scenarios including enhanced Mobile BroadBand (eMBB), massive Machine Type Communication (mMTC), and Ultra Reliable and Low Latency Communication (URLLC) in a single technology framework.

In the 3GPP, extension of services supported by NR has been studied (NPL 2 and NPL 3)

### CITATION LIST

### Non Patent Literature

NPL 1: “New SID proposal: Study on New Radio Access Technology”, RP-160671, NTT docomo, 3GPP TSG RAN Meeting #71, Goteborg, Sweden, 7 to 10 Mar. 2016.

NPL 2: “Release 17 package for RAN”, RP-193216, RAN chairman, RAN1 chairman, RAN2 chairman, RAN3 chairman, 3GPP TSG RAN Meeting #86, Sitges, Spain, 9 to 12 Dec. 2019

NPL 3: “Release 18 package summary”, RP-213469, RAN chairman, RAN1 chairman, RAN2 chairman, RAN3 chairman, 3GPP TSG RAN Meeting #94-e, 6 to 17 Dec. 2021

### SUMMARY OF INVENTION

### Technical Problem

The present invention provides a terminal apparatus that efficiently performs communication, a communication method used for the terminal apparatus, a base station apparatus that efficiently performs communication, and a communication method used for the base station apparatus.

### Solution to Problem

(1) A first aspect of the present invention is a terminal apparatus including a receiver configured to receive a PDCCH to which DCI is mapped, and a transmitter configured to transmit a first PUCCH scheduled by the DCI and transmit a second PUCCH, wherein a first PUCCH resource for the first PUCCH is indicated by the DCI, a second PUCCH resource for the second PUCCH is configured by a first higher layer parameter, first beam information applied to the first PUCCH is determined based on a value of a first CORESET pool index, second beam information applied to the second PUCCH is determined based on a value of a second CORESET pool index, the value of the first CORESET pool index corresponds to a CORESET for the PDCCH, and the value of the second CORESET pool index is provided for the second PUCCH resource.
(2) A second aspect of the present invention is a base station apparatus including a transmitter configured to transmit a PDCCH to which DCI is mapped, and a receiver configured to receive a first PUCCH scheduled by the DCI and receive a second PUCCH, wherein a first PUCCH resource for the first PUCCH is indicated by the DCI, a second PUCCH resource for the second PUCCH is configured by a first higher layer parameter, first beam information applied to the first PUCCH is determined based on a value of a first CORESET pool index, second beam information applied to the second PUCCH is determined based on a value of a second CORESET pool index, the value of the first CORESET pool index corresponds to a CORESET for the PDCCH, and the value of the second CORESET pool index is provided for the second PUCCH resource.
(3) A third aspect of the present invention is a communication method for a terminal apparatus, the communication method including receiving a PDCCH to which DCI is mapped, and transmitting a first PUCCH scheduled by the DCI and transmitting a second PUCCH, wherein a first PUCCH resource for the first PUCCH is indicated by the DCI, a second PUCCH resource for the second PUCCH is configured by a first higher layer parameter, first beam information applied to the first PUCCH is determined based on a value of a first CORESET pool index, second beam information applied to the second PUCCH is determined based on a value of a second CORESET pool index, the value of the first CORESET pool index corresponds to a CORESET for the PDCCH, and the value of the second CORESET pool index is provided for the second PUCCH resource.

### Advantageous Effects of Invention

According to the aspects of the present invention, the terminal apparatus can efficiently perform communication. In addition, the base station apparatus can efficiently perform communication.

### BRIEF DESCRIPTION OF DRAWINGS

FIG. 1 is a conceptual diagram of a radio communication system according to an aspect of the present embodiment.

FIG. 2 is an example illustrating a relationship between a subcarrier spacing configuration μ, the number of OFDM symbols per slot N^{slot}_{symb}, and a cyclic Prefix (CP) configuration according to an aspect of the present embodiment.

FIG. 3 is a diagram illustrating an example of a configuration method of a resource grid according to an aspect of the present embodiment.

FIG. 4 is a diagram illustrating a configuration example of a resource grid 3001 according to an aspect of the present embodiment.

FIG. 5 is a schematic block diagram illustrating a configuration example of a base station apparatus 3 according to an aspect of the present embodiment.

FIG. 6 is a schematic block diagram illustrating a configuration example of a terminal apparatus 1 according to an aspect of the present embodiment.

FIG. 7 is a diagram illustrating a configuration example of an SS/PBCH block according to an aspect of the present embodiment.

FIG. 8 is a diagram illustrating an example of monitoring occasions for search space sets according to an aspect of the present embodiment.

FIG. 9 is a diagram illustrating an example of an activation command A according to an aspect of the present embodiment.

FIG. 10 is a diagram illustrating an example of an activation command B according to an aspect of the present embodiment.

FIG. 11 is a diagram illustrating an example of an activation command C according to an aspect of the present embodiment.

FIG. 12 is a diagram illustrating an example of an activation command D according to an aspect of the present embodiment.

FIG. 13 is a diagram illustrating an example of an activation command E according to an aspect of the present embodiment.

FIG. 14 is a diagram illustrating an example of management of a TCI state according to an aspect of the present embodiment.

FIG. 15 is a diagram illustrating an example of applying an “indicated TCI state” according to an aspect of the present embodiment.

FIG. 16 is a diagram illustrating an example of a PUCCH transmission according to an aspect of the present embodiment.

### DESCRIPTION OF EMBODIMENTS

An embodiment of the present invention will be described below.

floor(C) may be a floor function for a real number C. For example, floor(C) may be a function that outputs a maximum integer in a range of not exceeding the real number C. ceil(D) may be a ceiling function for a real number D. For example, ceil(D) may be a function that outputs a minimum integer in a range of not falling below the real number D. mod(E, F) may be a function that outputs a remainder obtained by dividing E by F. mod(E, F) may be a function that outputs a value corresponding to the remainder obtained by dividing E by F. exp(G)=e\hat{ }G. Here, e is a Napier's constant. H\hat{ }I represents H to the power of I. max(J, K) is a function that outputs a maximum value out of J and K. Here, in a case that J and K are equal, max(J, K) is a function that outputs J or K. min(L, M) is a function that outputs a maximum value out of L and M. Here, in a case that L and M are equal, min(L, M) is a function that outputs L or M. round(N) is a function that outputs an integer value of a value closest to N. “·” represents multiplication.

In the radio communication system according to an aspect of the present embodiment, at least Orthogonal Frequency Division Multiplex (OFDM) is used. The OFDM symbol is a time domain unit of the OFDM. The OFDM symbol includes at least one or multiple subcarriers. The OFDM symbol is converted into a time-continuous signal in baseband signal generation. In downlink, at least Cyclic Prefix-Orthogonal Frequency Division Multiplexing (CP-OFDM) is used. In uplink, either CP-OFDM or Discrete Fourier Transform-spread-Orthogonal Frequency Division Multiplex (DFT-s-OFDM) is used. DFT-s-OFDM may be given by applying Transform precoding to the CP-OFDM.

The OFDM symbol may be a term including a CP added to the OFDM symbol. That is, a certain OFDM symbol may include the certain OFDM symbol and the CP added to the certain OFDM symbol.

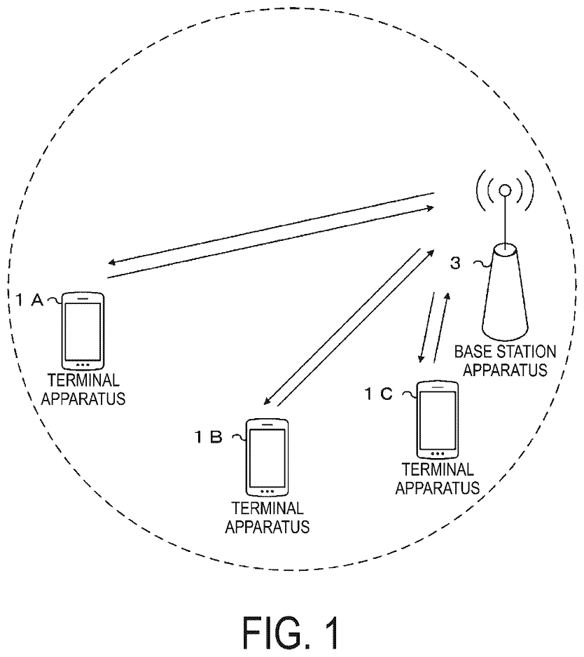

FIG. 1 is a conceptual diagram of a radio communication system according to an aspect of the present embodiment. In FIG. 1, the radio communication system includes at least terminal apparatuses 1A to 1C and a base station apparatus 3 (Base station #3 (BS #3)). Hereinafter, the terminal apparatuses 1A to 1C are also referred to as a terminal apparatus 1 (User Equipment #1 (UE #1)).

The base station apparatus 3 may include one or multiple transmission apparatuses (or transmission points, transmission and/or reception apparatuses, transmission and/or reception points). In a case that the base station apparatus 3 includes multiple transmission apparatuses, the multiple transmission apparatuses may be arranged at different positions.

The base station apparatus 3 may provide one or multiple serving cells. Each serving cell may be defined as a set of resources used for radio communication. In addition, the serving cell is also referred to as a cell.

The serving cell may include one or both of one downlink component carrier (downlink carrier) and one uplink component carrier (uplink carrier). The serving cell may include either or both of two or more downlink component carriers, and/or two or more uplink component carriers. The downlink component carrier and the uplink component carrier are also collectively referred to as a component carrier (carrier).

For example, for each component carrier, one resource grid may be given. In addition, for each set of one component carrier and a certain subcarrier spacing configuration μ, one resource grid may be given. Here, the subcarrier spacing configuration μ is also referred to as numerology. For example, for a set of a certain antenna port p, a certain subcarrier spacing configuration μ, and a certain transmission direction x, one resource grid may be given.

The resource grid includes N^{size, μ}_{grid, x}N^{RB}_{sc} subcarriers. Here, the resource grid starts from a common resource block N^{start, μ}_{grid, x}. In addition, the common resource block N^{start, μ}_{grid, x} is also referred to as a reference point of the resource grid.

The resource grid includes N^{subframe, μ}_{symb} OFDM symbols.

The subscript x added to the parameter associated with the resource grid indicates the transmission direction. For example, the subscript x may be used to indicate either of downlink or uplink.

N^{size, μ}_{grid, x} is an offset configuration indicated by a parameter provided by the RRC layer (e.g., parameter CarrierBandwidth). N^{start, μ}_{grid, x} is a band configuration indicated by a parameter provided by the RRC layer (e.g., parameter, OffsetToCarrier). The offset configuration and the band configuration are configurations used for configuring an SCS-specific carrier.

The SubCarrier Spacing (SCS) Δf for a certain subcarrier spacing configuration μ may be Δf satisfying Δf=2^{μ}·15 kHz. Here, the subcarrier spacing configuration μ may indicate one of 0, 1, 2, 3, or 4.

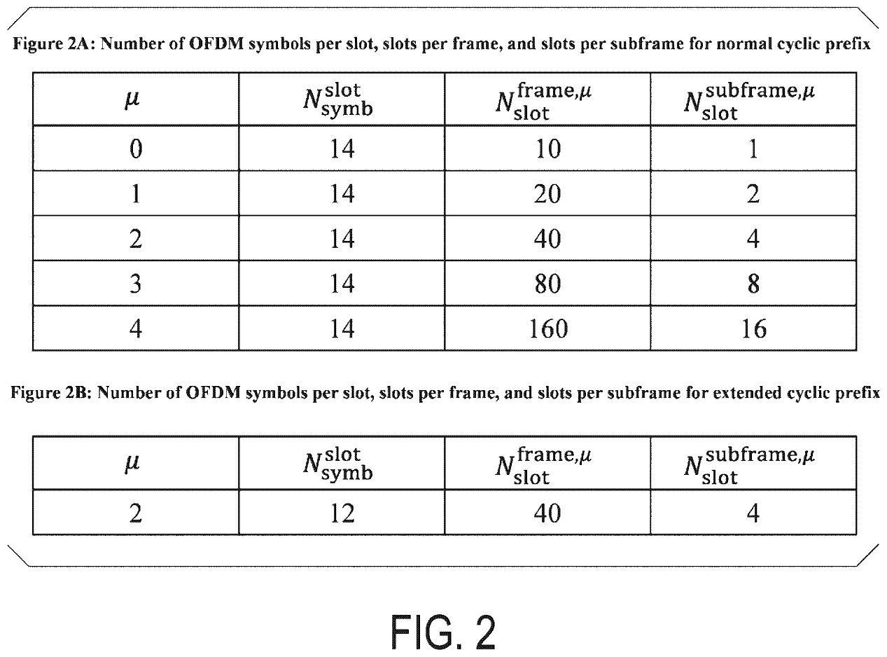

FIG. 2 is an example illustrating a relationship between the subcarrier spacing configuration μ, the number of OFDM symbols per slot N^{slot}_{symb}, and a cyclic Prefix (CP) configuration according to an aspect of the present embodiment. In FIG. 2A, for example, in a case that the subcarrier spacing configuration μ is 2 and the CP configuration is a normal cyclic prefix (normal CP), N^{slot}_{symb}=14, N^{frame, μ}ₛₗₒₜ=40, and N^{subframe, μ}ₛₗₒₜ=4. In addition, in FIG. 2B, for example, in a case that the subcarrier spacing configuration μ is 2 and the CP configuration is an extended cyclic prefix (extended CP), N^{slot}_{symb}=12, N^{frame, μ}ₛₗₒₜ=40, and N^{subframe, μ}ₛₗₒₜ=4.

The time unit T_{c} may be used to represent the length of the time domain. The time unit T_{c} is T_{c}=1/(Δfₘₐₓ·N_{f}). Δfₘₐₓ=480 kHz. N_{f}=4096. A constant κ is κ=Δfₘₐₓ·N_{f}/(Δf_{ref}N_{f, ref})=64. Δf_{ref} is 15 kHz. N_{f, ref} is 2048.

Transmission of a signal in the downlink and/or transmission of a signal in the uplink may be organized into a radio frame (system frame, frame) having the length T_{f}. T_{f}=(ΔfₘₐₓN_{f}/100)·Tₛ=10 ms. The radio frame includes 10 subframes. The length T_{sf} of the subframe is (ΔfₘₐₓN_{f}/1000)·Tₛ=1 ms. The number of OFDM symbols per subframe is N^{subframe, μ}_{symb}=N^{slot}_{symb}N^{subframe, μ}ₛₗₒₜ.

The OFDM symbol is a time domain unit of one communication scheme. For example, the OFDM symbol may be a time domain unit of CP-OFDM. In addition, the OFDM symbol may be a time domain unit of DFT-s-OFDM.

The slot may include multiple OFDM symbols. For example, N^{slot}_{symb} continuous OFDM symbols may constitute one slot. For example, in a normal CP configuration, N^{slot}_{symb} may be 14. In addition, in an extended CP configuration, N^{slot}_{symb} may be 12.

For a certain subcarrier spacing configuration μ, the number and index of a slot included in the subframe may be given. For example, slot indices n^{μ}ₛ may be given in ascending order in the subframe with integer values within a range of 0 to N^{subframe, μ}ₛₗₒₜ−1. For the subcarrier spacing configuration μ, the number and index of a slot included in the radio frame may be given. In addition, slot indices n^{μ}_{s,f} may be given in ascending order in the radio frame with integer values within a range of 0 to N^{frame, μ}ₛₗₒₜ−1.

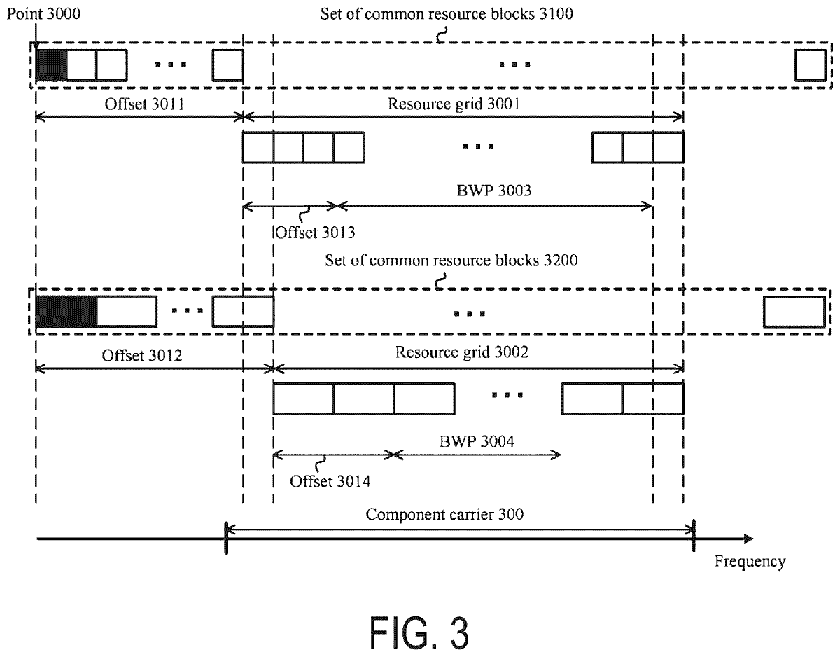

FIG. 3 is a diagram illustrating an example of a configuration method of a resource grid according to an aspect of the present embodiment. The horizontal axis of FIG. 3 represents a frequency domain. FIG. 3 illustrates a configuration example of a resource grid of a subcarrier spacing uy in a component carrier 300, and a configuration example of a resource grid of a subcarrier spacing uz in the certain component carrier. As described above, for a certain component carrier, one or multiple subcarrier spacings may be configured. In FIG. 3, it is assumed that μ₁=μ₂−1, but various aspects of the present embodiment are not limited to the condition of μ₁=μ₂−1.

The component carrier 300 is a band having a predetermined width in the frequency domain.

A point 3000 is an identifier for identifying a certain subcarrier. The point 3000 is also referred to as a point A. A common resource block (CRB) set 3100 is a set of common resource blocks for the configuration of the subcarrier spacing μ₁.

In the common resource block set 3100, a common resource block (solid black block in the common resource block set 3100 in FIG. 3) including the point 3000 is also referred to as a reference point of the common resource block set 3100. The reference point of the common resource block set 3100 may be a common resource block having an index 0 in the common resource block set 3100.

An offset 3011 is an offset from the reference point of the common resource block set 3100 to a reference point of a resource grid 3001. The offset 3011 is represented by the number of common resource blocks for the configuration of the subcarrier spacing μ₁. The resource grid 3001 includes N^{size, μ}_{grid1, x} common resource blocks starting from the reference point of the resource grid 3001.

An offset 3013 is an offset from the reference point of the resource grid 3001 to a reference point (N^{start, μ}_{BWP, i1}) of a bandwidth part (BWP) 3003 having an index i1.

A common resource block set 3200 is a set of common resource blocks for the configuration of the subcarrier spacing μ₂.

In the common resource block set 3200, a common resource block (solid black block in the common resource block set 3200 in FIG. 3) including the point 3000 is also referred to as a reference point of the common resource block set 3200. The reference point of the common resource block set 3200 may be a common resource block having an index 0 in the common resource block set 3200.

An offset 3012 is an offset from the reference point of the common resource block set 3200 to a reference point of a resource grid 3002. The offset 3012 is represented by the number of common resource blocks for the subcarrier spacing μ₂. The resource grid 3002 includes N^{size, μ}_{grid2, x} common resource blocks starting from the reference point of the resource grid 3002.

An offset 3014 is an offset from the reference point of the resource grid 3002 to a reference point (N^{start, μ}_{BWP, i2}) of a BWP 3004 having an index i2.

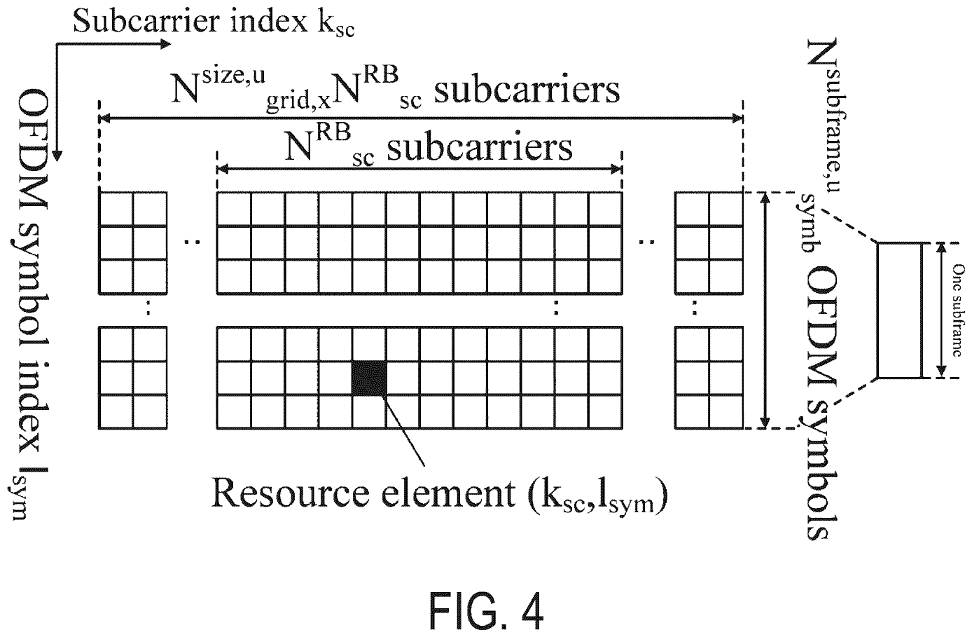

FIG. 4 is a diagram illustrating a configuration example of the resource grid 3001 according to an aspect of the present embodiment. In the resource grid of FIG. 4, the horizontal axis corresponds to an OFDM symbol index l_{sym}, and the vertical axis corresponds to a subcarrier index k_{sc}. The resource grid 3001 includes N^{size, μ}_{grid1, x}N^{RB}_{sc} subcarriers, and N^{subframe, μ}_{symb} OFDM symbols. In the resource grid, a resource identified by the subcarrier index k_{sc} and the OFDM symbol index l_{sym} is also referred to as a resource element (RE).

The resource block (RB) includes N^{RB}_{sc} continuous subcarriers. The resource block is a general term for a common resource block, a physical resource block (PRB), and a virtual resource block (VRB). Here, N^{RB}_{sc} is 12.

A resource block unit is a set of resources corresponding to one OFDM symbol in one resource block. That is, one resource block unit includes 12 resource elements corresponding to one OFDM symbol in one resource block.

The common resource blocks for the configuration of a certain subcarrier spacing μ are assigned indices (indexing) in ascending order from 0 in the frequency domain in a certain common resource block set. The common resource block having the index 0 for the configuration of a certain subcarrier spacing μ includes (collides with or matches) the point 3000. An index n^{μ}_{CRB} of the common resource block for the configuration of the certain subcarrier spacing μ satisfies the relationship of n^{μ}_{CRB}=ceil(k_{sc}/N^{RB}_{sc}). Here, a subcarrier with k_{sc}=0 is a subcarrier having the same center frequency as the center frequency of a subcarrier corresponding to the point 3000.

Physical resource blocks for the configuration of the certain subcarrier spacing μ are assigned indices in ascending order from 0 in the frequency domain in a certain BWP. An index n^{μ}_{PRB} of the physical resource block for the configuration of the certain subcarrier spacing cμ satisfies the relationship of n^{μ}_{CRB}=n^{μ}_{PRB}+N^{start, μ}_{BWP, i}. Here, N^{start, μ}_{BWP, i} indicates a reference point of the BWP having an index i.

The BWP is defined as a subset of common resource blocks included in the resource grid. The BWP includes N^{size, μ}_{BWP, i} common resource blocks starting from the reference point N^{start, μ}_{BWP, i} of the BWP. A BWP configured for a downlink carrier is also referred to as a downlink BWP. A BWP configured for an uplink component carrier is also referred to as an uplink BWP.

An antenna port may be defined such that the channel over which a symbol on the antenna port is conveyed can be inferred from the channel over which another symbol on the same antenna port is conveyed. For example, the channel may correspond to a physical channel. In addition, the symbol may correspond to an OFDM symbol. In addition, the symbol may correspond to a resource block unit. In addition, the symbol may correspond to a resource element.

The fact that a large scale property of a channel over which a symbol on one antenna port is conveyed can be inferred from a channel over which a symbol on another antenna port is conveyed is referred to as the two antenna ports being quasi co-located (QCL). Here, the large scale property may include at least long term property of a channel. The large scale property may include at least a part or all of delay spread, Doppler spread, Doppler shift, an average gain, an average delay, and a beam parameter (spatial Rx parameters). The fact that the first antenna port and the second antenna port are QCLed with respect to a beam parameter may mean that a reception beam assumed by a reception side for the first antenna port and a reception beam assumed by the reception unit side for the second antenna port are the same (or the reception beams correspond to each other). The fact that the first antenna port and the second antenna port are QCLed with respect to a beam parameter may mean that a transmission beam assumed by a reception side for the first antenna port and a transmission beam assumed by the reception side for the second antenna port are the same (or the transmission beams correspond to each other). In a case that the large scale property of a channel over which a symbol on one antenna port is conveyed can be inferred from a channel over which a symbol on another antenna port is conveyed, the terminal apparatus 1 may assume that the two antenna ports are QCL. The fact that two antenna ports are QCL may mean that the two antenna ports are assumed to be QCL. The large scale property may be referred to as a QCL parameter.

The QCL type may be any one of typeA, typeB, typeC, and typeD.

The fact that two antenna ports are QCLed with typeA may mean that a first large scale property of a channel over which a symbol on one antenna port is conveyed can be inferred from a channel over which a symbol on another antenna port is conveyed. The fact that two antenna ports are QCLed with typeB may mean that a second large scale property of a channel over which a symbol on one antenna port is conveyed can be inferred from a channel over which a symbol on another antenna port is conveyed. The fact that two antenna ports are QCLed with typeC may mean that a third large scale property of a channel over which a symbol on one antenna port is conveyed can be inferred from a channel over which a symbol on another antenna port is conveyed. The fact that two antenna ports are QCLed with typeD may mean that a fourth large scale property of a channel over which a symbol on one antenna port is conveyed can be inferred from a channel over which a symbol on another antenna port is conveyed. The first large scale property may include all of a Doppler shift, a Doppler spread, an average delay, and a delay spread. The second large scale property may include all of a Doppler shift and a Doppler spread. The third large scale property may include all of a Doppler shift and an average delay. The fourth large scale property may include spatial reception parameters (information of a spatial direction, information of a beam). An antenna port of a DMRS may be a DMRS port. For example, an antenna port of a PTRS may be a PTRS antenna port. An antenna port associated with a PTRS may be a PTRS port. An antenna port for an SRS may be an SRS port. An antenna port for a DMRS may be a DMRS port. An antenna port associated with a DMRS may be a DMRS port.

Carrier aggregation may mean that communication is performed by using multiple serving cells being aggregated. In addition, carrier aggregation may mean that communication is performed by using multiple component carriers being aggregated. In addition, carrier aggregation may mean that communication is performed by using multiple downlink component carriers being aggregated. In addition, carrier aggregation may mean that communication is performed by using multiple uplink component carriers being aggregated.

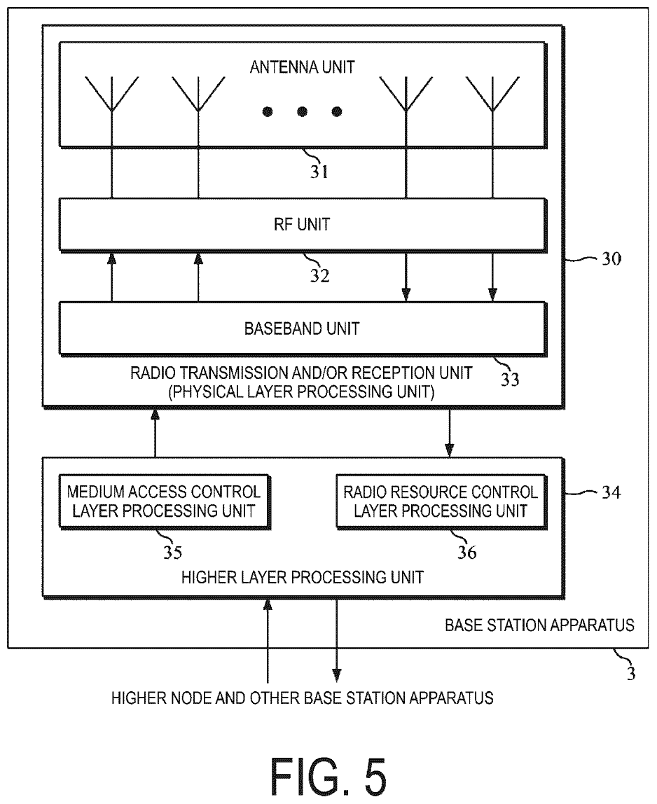

FIG. 5 is a schematic block diagram illustrating a configuration example of the base station apparatus 3 according to an aspect of the present embodiment. As illustrated in FIG. 5, the base station apparatus 3 includes at least a part or all of a radio transmission and/or reception unit (physical layer processing unit) 30 and/or a higher layer processing unit 34. The radio transmission and/or reception unit 30 includes at least a part or all of an antenna unit 31, a radio frequency (RF) unit 32, and a baseband unit 33. The higher layer processing unit 34 includes at least a part or all of a medium access control layer processing unit 35 and a radio resource control (RRC) layer processing unit 36.

The radio transmission and/or reception unit 30 includes at least a part or all of a radio transmission unit 30a and a radio reception unit 30b. Here, apparatus configurations of the baseband unit included in the radio transmission unit 30a and the baseband unit included in the radio reception unit 30b may be the same or different from each other. In addition, apparatus configurations of the RF unit included in the radio transmission unit 30a and the RF unit included in the radio reception unit 30b may be the same or different from each other. In addition, apparatus configurations of the antenna unit included in the radio transmission unit 30a and the antenna unit included in the radio reception unit 30b may be the same or different from each other.

For example, the radio transmission unit 30a may generate and transmit a baseband signal of a PDSCH. For example, the radio transmission unit 30a may generate and transmit a baseband signal of a PDCCH. For example, the radio transmission unit 30a may generate and transmit a baseband signal of a PBCH. For example, the radio transmission unit 30a may generate and transmit a baseband signal of a synchronization signal. For example, the radio transmission unit 30a may generate and transmit a baseband signal of a PDSCH DMRS. For example, the radio transmission unit 30a may generate and transmit a baseband signal of a PDCCH DMRS. For example, the radio transmission unit 30a may generate and transmit a baseband signal of a CSI-RS. For example, the radio transmission unit 30a may generate and transmit a baseband signal of a DL PTRS.

For example, the radio reception unit 30b may receive a PRACH. For example, the radio reception unit 30b may receive and demodulate a PUCCH. The radio reception unit 30b may receive and demodulate a PUSCH. For example, the radio reception unit 30b may receive a PUCCH DMRS. For example, the radio reception unit 30b may receive a PUSCH DMRS. For example, the radio reception unit 30b may receive a UL PTRS. For example, the radio reception unit 30b may receive an SRS.

The higher layer processing unit 34 outputs downlink data (a transport block) to the radio transmission and/or reception unit 30 (or the radio transmission unit 30a). The higher layer processing unit 34 performs processing operations of a Medium Access Control (MAC) layer, a Packet Data Convergence Protocol (PDCP) layer, a Radio Link Control (RLC) layer, and an RRC layer.

The medium access control layer processing unit 35 included in the higher layer processing unit 34 performs processing of the MAC layer.

The radio resource control layer processing unit 36 included in the higher layer processing unit 34 performs processing of the RRC layer. The radio resource control layer processing unit 36 manages various pieces of configuration information/parameters (RRC parameters) of the terminal apparatus 1. The radio resource control layer processing unit 36 sets the parameter based on an RRC message received from the terminal apparatus 1.

The radio transmission and/or reception unit 30 (or the radio transmission unit 30a) performs processing such as modulation and encoding. The radio transmission and/or reception unit 30 (or the radio transmission unit 30a) generates a physical signal through modulation, encoding, and baseband signal generation (conversion into the time-continuous signal) on downlink data, and transmits the physical signal to the terminal apparatus 1. The radio transmission and/or reception unit 30 (or the radio transmission unit 30a) may map the physical signal to a certain component carrier and transmit the physical signal to the terminal apparatus 1.

The radio transmission and/or reception unit 30 (or the radio reception unit 30b) performs processing such as demodulation and decoding. The radio transmission and/or reception unit 30 (or the radio reception unit 30b) separates, demodulates, and decodes the received physical signal, and outputs the decoded information to the higher layer processing unit 34. The radio transmission and/or reception unit 30 (or the radio reception unit 30b) may perform a channel access procedure prior to transmission of the physical signal.

The RF unit 32 converts (down-converts) a signal received via the antenna unit 31 into a baseband signal by means of orthogonal demodulation and removes unnecessary frequency components. The RF unit 32 outputs a processed analog signal to the baseband unit.

The baseband unit 33 converts an analog signal input from the RF unit 32 into a digital signal. The baseband unit 33 removes a portion corresponding to a cyclic prefix (CP) from the converted digital signal, performs a Fast Fourier Transform (FFT) on the signal from which the CP has been removed, and extracts a signal in the frequency domain.

The baseband unit 33 performs Inverse Fast Fourier Transform (IFFT) on the data to generate an OFDM symbol, adds a CP to the generated OFDM symbol, generates a baseband digital signal, and converts the baseband digital signal into an analog signal. The baseband unit 33 outputs the converted analog signal to the RF unit 32.

The RF unit 32 removes an unnecessary frequency component from the analog signal input from the baseband unit 33 by using a low-pass filter, upconverts the analog signal into a signal having a carrier frequency, and transmits the signal via the antenna unit 31. In addition, the RF unit 32 may have a function of controlling transmission power. The RF unit 32 is also referred to as a transmission power control unit.

For the terminal apparatus 1, one or multiple serving cells (or component carriers, downlink component carriers, uplink component carriers) may be configured.

Each of the serving cells configured for the terminal apparatus 1 may be one of a Primary cell (PCell), a Primary SCG cell (PSCell), or a Secondary Cell (SCell).

The PCell is a serving cell included in a Master Cell Group (MCG). The PCell is a cell in which an initial connection establishment procedure or a connection re-establishment procedure is performed (has been performed) by the terminal apparatus 1.

The PSCell is a serving cell included in a Secondary Cell Group (SCG). The PSCell is a serving cell in which random access is performed by the terminal apparatus 1.

The SCell may be included in either of the MCG or the SCG.

A serving cell group (cell group) is a term at least including an MCG and an SCG. The serving cell group may include one or multiple serving cells (or component carriers). One or multiple serving cells (or component carriers) included in the serving cell group may be operated by means of carrier aggregation.

One or multiple downlink BWPs may be configured for each of the serving cells (or downlink component carriers). One or multiple uplink BWPs may be configured for each of the serving cells (or uplink component carriers).

Among one or multiple downlink BWPs configured for the serving cell (or the downlink component carrier), one downlink BWP may be configured as an active downlink BWP (or one downlink BWP may be activated). Among one or multiple uplink BWPs configured for the serving cell (or the uplink component carrier), one uplink BWP may be configured as an active uplink BWP (or one uplink BWP may be activated).

The PDSCH, the PDCCH, and the CSI-RS may be received in the active downlink BWP. The terminal apparatus 1 may attempt to receive the PDSCH, the PDCCH, and the CSI-RS in the active downlink BWP. The PUCCH and the PUSCH may be transmitted in the active uplink BWP. The terminal apparatus 1 may transmit the PUCCH and the PUSCH in the active uplink BWP. The active downlink BWP and the active uplink BWP are also collectively referred to as active BWPs.

The PDSCH, the PDCCH, and the CSI-RS need not be received in downlink BWPs (inactive downlink BWPs) other than the active downlink BWP. The terminal apparatus 1 need not attempt to receive the PDSCH, the PDCCH, and the CSI-RS in downlink BWPs that are not active downlink BWPs. The PUCCH and the PUSCH need not be transmitted in uplink BWPs (inactive uplink BWPs) that are not active uplink BWPs. The terminal apparatus 1 need not transmit the PUCCH and the PUSCH in uplink BWPs that are not active uplink BWPs. The inactive downlink BWPs and the inactive uplink BWPs are also collectively referred to as inactive BWPs.

Downlink BWP switch is a procedure for deactivating one active downlink BWP of a certain serving cell and activating any one of the inactive downlink BWPs of the certain serving cell. The downlink BWP switch may be controlled by a BWP field included in downlink control information. The downlink BWP switch may be controlled based on a higher layer parameter.

Uplink BWP switch is used for deactivating one active uplink BWP and activating any one of the inactive uplink BWPs that are not the one active uplink BWP. The uplink BWP switch may be controlled by a BWP field included in downlink control information. The uplink BWP switch may be controlled based on a higher layer parameter.

Among one or multiple downlink BWPs configured for the serving cell, two or more downlink BWPs need not be configured for an active downlink BWP. For the serving cell, at certain times, one downlink BWP may be active.

Among one or multiple uplink BWPs configured for the serving cell, two or more uplink BWPs need not be configured for an active uplink BWP. For the serving cell, at certain times, one uplink BWP may be active.

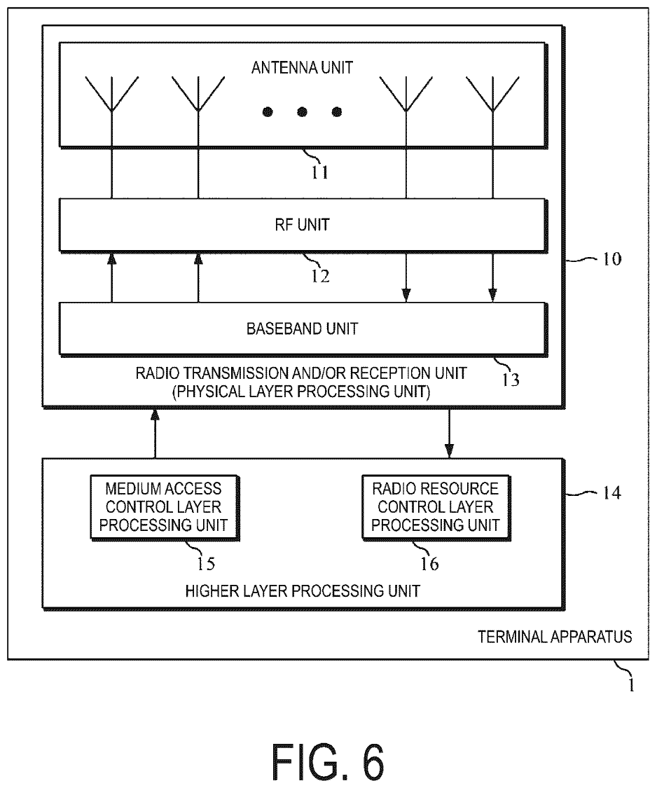

FIG. 6 is a schematic block diagram illustrating a configuration example of the terminal apparatus 1 according to an aspect of the present embodiment. As illustrated in FIG. 6, the terminal apparatus 1 includes at least one or all of a radio transmission and/or reception unit (physical layer processing unit) 10 and a higher layer processing unit 14. The radio transmission and/or reception unit 10 includes at least a part or all of an antenna unit 11, an RF unit 12, and a baseband unit 13. The higher layer processing unit 14 includes at least a part or all of a medium access control layer processing unit 15 and a radio resource control layer processing unit 16.

The radio transmission and/or reception unit 10 includes at least a part or all of a radio transmission unit 10a and a radio reception unit 10b. Here, apparatus configurations of the baseband unit 13 included in the radio transmission unit 10a and the baseband unit 13 included in the radio reception unit 10b may be the same or different from each other. In addition, apparatus configurations of the RF unit 12 included in the radio transmission unit 10a and the RF unit 12 included in the radio reception unit 10b may be the same or different from each other. In addition, apparatus configurations of the antenna unit 11 included in the radio transmission unit 10a and the antenna unit 11 included in the radio reception unit 10b may be the same or different from each other.

For example, the radio transmission unit 10a may generate and transmit a baseband signal of a PRACH. For example, the radio transmission unit 10a may generate and transmit a baseband signal of a PUCCH. The radio transmission unit 10a may generate and transmit a baseband signal of a PUSCH. For example, the radio transmission unit 10a may generate and transmit a baseband signal of a PUCCH DMRS. For example, the radio transmission unit 10a may generate and transmit a baseband signal of a PUSCH DMRS. For example, the radio transmission unit 10a may generate and transmit a baseband signal of a UL PTRS. For example, the radio transmission unit 10a may generate and transmit a baseband signal of an SRS.

For example, the radio reception unit 10b may receive and demodulate a PDSCH. For example, the radio reception unit 10b may receive and demodulate a PDCCH. For example, the radio reception unit 10b may receive and demodulate a PBCH. For example, the radio reception unit 10b may receive a synchronization signal. For example, the radio reception unit 10b may receive a PDSCH DMRS. For example, the radio reception unit 10b may receive a PDCCH DMRS. For example, the radio reception unit 10b may receive a CSI-RS. For example, the radio reception unit 10b may receive a DL PTRS.

The higher layer processing unit 14 outputs uplink data (a transport block) to the radio transmission and/or reception unit 10 (or the radio transmission unit 10a). The higher layer processing unit 14 performs processing operations of the MAC layer, a packet data convergence protocol layer, a radio link control layer, and the RRC layer.

The medium access control layer processing unit 15 included in the higher layer processing unit 14 performs processing of the MAC layer.

The radio resource control layer processing unit 16 included in the higher layer processing unit 14 performs processing of the RRC layer. The radio resource control layer processing unit 16 manages various pieces of configuration information/parameters (RRC parameters) of the terminal apparatus 1. The radio resource control layer processing unit 16 sets the RRC parameters based on an RRC message received from the base station apparatus 3.

The radio transmission and/or reception unit 10 (or the radio transmission unit 10a) performs processing such as modulation and encoding. The radio transmission and/or reception unit 10 (or the radio transmission unit 10a) generates a physical signal through modulation, encoding, and baseband signal generation (conversion into a time-continuous signal) on uplink data and transmits the physical signal to the base station apparatus 3. The radio transmission and/or reception unit 10 (or the radio transmission unit 10a) may map the physical signal to a certain BWP (an active uplink BWP) and transmit the physical signal to the base station apparatus 3.

The radio transmission and/or reception unit 10 (or the radio reception unit 10b) performs processing such as demodulation and decoding. The radio transmission and/or reception unit 10 (or the radio reception unit 30b) may receive a physical signal in a certain BWP (active downlink BWP) of a certain serving cell. The radio transmission and/or reception unit 10 (or the radio reception unit 10b) separates, demodulates, and decodes the received physical signal and outputs the decoded information to the higher layer processing unit 14. The radio transmission and/or reception unit 10 (radio reception unit 10b) may perform the channel access procedure prior to the transmission of the physical signal.

The RF unit 12 converts (down-converts) a signal received via the antenna unit 11 into a baseband signal by means of orthogonal demodulation and removes unnecessary frequency components. The RF unit 12 outputs a processed analog signal to the baseband unit 13.

The baseband unit 13 converts the analog signal input from the RF unit 12 into a digital signal. The baseband unit 13 removes a portion corresponding to a cyclic prefix (CP) from the converted digital signal, performs a Fast Fourier Transform (FFT) on the signal from which the CP has been removed, and extracts a signal of the frequency domain.

The baseband unit 13 performs an Inverse Fast Fourier Transform (IFFT) on the uplink data to generate an OFDM symbol, adds a CP to the generated OFDM symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 through a low-pass filter, upconverts the analog signal into a signal having a carrier frequency, and transmits the signal via the antenna unit 11. In addition, the RF unit 12 may have a function of controlling transmission power. The RF unit 12 is also referred to as a transmission power control unit.

A physical signal (signal) will be described below.

A physical signal is a general term for a downlink physical channel, a downlink physical signal, an uplink physical channel, and an uplink physical channel. A physical channel is a general term for a downlink physical channel and an uplink physical channel. A physical signal is a general term for a downlink physical signal and an uplink physical signal. The physical signal may be referred to as a reference signal.

An uplink physical channel may correspond to a set of resource elements for conveying information that is generated in a higher layer. An uplink physical channel may be a physical channel used in an uplink component carrier. An uplink physical channel may be transmitted by the terminal apparatus 1. The uplink physical channel may be received by the base station apparatus 3. In the radio communication system according to an aspect of the present embodiment, at least a part or all of the following uplink physical channels may be used:
Physical Uplink Control CHannel (PUCCH);
Physical Uplink Shared CHannel (PUSCH); and
Physical Random Access CHannel (PRACH).

The PUCCH may be used to transmit Uplink Control Information (UCI). The PUCCH may be transmitted for conveying (delivering or transmitting) uplink control information. The uplink control information may be mapped to the PUCCH. The terminal apparatus 1 may transmit the PUCCH to which the uplink control information is mapped. The base station apparatus 3 may receive the PUCCH to which the uplink control information is mapped.

The uplink control information (uplink control information bit, uplink control information sequence, or uplink control information type) includes at least a part or all of Channel State Information (CSI), a Scheduling Request (SR), and Hybrid Automatic Repeat request ACKnowledgement (HARQ-ACK) information.

The channel state information is also referred to as a channel state information bit or a channel state information sequence. The scheduling request is also referred to as a scheduling request bit or a scheduling request sequence. The HARQ-ACK information is also referred to as a HARQ-ACK information bit or a HARQ-ACK information sequence.

The HARQ-ACK information may include at least a HARQ-ACK corresponding to a transport block (TB). The HARQ-ACK may indicate an acknowledgement (ACK) or a negative-acknowledgement (NACK) corresponding to the transport block. The ACK may indicate that decoding of the transport block has been decoded successfully. The NACK may indicate that decoding of the transport block has not been decoded successfully. The HARQ-ACK information may include a HARQ-ACK codebook including one or multiple HARQ-ACK bits.

The transport block is a sequence of information bits delivered from a higher layer. Here, the sequence of information bits is also referred to as a bit sequence. Here, the transport block may be delivered through an UpLink-Shared CHannel (UL-SCH) of a Transport layer.

A HARQ-ACK for the transport block may be referred to as a HARQ-ACK for a PDSCH. In this case, the “HARQ-ACK for the PDSCH” indicates a HARQ-ACK for a transport block included in a PDSCH.

The HARQ-ACK may indicate an ACK or a NACK corresponding to one code block group (CBG) included in the transport block.

A scheduling request may be at least used for requesting a resource of the UL-SCH for new transmission. A scheduling request bit may be used for indicating either of a positive SR or a negative SR. The scheduling request bit indicating the positive SR is also referred to as a “positive SR being conveyed”. The positive SR may indicate that the terminal apparatus 1 requests resources of the UL-SCH for new transmission. The positive SR may indicate that a scheduling request is triggered by a higher layer. The positive SR may be conveyed in a case that the higher layer indicates the scheduling request. The scheduling request bit indicating the negative SR is also referred to as a “negative SR being transmitted”. The negative SR may indicate that the terminal apparatus 1 requests no resources of the UL-SCH for new transmission. The negative SR may indicate that the scheduling request is not triggered by a higher layer. The negative SR may be conveyed in a case that the higher layer indicates no scheduling request.

Channel state information may include at least a part or all of a Channel Quality Indicator (CQI), a Precoder Matrix Indicator (PMI), and a Rank Indicator (RI). The CQI is an indicator related to quality (for example, propagation strength) of a propagation path or quality of a physical channel, and the PMI is an indicator related to a precoder. The RI is an indicator related to a transmission rank (or the number of transmission layers).

The channel state information is an indicator related to a reception state of a physical signal (for example, CSI-RS) at least used for channel measurement. A value of the channel state information may be determined by the terminal apparatus 1 based on the reception state assumed by a physical signal at least used for channel measurement. Channel measurement may include interference measurement.

The PUCCH may correspond to a PUCCH format. The PUCCH may be a set of resource elements used for conveying the PUCCH format. The PUCCH may include the PUCCH format. The PUCCH may be transmitted in a certain PUCCH format. Note that the PUCCH format may be interpreted as a form of information. In addition, the PUCCH format may be interpreted as a set of information set in a certain form of information.

The PUSCH may be used for conveying one or both of a transport block and uplink control information. The transport block may be mapped to the PUSCH. The transport block delivered on the UL-SCH may be mapped to the PUSCH. The uplink control information may be mapped to the PUSCH. The terminal apparatus 1 may transmit the PUSCH to which one or both of the transport block and the uplink control information are mapped. The base station apparatus 3 may receive the PUSCH to which one or both of the transport block and the uplink control information are mapped.

The PRACH may be transmitted for conveying a random access preamble. The terminal apparatus 1 may transmit the PRACH. The base station apparatus 3 may receive the PRACH. A PRACH sequence x_{u, v}(n) is defined by x_{u, v}(n)=xᵤ(mod(n+Cᵥ, L_{RA})). Here, xᵤ is a Zadoff Chu (ZC) sequence. In addition, xᵤ may be defined by xᵤ=exp(−jπui(i+1)/L_{RA}). j is an imaginary unit. In addition, π is the ratio of the circumference of a circle to its diameter. In addition, Cᵥ corresponds to a cyclic shift of the PRACH sequence. In addition, L_{RA} corresponds to the length of the PRACH sequence. In addition, L_{RA} is 839, or 139. In addition, i is an integer in the range from 0 to L_{RA}−1. In addition, u is a sequence index for the PRACH sequence.

For each PRACH occasion, 64 random access preambles are defined. The random access preambles are identified based on the cyclic shift Cᵥ of the PRACH sequence and the sequence index u for the PRACH sequence. Each of the 64 identified random access preambles may be assigned an index.

Uplink physical signals may correspond to a set of resource elements. The uplink physical signals need not be used to convey information generated in a higher layer. Note that the uplink physical signals may be used to convey information generated in the physical layer. The uplink physical signals may be physical signals used in an uplink component carrier. The terminal apparatus 1 may transmit the uplink physical signals. The base station apparatus 3 may receive the uplink physical signals. In the radio communication system according to an aspect of the present embodiment, at least a part or all of the following uplink physical signals may be used:
UpLink Demodulation Reference Signal (UL DMRS);
Sounding Reference Signal (SRS); and
UpLink Phase Tracking Reference Signal (UL PTRS).

A UL DMRS is a general term for a DMRS for a PUSCH and a DMRS for a PUCCH.

A set of antenna ports of the DMRS for the PUSCH (the DMRS related to the PUSCH, the DMRS included in the PUSCH, or the DMRS corresponding to the PUSCH) may be given based on a set of antenna ports for the PUSCH. For example, the set of antenna ports of the DMRS for the PUSCH may be the same as a set of antenna ports of the PUSCH.

Transmission of the PUSCH and transmission of the DMRS for the PUSCH may be indicated (or may be scheduled) in one DCI format. The PUSCH and the DMRS for the PUSCH may be collectively referred to as a PUSCH. Transmission of the PUSCH may mean transmission of the PUSCH and the DMRS for the PUSCH.

A propagation path of the PUSCH may be inferred from the DMRS for the PUSCH.

A set of antenna ports of the DMRS for the PUCCH (a DMRS related to the PUCCH, a DMRS included in the PUCCH, or a DMRS corresponding to the PUCCH) may be the same as a set of antenna ports of the PUCCH.

Transmission of the PUCCH and transmission of the DMRS for the PUCCH may be indicated (or may be triggered) in one DCI format. One or both of resource element mapping of the PUCCH and resource element mapping of the DMRS for the PUCCH may be given in one PUCCH format. The PUCCH and the DMRS for the PUCCH may be collectively referred to as a PUCCH. Transmission of the PUCCH may mean transmission of the PUCCH and the DMRS for the PUCCH.

A propagation path of the PUCCH may be inferred from the DMRS for the PUCCH.

A downlink physical channel may correspond to a set of resource elements for conveying information generated in a higher layer. A downlink physical channel may be a physical channel used in a downlink component carrier. The base station apparatus 3 may transmit a downlink physical channel. The terminal apparatus 1 may receive a downlink physical channel. In the radio communication system according to an aspect of the present embodiment, at least a part or all of the following downlink physical channels may be used:
Physical Broadcast Channel (PBCH);
Physical Downlink Control Channel (PDCCH); and
Physical Downlink Shared Channel (PDSCH).

The PBCH may be transmitted for conveying one or both of a Master Information Block (MIB) and physical layer control information. Here, the physical layer control information is information generated in the physical layer. The MIB is a set of parameters mapped to a Broadcast Control CHannel (BCCH) that is a logical channel of the MAC layer. The BCCH is mapped to a BCH that is a channel of a transport layer. The BCH may be mapped to the PBCH. The terminal apparatus 1 may receive the PBCH to which one or both of the MIB and the physical layer control information are mapped. The base station apparatus 3 may transmit the PBCH to which one or both of the MIB and/or the physical layer control information are mapped.

For example, the physical layer control information may include 8 bits. The physical layer control information may include at least a part or all of the following 0A to 0D.
0A) Radio frame bits
0B) Half radio frame (half system frame or half frame) bits
0C) SS/PBCH block index bits
0D) Subcarrier offset bits

The radio frame bit is used for indicating a radio frame in which the PBCH is transmitted (radio frame including a slot in which the PBCH is transmitted). The radio frame bit includes 4 bits. The radio frame bit may include 4 bits out of a 10-bit radio frame indicator. For example, the radio frame indicator may be at least used for identifying radio frames from index 0 to index 1023.

The half radio frame bit is used for indicating, out of the radio frame in which the PBCH is transmitted, which of the first five subframes or the last five subframes is used for transmission of the PBCH. Here, the half radio frame may include five subframes. In addition, the half radio frame may include the first five subframes out of the 10 subframes included in the radio frame. In addition, the half radio frame may include the last five subframes out of the 10 subframes included in the radio frame.

An SS/PBCH block index bit is used for indicating an SS/PBCH block index. The SS/PBCH block index bit includes 3 bits. The SS/PBCH block index bit may include 3 bits out of a 6-bit SS/PBCH block index indicator. The SS/PBCH block index indicator may be at least used for identifying SS/PBCH blocks of the index 0 to index 63.

A subcarrier offset bit is used for indicating a subcarrier offset. The subcarrier offset may be used for indicating a difference between the leading subcarrier to which the PBCH is mapped and the leading subcarrier to which the control resource set having the index 0 is mapped.

The PDCCH may be transmitted for conveying Downlink Control Information (DCI). The downlink control information may be mapped to the PDCCH. The terminal apparatus 1 may receive the PDCCH to which the downlink control information is mapped. The base station apparatus 3 may transmit the PDCCH to which the downlink control information is mapped.

The downlink control information may be transmitted in a DCI format. Note that the DCI format may also be interpreted as the format of downlink control information. In addition, the DCI format may be interpreted as a set of downlink control information set to the format of certain downlink control information.

A DCI format 0_0, a DCI format 0_1, a DCI format 1_0, and a DCI format 1_1 are DCI formats. An uplink DCI format is a general term for the DCI format 0_0 and the DCI format 0_1. A downlink DCI format is a general term for the DCI format 1_0 and the DCI format 1_1.

The DCI format 0_0 is at least used for scheduling of the PUSCH mapped to a certain cell. The DCI format 0_0 includes at least a part or all of fields listed from 1A to 1E.
1A) Identifier field for DCI formats
1B) Frequency domain resource assignment field
1C) Time domain resource assignment field
1D) Frequency hopping flag field
1E) Modulation and Coding Scheme (MCS) field

An identifier field for DCI formats may indicate whether the DCI format including the identifier field for DCI formats is an uplink DCI format or a downlink DCI format. In other words, an identifier field for DCI formats may be included in each of the uplink DCI format and the downlink DCI format. Here, the identifier field for DCI formats included in the DCI format 0_0 may indicate 0.

A frequency domain resource assignment field included in the DCI format 0_0 may be used for indicating assignment of frequency resources for the PUSCH.

A time domain resource assignment field included in the DCI format 0_0 may be used for indicating assignment of time resources for the PUSCH.

A frequency hopping flag field may be used for indicating whether frequency hopping is applied to the PUSCH.

An MCS field included in the DCI format 0_0 may be at least used for indicating one or both of a modulation scheme for the PUSCH and a target encoding rate. The target encoding rate may be a target encoding rate for the transport block mapped to the PUSCH. A transport block size (TBS) mapped to the PUSCH may be determined based on one or both of the target encoding rate and the modulation scheme for the PUSCH.

The DCI format 0_0 need not include a field used for a CSI request.

The DCI format 0_0 need not include a carrier indicator field. In other words, the serving cell to which the uplink component carrier to which the PUSCH scheduled in the DCI format 0_0 is mapped belongs may be the same as the serving cell of the uplink component carrier to which the PDCCH including the DCI format 0_0 is mapped. Based on detection of the DCI format 0_0 in a certain downlink component carrier of a certain serving cell, the terminal apparatus 1 may recognize that the PUSCH scheduled in the DCI format 0_0 is mapped to the uplink component carrier of the certain serving cell.

The DCI format 0_0 need not include a BWP field (BWP indicator field). Here, the DCI format 0_0 may be a DCI format for scheduling the PUSCH without changing an active uplink BWP. The terminal apparatus 1 may recognize that the PUSCH is transmitted without switching the active uplink BWP based on detection of the DCI format 0_0 used for the scheduling of the PUSCH.

The DCI format 0_1 is at least used for scheduling of the PUSCH mapped to a certain cell. The DCI format 0_1 includes at least a part or all of fields listed from 2A to 2H.
2A) Identifier field for DCI formats
2B) Frequency domain resource assignment field
2C) Uplink time domain resource assignment field
2D) Frequency hopping flag field
2E) MCS field
2F) CSI request field
2G) BWP field
2H) Carrier indicator field

The identifier field for DCI formats included in the DCI format 0_1 may indicate 0.

The frequency domain resource assignment field included in the DCI format 0_1 may be used for indicating assignment of frequency resources for the PUSCH.

The time domain resource assignment field included in the DCI format 0_1 may be used for indicating assignment of time resources for the PUSCH.

The MCS field included in the DCI format 0_1 may be at least used for indicating a part or all of a modulation scheme for the PUSCH and/or a target encoding rate.

The BWP field of the DCI format 0_1 may be used for indicating an uplink BWP to which the PUSCH scheduled in the DCI format 0_1 is mapped. In other words, the DCI format 0_1 may be accompanied by a change in the active uplink BWP. The terminal apparatus 1 may recognize the uplink BWP to which the PUSCH is mapped based on detection of the DCI format 0_1 used for scheduling of the PUSCH.

The DCI format 0_1 not including the BWP field may be a DCI format for scheduling the PUSCH without changing the active uplink BWP. The terminal apparatus 1 may recognize that the PUSCH is transmitted without switching the active uplink BWP based on detection of the DCI format D0_1 which is the DCI format 0_1 used for the scheduling of the PUSCH and does not include the BWP field.

In a case that the BWP field is included in the DCI format 0_1 but the terminal apparatus 1 does not support the function of switching the BWP according to the DCI format 0_1, the terminal apparatus 1 may disregard the BWP field. In other words, the terminal apparatus 1 which does not support the function of switching the BWP may recognize that the PUSCH is transmitted without switching the active uplink BWP based on detection of the DCI format 0_1 which is the DCI format 0_1 used for the scheduling of the PUSCH and includes the BWP field. Here, in a case that the terminal apparatus 1 supports the function of switching the BWP, the terminal apparatus 1 may report, in a function information reporting procedure of the RRC layer, that “the terminal apparatus 1 supports the function of switching the BWP”.

The CSI request field is used for indicating a report of CSI.

In a case that a carrier indicator field is included in the DCI format 0_1, the carrier indicator field may be used for indicating the uplink component carrier to which the PUSCH is mapped. In a case that a carrier indicator field is not included in the DCI format 0_1, the uplink component carrier to which the PUSCH is mapped may be the same as the uplink component carrier to which the PDCCH including the DCI format 0_1 used for scheduling of the PUSCH is mapped. In a case that the number of uplink component carriers configured for the terminal apparatus 1 in a certain serving cell group is two or more (a case that uplink carrier aggregation is operated in a certain serving cell group), the number of bits of the carrier indicator field included in the DCI format 0_1 used for scheduling of the PUSCH mapped to the certain serving cell group may be 1 bit or more (for example, 3 bits). In a case that the number of uplink component carriers configured for the terminal apparatus 1 in a certain serving cell group is one (a case that uplink carrier aggregation is not operated in a certain serving cell group), the number of bits of the carrier indicator field included in the DCI format 0_1 used for scheduling of the PUSCH mapped to the certain serving cell group may be 0 bits (or the carrier indicator field may not be included in the DCI format 0_1 used for scheduling of the PUSCH mapped to the certain serving cell group).

The DCI format 1_0 is at least used for scheduling of the PDSCH mapped to a certain cell. The DCI format 1_0 includes at least a part or all of 3A to 3F:
3A) Identifier field for DCI formats;
3B) Frequency domain resource assignment field;
3C) Time domain resource assignment field;
3D) MCS field;
3E) PDSCH_HARQ feedback timing indicator field (PDSCH to HARQ feedback timing indicator field); and
3F) PUCCH resource indicator field.

The identifier field for DCI formats included in the DCI format 1_0 may indicate 1.

The frequency domain resource assignment field included in the DCI format 1_0 may be at least used for indicating assignment of frequency resources for the PDSCH.

The time domain resource assignment field included in the DCI format 1_0 may be at least used for indicating assignment of time resources for the PDSCH.

The MCS field included in the DCI format 1_0 may be at least used for indicating one or both of the modulation scheme for the PDSCH and the target encoding rate. The target encoding rate may be a target encoding rate for a transport block mapped to the PDSCH. The size of a transport block (Transport Block Size or TBS) mapped to the PDSCH may be determined based on one or both of the target encoding rate and the modulation scheme for the PDSCH.

The PDSCH_HARQ feedback timing indicator field may be used for indicating an offset from the slot including the last OFDM symbol of the PDSCH to the slot including the first OFDM symbol of the PUCCH.

The PUCCH resource indicator field may be a field indicating an index of any of one or multiple PUCCH resources included in a PUCCH resource set. The PUCCH resource set may include one or multiple PUCCH resources.

The DCI format 1_0 may not include the carrier indicator field. In other words, the downlink component carrier to which the PDSCH scheduled by using the DCI format 1_0 is mapped may be the same as the downlink component carrier to which the PDCCH including the DCI format 1_0 is mapped. Based on detection of the DCI format 1_0 on a certain downlink component carrier, the terminal apparatus 1 may recognize that the PDSCH scheduled in the DCI format 1_0 is mapped to the downlink component carrier.

The DCI format 1_0 may not include a BWP field. Here, DCI format 1_0 may be a DCI format for scheduling the PDSCH without changing the active downlink BWP. The terminal apparatus 1 may recognize that the PDSCH is received without switching the active downlink BWP based on detection of the DCI format 1_0 used in scheduling of the PDSCH.

The DCI format 1_1 is at least used for scheduling of the PDSCH mapped to a certain cell. The DCI format 1_1 includes at least some or all of 4A to 4I:
4A) Identifier field for DCI formats;
4B) Frequency domain resource assignment field;
4C) Time domain resource assignment field;
4E) MCS field;
4F) PDSCH_HARQ feedback timing indicator field;
4G) PUCCH resource indicator field;
4H) BWP field; and
4I) Carrier indicator field.

The identifier field for DCI formats included in the DCI format 1_1 may indicate 1.

The frequency domain resource assignment field included in the DCI format 1_1 may be at least used for indicating assignment of frequency resources for the PDSCH.

The time domain resource assignment field included in the DCI format 1_1 may be at least used for indicating assignment of time resources for the PDSCH.

The MCS field included in the DCI format 1_1 may be at least used for indicating one or both of the modulation scheme for the PDSCH and the target encoding rate.

In a case that the PDSCH_HARQ feedback timing indicator field is included in the DCI format 1_1, the PDSCH_HARQ feedback timing indicator field may be at least used for indicating an offset from the slot including the last OFDM symbol of the PDSCH to the slot including the first OFDM symbol of the PUCCH. In a case that the PDSCH_HARQ feedback timing indicator field is not included in the DCI format 1_1, an offset from the slot including the last OFDM symbol of the PDSCH to the slot including the first OFDM symbol of the PUCCH may be identified by a higher layer parameter.

The PUCCH resource indicator field may be a field indicating an index of any of one or multiple PUCCH resources included in a PUCCH resource set.

The BWP field of the DCI format 1_1 may be used to indicate the downlink BWP to which the PDSCH scheduled in the DCI format 1_1 is mapped. In other words, the DCI format 1_1 may be accompanied by a change in the active downlink BWP. The terminal apparatus 1 may recognize the downlink BWP to which the PUSCH is mapped based on detection of the DCI format 1_1 used for the scheduling of the PDSCH.

The DCI format 1_1 not including the BWP field may be a DCI format for scheduling the PDSCH without changing the active downlink BWP. The terminal apparatus 1 may recognize that the PDSCH is received without switching the active downlink BWP based on detection of the DCI format 1_1 which is used for the scheduling of the PDSCH and the DCI format 1_1 not including the BWP field.

In a case that the DCI format 1_1 includes the BWP field but the terminal apparatus 1 does not support the function of switching the BWP according to the DCI format 1_1, the terminal apparatus 1 may disregard the BWP field. In other words, the terminal apparatus 1 which does not support the function of switching the BWP may recognize that the PDSCH is received without switching the active downlink BWP based on detection of the DCI format 1_1 which is used for the scheduling of the PDSCH and the DCI format 1_1 including the BWP field. Here, in a case that the terminal apparatus 1 supports the function of switching the BWP, the terminal apparatus 1 may report, in a function information reporting procedure of the RRC layer, that “the terminal apparatus 1 supports the function of switching the BWP”.

In a case that the carrier indicator field is included in the DCI format 1_1, the carrier indicator field may be used for indicating the downlink component carrier to which the PDSCH is mapped. In a case that the carrier indicator field is not included in the DCI format 1_1, the downlink component carrier to which the PDSCH is mapped may be the same as the downlink component carrier to which the PDCCH including the DCI format 1_1 used for scheduling of the PDSCH is mapped. In a case that the number of downlink component carriers configured for the terminal apparatus 1 in a certain serving cell group is two or more (a case that downlink carrier aggregation is operated in a certain serving cell group), the number of bits of the carrier indicator field included in the DCI format 1_1 used for scheduling of the PDSCH mapped to the certain serving cell group may be 1 bit or more (for example, 3 bits). In a case that the number of downlink component carriers configured for the terminal apparatus 1 in a certain serving cell group is one (a case that downlink carrier aggregation is not operated in a certain serving cell group), the number of bits of the carrier indicator field included in the DCI format 1_1 used for scheduling of the PDSCH mapped to the certain serving cell group may be 0 bits (or the carrier indicator field may not be included in the DCI format 1_1 used for scheduling of the PDSCH mapped to the certain serving cell group).

The PDSCH may be transmitted for conveying a transport block. The PDSCH may be used for transmitting a transport block delivered on the DL-SCH. The PDSCH may be used for conveying a transport block. A transport block may be mapped to the PDSCH. The transport block corresponding to the DL-SCH may be mapped to the PDSCH. The base station apparatus 3 may transmit the PDSCH. The terminal apparatus 1 may receive the PDSCH.

A downlink physical signal may correspond to a set of resource elements. The downlink physical signal may not carry information generated in a higher layer. The downlink physical signal may be a physical signal used in a downlink component carrier. The downlink physical signal may be transmitted by the base station apparatus 3. The downlink physical signal may be transmitted by the terminal apparatus 1. In the radio communication system according to an aspect of the present embodiment, at least some or all of the following downlink physical signals may be used:
Synchronization signal (SS);
DownLink DeModulation Reference Signal (DL DMRS);
Channel State Information-Reference Signal (CSI-RS); and
DownLink Phase Tracking Reference Signal (DL PTRS).

The synchronization signal may be used for the terminal apparatus 1 to take synchronization in one or both of the frequency domain and the time domain in downlink. The synchronization signal is a general term for a primary synchronization signal (PSS) and a secondary synchronization signal (SSS).

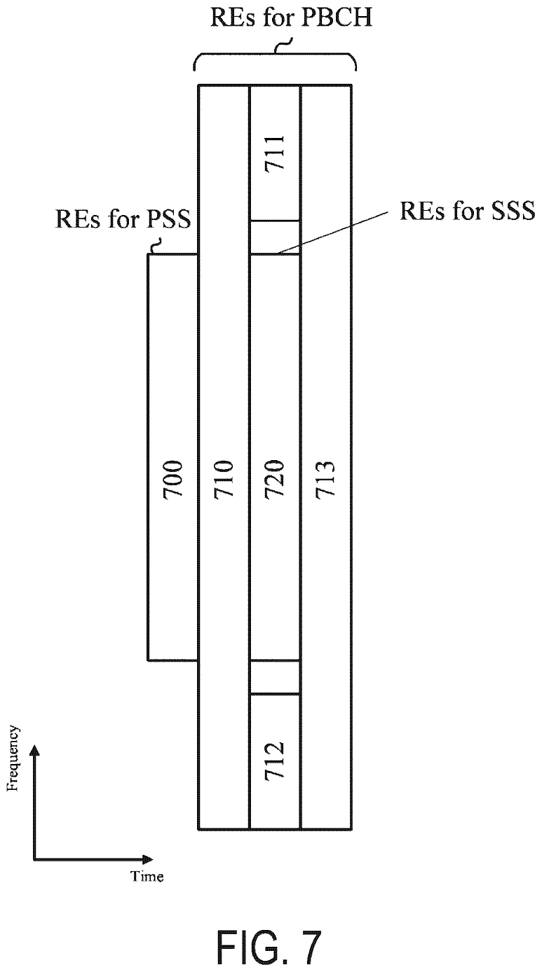

FIG. 7 is a diagram illustrating a configuration example of the SS/PBCH block according to an aspect of the present embodiment. In FIG. 7, the horizontal axis corresponds to a time axis (OFDM symbol index l_{sym}), and the vertical axis represents the frequency domain. In addition, a block 700 represents a set of resource elements for a PSS. In addition, a block 720 represents a set of resource elements for an SSS. In addition, four blocks (blocks 710, 711, 712, and 713) represent a set of resource elements for a PBCH and a DMRS for the PBCH (DMRS related to the PBCH, DMRS included in the PBCH, or DMRS corresponding to the PBCH).

As illustrated in FIG. 7, the SS/PBCH block includes a PSS, an SSS, and a PBCH. In addition, the SS/PBCH block includes four continuous OFDM symbols. The SS/PBCH block includes 240 subcarriers. The PSS is mapped to the 57th to 183rd subcarriers in the first OFDM symbol. The SSS is mapped to the 57th to 183rd subcarriers in the third OFDM symbol. Zero may be set to the 1st to 56th subcarriers of the first OFDM symbol. Zero may be set to the 184th to 240th subcarriers of the first OFDM symbol. Zero may be set to the 49th to 56th subcarriers of the third OFDM symbol. Zero may be set to the 184th to 192nd subcarriers of the third OFDM symbol. The PBCH is mapped to subcarriers which are the 1st to 240th subcarriers of the second OFDM symbol and to which a DMRS for the PBCH is not mapped. The PBCH is mapped to subcarriers which are the 1st to 48th subcarriers of the third OFDM symbol and to which a DMRS for the PBCH is not mapped. The PBCH is mapped to subcarriers which are the 193rd to 240th subcarriers of the third OFDM symbol and to which a DMRS for the PBCH is not mapped. The PBCH is mapped to subcarriers which are the 1st to 240th subcarriers of the fourth OFDM symbol and to which a DMRS for the PBCH is not mapped.

The antenna ports of the PSS, the SSS, the PBCH, and the DMRS for the PBCH may be the same.

The PBCH over which the symbol of the PBCH on a certain antenna port is conveyed may be inferred from the DMRS for the PBCH mapped to the slot to which the PBCH is mapped and the DMRS for the PBCH included in the SS/PBCH block including the PBCH.

The DL DMRS is a general term for a DMRS for the PBCH, a DMRS for the PDSCH, and a DMRS for the PDCCH.

A set of antenna ports of the DMRS for the PDSCH (a DMRS related to the PDSCH, a DMRS included in the PDSCH, or a DMRS corresponding to the PDSCH) may be given based on a set of antenna ports for the PDSCH. In other words, the set of antenna ports of the DMRS for the PDSCH may be the same as the set of antenna ports for the PDSCH.

Transmission of the PDSCH and transmission of the DMRS for the PDSCH may be indicated (or may be scheduled) in one DCI format. The PDSCH and the DMRS for the PDSCH may be collectively referred to as a PDSCH. Transmission of the PDSCH may be transmission of the PDSCH and the DMRS for the PDSCH.

A propagation path of the PDSCH may be inferred from the DMRS for the PDSCH. In a case that a set of resource elements in which the symbol of a certain PDSCH is conveyed and a set of resource elements in which the symbol of the DMRS for the certain PDSCH is conveyed are included in the same Precoding Resource Group (PRG), the PDSCH over which the symbol of the PDSCH on a certain antenna port is conveyed may be inferred from the DMRS for the PDSCH.

The antenna port of the DMRS for the PDCCH (the DMRS related to the PDCCH, the DMRS included in the PDCCH, or the DMRS corresponding to the PDCCH) may be the same as the antenna port for the PDCCH.

The PDCCH may be inferred from the DMRS for the PDCCH. In other words, a propagation path of the PDCCH may be inferred from the DMRS for the PDCCH. In a case that the same precoder is applied (in a case that the same precoder is assumed to be applied, or in a case of assuming that the same precoder is applied) to a set of resource elements in which the symbol of a certain PDCCH is conveyed and a set of resource elements in which the symbol of the DMRS for the certain PDCCH is conveyed, the PDCCH over which the symbol of the PDCCH on a certain antenna port is conveyed may be inferred from the DMRS for the PDCCH.

A Broadcast CHannel (BCH), an Uplink-Shared CHannel (UL-SCH), and a Downlink-Shared CHannel (DL-SCH) are transport channels. A transport channel defines the relationship between a physical layer channel and a MAC layer channel (also referred to as a logical channel).

A BCH of the transport layer is mapped to the PBCH of the physical layer. In other words, a transport block passing through the BCH of the transport layer is delivered to the PBCH of the physical layer. In addition, the UL-SCH of the transport layer is mapped to the PUSCH of the physical layer. In other words, the transport block passing through the UL-SCH of the transport layer is delivered to the PUSCH of the physical layer. In addition, the DL-SCH of the transport layer is mapped to the PDSCH of the physical layer. In other words, a transport block passing through the DL-SCH of the transport layer is delivered to the PDSCH of the physical layer.

One UL-SCH and one DL-SCH may be given to each serving cell. The BCH may be given to a PCell. The BCH may not be given to a PSCell and an SCell.

In the MAC layer, control over a Hybrid Automatic Repeat reQuest (HARQ) is performed for each transport block.

A Broadcast Control CHannel (BCCH), a Common Control CHannel (CCCH), and a Dedicated Control CHannel (DCCH) are logical channels. For example, the BCCH is a channel of the RRC layer used for transmitting a MIB or system information. In addition, a Common Control CHannel (CCCH) may be used for transmitting a common RRC message in multiple terminal apparatuses 1. Here, the CCCH may be, for example, used for a terminal apparatus 1 that is not in a state of RRC connection. In addition, a Dedicated Control CHannel (DCCH) may be at least used for transmitting an RRC message dedicated to a terminal apparatus 1. Here, the DCCH may be, for example, used for the terminal apparatus 1 that is in a state of RRC connection.

A higher layer parameter common to multiple terminal apparatuses 1 is also referred to as a common higher layer parameter. Here, the common higher layer parameter may be defined as a parameter specific to a serving cell. Here, a parameter specific to a serving cell may be a parameter common to terminal apparatuses configured with the serving cell (for example, terminal apparatuses 1-A, 1-B, and 1-C).

For example, an RRC message delivered to the BCCH may include the common higher layer parameter. For example, an RRC message delivered on the DCCH may include the common higher layer parameter.

Among certain higher layer parameters, a higher layer parameter different from the common higher layer parameter is also referred to as a dedicated higher layer parameter. Here, the dedicated higher layer parameter can provide a dedicated RRC parameter to the terminal apparatus 1-A configured with the serving cell. In other words, the dedicated RRC parameter is a higher layer parameter capable of providing a unique configuration to each of the terminal apparatuses 1-A, 1-B, and 1-C.

The BCCH of the logical channel may be mapped to the BCH or the DL-SCH of the transport layer. For example, a transport block including information of an MIB is delivered to the BCH of the transport layer. In addition, a transport block including system information other than the MIB is delivered to the DL-SCH of the transport layer. In addition, the CCCH is mapped to the DL-SCH or the UL-SCH. In other words, a transport block mapped to the CCCH is delivered to the DL-SCH or the UL-SCH. In addition, the DCCH is mapped to the DL-SCH or the UL-SCH. In other words, a transport block mapped to the DCCH is delivered to the DL-SCH or the UL-SCH.

An RRC message includes one or multiple parameters managed in the RRC layer. Here, the parameters managed in the RRC layer are also referred to as RRC parameters. For example, the RRC message may include the MIB. In addition, the RRC message may include system information. In addition, the RRC message may include a message corresponding to the CCCH. In addition, the RRC message may include a message corresponding to the DCCH. An RRC message including a message corresponding to the DCCH is also referred to as an individual RRC message.

A higher layer parameter (parameter in higher layer) is an RRC parameter or a parameter included in a Medium Access Control Control Element (MAC CE). In other words, the higher layer parameter is a general term for the MIB, the system information, a message corresponding to the CCCH, a message corresponding to the DCCH, and a parameter included in a MAC CE. The parameter included in the MAC CE is transmitted by using a MAC Control Element (CE) command.

Procedures performed by the terminal apparatus 1 include at least some or all of the following 5A to 5C:
5A) Cell search;
5B) Random access, and
5C) Data communication

The cell search is a procedure used for the terminal apparatus 1 synchronizing with a certain cell related to the time domain and the frequency domain and detecting a physical cell identity (physical cell ID). In other words, by means of the cell search, the terminal apparatus 1 may perform synchronization with a certain cell in the time domain and the frequency domain and detect a physical cell ID.

A sequence of the PSS is given based at least on the physical cell ID. A sequence of the SSS is given based at least on the physical cell ID.

An SS/PBCH block candidate indicates a resource allowed to (possible to, scheduled to, configured to, defined to, having a possibility to) transmit the SS/PBCH block.

A set of SS/PBCH block candidates in a certain half radio frame is also referred to as an SS burst set. An SS burst set is also referred to as a transmission window, an SS transmission window, or a Discovery Reference Signal transmission window (DRS transmission window).

The SS burst set is a general term including at least a first SS burst set and a second SS burst set. The base station apparatus 3 transmits SS/PBCH blocks with one or multiple indices with a prescribed period. The terminal apparatus 1 may detect at least one SS/PBCH block out of the SS/PBCH blocks with one or multiple indices and attempt decoding of the PBCH included in the SS/PBCH block.

The random access is a procedure including at least some or all of a message 1, a message 2, a message 3, and a message 4.

The message 1 is a procedure in which the PRACH is transmitted by the terminal apparatus 1. The terminal apparatus 1 transmits the PRACH in one PRACH occasion selected out of one or multiple PRACH occasions based at least on the index of the SS/PBCH block candidate detected based on the cell search. Each of the PRACH occasions is defined based at least on resources in the time domain and the frequency domain.

The terminal apparatus 1 transmits one random access preamble selected out of the PRACH occasions corresponding to the indices of the SS/PBCH block candidates in which the SS/PBCH block is detected.

The message 2 is a procedure of attempting to detect a DCI format 1_0 with a Cyclic Redundancy Check (CRC) scrambled by a Random Access-Radio Network Temporary Identifier (RA-RNTI) by the terminal apparatus 1. The terminal apparatus 1 attempts detection of the PDCCH including the DCI format in a control resource set given based on the MIB, which is included in the PBCH included in the SS/PBCH block detected based on a cell search, and in resources indicated based on a configuration of a search space set. The message 2 is also referred to as a random access response.

The message 3 is a procedure of transmitting the PUSCH scheduled by using a random access response grant included in the DCI format 1_0 detected through the procedure of the message 2. Here, the random access response grant is indicated by a MAC CE included in the PDSCH scheduled by using the DCI format 1_0.

The PUSCH scheduled based on the random access response grant is either a message 3 PUSCH or a PUSCH. The message 3 PUSCH includes a contention resolution identifier (contention resolution ID) MAC CE. The contention resolution ID MAC CE includes a contention resolution ID.

Retransmission of the message 3 PUSCH is scheduled by using a DCI format 0_0 with a CRC scrambled based on a Temporary Cell-Radio Network Temporary Identifier (TC-RNTI).

The message 4 is a procedure of attempting to detect the DCI format 1_0 with a CRC scrambled based on either of a Cell-Radio Network Temporary Identifier (C-RNTI) or a TC-RNTI. The terminal apparatus 1 receives a PDSCH scheduled based on the DCI format 1_0. The PDSCH may include a contention resolution ID.

Data communication is a general term for downlink communication and uplink communication.

In the data communication, the terminal apparatus 1 attempts detection of the PDCCH (monitors the PDCCH or supervises the PDCCH) in a control resource set and resources identified based on a search space set.

The control resource set (CORESET) is a set of resources including a prescribed number of resource blocks and a prescribed number of OFDM symbols. In the frequency domain, the control resource set may include continuous resources (non-interleaved mapping) or may include distributed resources (interleaver mapping).

A set of resource blocks constituting the control resource set may be indicated by a higher layer parameter. The number of OFDM symbols constituting the control resource set may be indicated by a higher layer parameter.

The terminal apparatus 1 attempts detection of the PDCCH in a search space set. Here, an attempt to detect the PDCCH in the search space set may be an attempt to detect a candidate of the PDCCH in the search space set, may be an attempt to detect a DCI format in the search space set, may be an attempt to detect the PDCCH in the control resource set, may be an attempt to detect a candidate of the PDCCH in the control resource set, or may be an attempt to detect a DCI format in the control resource set.

The search space set is defined as a set of candidates of the PDCCH. The search space set may be a Common Search Space (CSS) set or may be a UE-specific Search Space (USS) set. The terminal apparatus 1 attempts detection of candidates of the PDCCH in some or all of a Type 0 PDCCH common search space set, a Type 0a PDCCH common search space set, a Type 1 PDCCH common search space set, a Type 2 PDCCH common search space set, a Type 3 PDCCH common search space set, and/or a UE-specific PDCCH search space set (UE-specific search space set).

The Type 0 PDCCH common search space set may be used as a common search space set having the index 0. The Type 0 PDCCH common search space set may be a common search space set having the index 0.

A CSS set is a general term for the Type 0 PDCCH common search space set, the Type 0a PDCCH common search space set, the Type 1 PDCCH common search space set, the Type 2 PDCCH common search space set, and the Type 3 PDCCH common search space set. A USS set is also referred to as a UE-specific PDCCH search space set.

A certain search space set is related to (included in or corresponds to) a certain control resource set. The index of the control resource set related to the search space set may be indicated by a higher layer parameter.

For a certain search space set, some or all of 6A to 6C may be indicated by at least a higher layer parameter:
6A) PDCCH monitoring periodicity
6B) PDCCH monitoring pattern within a slot
6C) PDCCH monitoring offset

The monitoring occasion of a certain search space set may correspond to the OFDM symbol to which the first OFDM symbol of a control resource set related to the certain search space set is mapped. The monitoring occasion of a certain search space set may correspond to a resource of a control resource set starting from the first OFDM symbol of the control resource set related to the certain search space set. The monitoring occasion of the search space set is given based at least on some or all of the monitoring periodicity of the PDCCH, the monitoring pattern of the PDCCH in a slot, and a monitoring offset of the PDCCH.

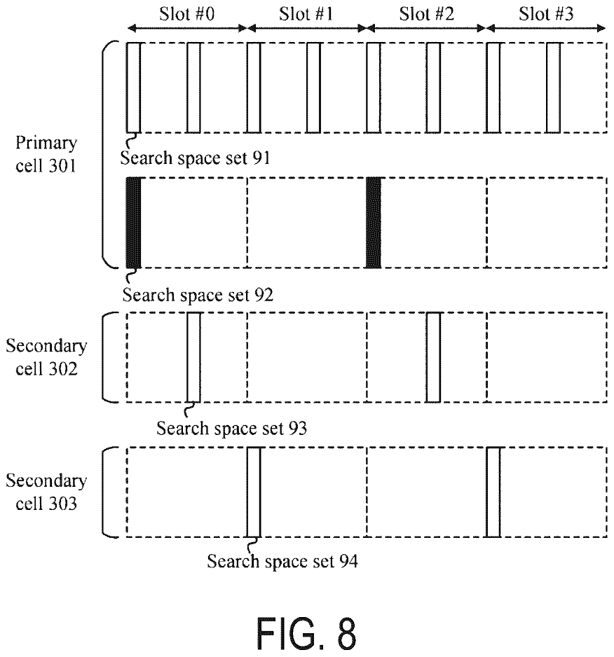

FIG. 8 is a diagram illustrating an example of the monitoring occasions for the search space sets according to an aspect of the present embodiment. In FIG. 8, search space set 91 and search space set 92 are configured in a primary cell 301, search space set 93 is configured in a secondary cell 302, and search space set 94 is configured in a secondary cell 303.

In FIG. 8, solid white blocks in the primary cell 301 represent the search space set 91, solid black blocks in the primary cell 301 represent the search space set 92, blocks in the secondary cell 302 represent the search space set 93, and blocks in the secondary cell 303 represent the search space set 94.

The monitoring periodicity of the search space set 91 is set to one slot, the monitoring offset of the search space set 91 is set to zero slots, and the monitoring pattern of the search space set 91 is set to [1, 0, 0, 0, 0, 0, 0, 1, 0, 0, 0, 0, 0, 0]. In other words, the monitoring occasions for the search space set 91 correspond to the first OFDM symbol (OFDM symbol #0) and the 8th OFDM symbol (OFDM symbol #7) in each of the slots.

The monitoring periodicity of the search space set 92 is set to two slots, the monitoring offset of the search space set 92 is set to zero slots, and the monitoring pattern of the search space set 92 is set to [1, 0, 0, 0, 0, 0, 0, 0, 0, 0, 0, 0, 0, 0]. In other words, the monitoring occasion for the search space set 92 corresponds to the first OFDM symbol (OFDM symbol #0) in each of the even-numbered slots.

The monitoring periodicity of the search space set 93 is set to two slots, the monitoring offset of the search space set 93 is set to zero slots, and the monitoring pattern of the search space set 93 is set to [0, 0, 0, 0, 0, 0, 0, 1, 0, 0, 0, 0, 0, 0]. In other words, the monitoring occasion for the search space set 93 corresponds to the 8th OFDM symbol (OFDM symbol #7) in each of the even-numbered slots.

The monitoring periodicity of the search space set 94 is set to two slots, the monitoring offset of the search space set 94 is set to one slot, and the monitoring pattern of the search space set 94 is set to [1, 0, 0, 0, 0, 0, 0, 0, 0, 0, 0, 0, 0, 0]. In other words, the monitoring occasion for the search space set 94 corresponds to the first OFDM symbol (OFDM symbol #0) in each of the odd-numbered slots.

The Type 0 PDCCH common search space set may be at least used for the DCI format with a Cyclic Redundancy Check (CRC) sequence scrambled by a System Information-Radio Network Temporary Identifier (SI-RNTI).

The Type 0a PDCCH common search space set may be at least used for the DCI format with a Cyclic Redundancy Check (CRC) sequence scrambled by a System Information-Radio Network Temporary Identifier (SI-RNTI).

The Type 1 PDCCH common search space set may be at least used for the DCI format with a CRC sequence scrambled by a Random Access-Radio Network Temporary Identifier (RA-RNTI) and/or a CRC sequence scrambled by a Temporary Cell-Radio Network Temporary Identifier (TC-RNTI).

The Type 2 PDCCH common search space set may be used for the DCI format with a CRC sequence scrambled by a Paging-Radio Network Temporary Identifier (P-RNTI).

The Type 3 PDCCH common search space set may be used for the DCI format with a CRC sequence scrambled by a Cell-Radio Network Temporary Identifier (C-RNTI).

The UE-specific PDCCH search space set may be at least used for the DCI format with a CRC sequence scrambled by C-RNTI.

In downlink communication, the terminal apparatus 1 detects a downlink DCI format. The detected downlink DCI format is at least used for resource assignment of the PDSCH. The detected downlink DCI format is also referred to as downlink assignment. The terminal apparatus 1 attempts reception of the PDSCH. A HARQ-ACK corresponding to the PDSCH (HARQ-ACK corresponding to the transport block included in the PDSCH) is reported to the base station apparatus 3 based on PUCCH resources indicated based on the detected downlink DCI format.

In uplink communication, the terminal apparatus 1 detects an uplink DCI format. The detected DCI format is at least used for resource assignment of the PUSCH. The detected uplink DCI format is also referred to as an uplink grant. The terminal apparatus 1 performs transmission of the PUSCH.

In configured scheduling (configured grant), the uplink grant for scheduling the PUSCH is configured for each transmission periodicity of the PUSCH. A part or all of pieces of information indicated by an uplink DCI format in a case that the PUSCH is scheduled by the uplink DCI format may be indicated by the uplink grant configured in a case of the configured scheduling.

The PUSCH transmission may correspond to a configured scheduling type 1 or a configured scheduling type 2. In other words, the configured scheduling may be any one of the configured scheduling type 1 or the configured scheduling type 2. A PUSCH transmission of the configured scheduling type 1 is semi-statically configured. For example, a PUSCH transmission of the configured scheduling type 1 may be operated in response to receiving a certain higher layer parameter. A certain higher layer parameter may be configuredGrantConfig. For example, configuredGrantConfig may include rrc-ConfiguredUplinkGrant. The PUSCH transmission may be operated without detecting an uplink grant in the DCI.

The PUSCH transmission of the configured scheduling type 2 may be semi-persistently scheduled. For example, the PUSCH transmission may be scheduled by a certain uplink grant. The certain uplink grant may be included in activation DCI (or valid activation DCI). For example, after receiving a certain higher layer parameter, the PUSCH transmission of the configured scheduling type 2 may be scheduled by a certain uplink grant. A certain higher layer parameter may be configuredGrantConfig. For example, configuredGrantConfig need not include rrc-ConfiguredUplinkGrant.

A system frame number (SFN) nr may be a number assigned to a radio frame and/or an index for a radio frame. The system frame number may include 10 bits. At least a part of the system frame number may be signaled in the MIB. For example, 6 bits (e.g., 6 most significant bits) of the 10-bit system frame number may be signaled in the MIB. At least a part of the system frame number may be determined based on the PBCH for conveying the MIB. For example, 4 bits (e.g., 4 least significant bits) of the 10-bit system frame number may be conveyed in a PBCH transport block as a part of channel coding.

PDCCH-Config may be a dedicated higher layer parameter PDCCH-Config may configure a parameter for a PDCCH. Multiple (for example, up to three) CORESETs may be configured in PDCCH-Config. A CORESET ID may be configured in one CORESET. One CORESET pool index may be configured in one CORESET.

PDSCH-Config may be a dedicated higher layer parameter. PDSCH-Config may configure a parameter for a PDSCH.

In a case that multiple PDCCH candidates (PDCCH candidate(s)) are associated with a search space set configured by a higher layer parameter, one PDCCH candidate is used. The one PDCCH candidate may be one of two PDCCH candidates that starts earlier. The higher layer parameter may be a searchSpaceLinking.

A MAC entity may include one HARQ entity in each serving cell. Each HARQ entity may manage one or multiple HARQ processes. Each HARQ process may be associated with a HARQ process identifier (ID). The HARQ entity may indicate (direct) HARQ information and the TB received on the DL-SCH to the corresponding HARQ process. The corresponding HARQ process may be a HARQ process corresponding to the HARQ process ID included in the HARQ information.

The number of HARQ processes may be given for each HARQ entity. For example, the respective HARQ processes may be in parallel. A dedicated broadcast HARQ process may be used for the BCCH.

The HARQ process may support one TB. For example, the HARQ process may be used for one TB. For example, the HARQ process may correspond to one TB. In a case that the physical layer is not configured for downlink spatial multiplexing, the HARQ process may support one TB. The HARQ process may support one or two TBs. For example, the HARQ process may correspond to one or two TBs. In a case that the physical layer is configured for downlink spatial multiplexing, the HARQ process may support one or two TBs.

The higher layer parameter may provide the number of TB transmissions. For example, the higher layer parameter may provide the number of TB transmissions in a bundle of downlink assignments. A bundling operation may rely on the HARQ entity. The same HARQ process may be invoked for each transmission that is part of the same bundle. The bundling operation may rely on the HARQ entity to invoke the same HARQ process for each transmission that is part of the same bundle. After an initial transmission, a certain number of HARQ retransmissions may be performed. The certain number may be a value of a higher layer parameter, pdsch-AggregationFactor, minus 1.

The MAC entity may assign the TB and the HARQ information to the HARQ process. For example, in a case that the downlink assignment is indicated, the MAC entity may assign the TB and the HARQ information to the HARQ process. The HARQ processes may be indicated by the HARQ information. The HARQ information may be associated with the TB. For example, the HARQ information may indicate the TBS of the TB. The TB may be received from the physical layer. For example, in a case that the downlink assignment is indicated for the broadcast HARQ process, the MAC entity may assign the received TB to the broadcast HARQ process.

The HARQ information may be HARQ information for any of the DL-SCH, the UL-SCH, and the SL-SCH. The HARQ information may include some or all of a New Data Indicator (NDI), a Transport Block Size (TBS), a Redundancy Version (RV), and a HARQ process ID.

A certain transmission may be performed corresponding to the HARQ process. For example, in a case that a certain transmission is performed in the HARQ process, one or two TBs and the HARQ information may be received from the HARQ entity. The HARQ process may assume that the certain transmission is a new transmission. For example, in a case that the NDI is toggled, the HARQ process may assume that the certain transmission is a new transmission. For example, for each certain TB, in a case that the NDI is toggled compared to a value of the previously received transmission corresponding to the certain TB, the certain transmission may be assumed to be a new transmission. For example, in a case that the HARQ process is at least equal to a broadcast process, the HARQ process may assume that the certain transmission is a new transmission. For example, in a case that there is no previous NDI for the certain TB, the HARQ process corresponding to the certain TB may assume that the certain transmission is a new transmission. The new transmission may be an initial transmission. In a case that the certain transmission is not a new transmission, the certain transmission may be a retransmission. For example, in a case that the NDI is not toggled, the certain transmission may be a retransmission.

In a case that the certain transmission is a new transmission, the MAC entity may attempt to decode the received data. In a case that the certain transmission is a retransmission, the MAC entity may indicate to the physical layer that the received data and data in a soft buffer combined. The MAC entity may attempt to decode the combined data. The data may correspond to a TB. The soft buffer may correspond to a TB. The HARQ process may be equal to a broadcast process. In a case that certain data is successfully decoded, the MAC entity may transmit the decoded data (e.g., MAC PDU) to a higher layer. In a case that the certain data is failed to be decoded, the MAC entity may indicate to the physical layer that the certain data is placed in the soft buffer. The MAC entity may indicate to the physical layer that an Acknowledgement(s) (ACK) of the data is generated. The MAC entity may ignore the NDI. For example, the NDI may be received in all the downlink assignments. The downlink assignment may be in the PDCCH. The PDCCH may correspond to a Temporary C-RNTI (TC-RNTI). For example, in a case of determining whether the NDI in the PDCCH corresponding to the C-RNTI is toggled, the MAC entity may ignore the NDI in the PDCCH corresponding to the TC-RNTI. The NDI being toggled may mean that the NDI is toggled compared to the value in the previous transmission.

Semi-persistent scheduling (SPS) may be configured (or provided) by a higher layer parameter. The SPS may be configured for each BWP in one serving cell by the RRC layer. For example, the SPS may be provided for each BWP in one serving cell by the RRC layer. In one BWP, multiple configured downlink assignments may be activated. The activation and deactivation of the SPS may be independent between the multiple serving cells. For example, in a case that first SPS in a first serving cell is activated, a second SPS in a second serving cell may be activated or deactivated.

The fact that the SPS is activated may mean that activation of the configured downlink assignment is performed. The fact that the SPS is activated may mean that the configured downlink assignment is activated. The fact that the SPS is activated may mean SPS activation is indicated. The fact that the SPS is activated may mean that the configured downlink assignment is initiated (or resumed, or stored). The fact that the SPS is activated may mean that activation PDCCH verification is achieved. The fact that the SPS is activated may mean that a special field in a DCI format has a specific value and verification of the DCI format is achieved. The fact that the SPS is activated may mean an SPS PDSCH is activated. The fact that the SPS is activated may mean a PDSCH is activated.

The fact that the SPS is deactivated may mean that deactivation of the configured downlink assignment is performed. The fact that the SPS is deactivated may mean that the configured downlink assignment is deactivated. The fact that the SPS is deactivated may mean SPS deactivation is indicated. The fact that the SPS is deactivated may mean that the configured downlink assignment is discarded (cleared) or released. The fact that the SPS is deactivated may mean that deactivation PDCCH verification is achieved. The fact that the SPS is deactivated may mean that a special field in the DCI format has a specific value and verification of the DCI format is achieved. The fact that the SPS is deactivated may mean an SPS PDSCH is deactivated. The fact that the SPS is deactivated may mean a PDSCH is deactivated.

The configured downlink assignment may be a downlink SPS assignment. The configured downlink assignment may be a downlink assignment for an SPS PDSCH.

The SPS PDSCH may be a PDSCH without a corresponding PDCCH. The SPS PDSCH may be a PDSCH without a corresponding PDCCH transmission. The SPS PDSCH may be an activated PDSCH. The PDSCH may be received without a corresponding PDCCH transmission. The SPS PDSCH may be a PDSCH scheduled by the configured downlink assignment. The SPS PDSCH may be a PDSCH of which transmission is indicated by the configured downlink assignment. The SPS PDSCH may be a PDSCH using a higher layer parameter, sps-Config. The SPS PDSCH may be a PDSCH activated by the DCI format 1_1 or a DCI format 1_2. The SPS PDSCH may be a PDSCH scheduled without a corresponding PDCCH transmission using sps-Config. The SPS PDSCH may be a PDSCH activated by a DCI format 4_2. The SPS PDSCH may be a PDSCH with SPS.

An SPS PDSCH configuration may be a higher layer parameter, SPS-Config. The SPS PDSCH configuration may be a configuration for an SPS.

A period for the SPS PDSCH may be a period in the SPS PDSCH configuration. The period for the SPS PDSCH may be a period of the configured downlink assignment. The period for the SPS PDSCH may be a period for the SPS. The period for the SPS PDSCH may be a higher layer parameter, periodicity, or a value of the higher layer parameter, periodicity. The period for the SPS PDSCH may be a value provided in the DCI format.

In the SPS, one downlink assignment may be provided by the PDCCH. One downlink assignment may be saved (stored) based on physical layer signalling indicating activation. One downlink assignment may be discarded (cleared) based on physical layer signalling indicating deactivation.

One or multiple higher layer parameters may be configured for the SPS. For example, one or multiple higher layer parameters may include some or all of the following higher layer parameters. One SPS configuration may include some or all of the following higher layer parameters. The SPS PDSCH configuration may include some or all of the following higher layer parameters.
CS-RNTI
nrofHAQR-processes
harq-ProcID-Offset
periodicity

The higher layer parameter, cs-RNTI, may be a value of the RNTI for the scheduling configured in the downlink and/or the uplink. cs-RNTI may be used for any of activation, deactivation, and retransmission.

The number of HARQ processes for the SPS may be provided by a higher layer parameter. For example, the higher layer parameter, nrofHARQ-processes, may provide the number of HARQ processes configured for the SPS. The HARQ process may be managed by a HARQ entity. The terminal apparatus 1 may assign the transport block received from the physical layer and the HARQ information to the HARQ process indicated by the HARQ information.

An offset may be provided for the HARQ process ID by a higher layer parameter For example, the offset used in deriving the HARQ process ID may be provided by a higher layer parameter. An offset of the HARQ process for the SPS may be determined by a higher layer parameter. The higher layer parameter may be harq-ProcID-Offset.

A period of the configured downlink assignment for the SPS may be configured by a higher layer parameter. A period for the SPS may be configured by a higher layer parameter. A period for the SPS PDSCH may be configured by a higher layer parameter. A period of the configured downlink assignment may be configured by a higher layer parameter. Being configured by a higher layer parameter may mean being provided by the higher layer parameter. Being configured by a higher layer parameter may mean being determined based on the higher layer parameter. A period may be based on a subcarrier spacing. A period may be provided using a unit of milliseconds. A period may be provided using a frame rate (FPS: frames per second). A period may be provided using an inverse of the frame rate. A period may be an integer. A period may be a real number. A period may be equal to or less than 10 milliseconds. A period may be updated by a DCI format. A period may be indicated by the DCI format. The higher layer parameter may be the higher layer parameter, periodicity.

The configuration for the SPS (or a PDSCH SPS configuration) may be indexed. One or multiple SPS configurations may be provided. Indices of one or multiple SPS configurations may be configured by a higher layer parameter. The higher layer parameter may be sps-ConfigIndex. The higher layer parameter may be referred to as an SPS PDSCH configuration index.

After the downlink assignment for the SPS is configured, a first downlink assignment may occur in a first slot. The first slot may be determined based on one or multiple elements. One or multiple elements may include the number of slots in one radio frame (N^{frame, μ}ₛₗₒₜ). One or multiple elements may include a system frame number. One or multiple elements may include a slot number (slot index) in one radio frame. One or multiple elements may include a period for the SPS. One or multiple elements may include the higher layer parameter, periodicity. A second downlink assignment may occur in a second slot. The second slot may be a slot periodicity x N^{frame, μ}ₛₗₒₜ/10 after the first slot. The PDSCH transmitted by the second downlink assignment may be retransmission of the PDSCH transmitted by the first downlink assignment.

The downlink assignment information may be provided by the PDCCH The downlink assignment may be received on the PDCCH. The downlink assignment may indicate that the DL-SCH is transmitted in one MAC entity. The downlink assignment may indicate that there is a transmission in the DL-SCL in the MAC entity. The downlink assignment may provide the HARQ information.

Multiple Transmission Reception Points (Transmit/Receive Points or TRPs) may be used. The base station apparatus 3 may include multiple TRPs (Multi-TRP). The terminal apparatus 1 may be scheduled by two TRPs in one serving cell. In Multi-TRP, the operation mode of one of single-DCI and multi-DCI may be used. In Multi-TRP, uplink control may be completed in the MAC layer and the physical layer. In Multi-TRP, downlink control may be completed in the MAC layer and the physical layer. In the Single-DCI mode, the terminal apparatus 1 may be scheduled by the same DCI for two TRPs. In a Multi-DCI mode, the terminal apparatus 1 may be scheduled by independent DCI from each TRP. In the Multi-DCI mode, each TRP in the Multi-TRP may be identified by TRP information. In other words, one TRP in the Multi-TRP may be identified by one piece of TRP information. The TRP information may be used to select one TRP. In addition, an index of a Control Resource Set (CORESET) resource pool may be associated with one CORESET. The terminal apparatus 1 may transmit the PUSCH based on the index of the CORESET resource pool. The terminal apparatus 1 may transmit the PDCCH and the PDSCH based on the index of the CORESET resource pool. The TRP information may be a CORESET pool index. The TRP information may be given by a TRP indicator field. The TRP information may be included in a spatial setting.

The terminal apparatus 1 may form a beam (beamforming). For example, the terminal apparatus 1 may transmit a radio wave (electromagnetic waves) in a specific spatial direction by beamforming. For example, the terminal apparatus 1 may receive a radio wave from a specific spatial direction by beamforming. The terminal apparatus 1 may include and use one or multiple antennas for one or both of transmission and reception of a radio wave. A directional radio wave may be referred to as a beam. Information related to a beam may be referred to as beam information. For example, the beam information may be a specific spatial direction. For example, the beam information may be an arrival direction of a radio wave. The beam information may be a TCI state. The beam information may be an uplink transmission spatial filter. The beam information may be an SRS resource indicator. The beam information may be a QCL assumption or a QCL relationship. The beam information may be a spatial setting.

The uplink control information (UCI) or a UCI type may be reported in the PUCCH. For example, the UCI type may include some or all of the HARQ-ACK information, the scheduling request (SR), a link recovery request (LRR), and the channel state information (CSI). UCI bits (UCI information bits) may include some or all of the HARQ-ACK information bits, SR information bits, LRR information bits, and CSI bits.

The terminal apparatus 1 may transmit a PUCCH. For example, the terminal apparatus 1 may transmit a PUCCH with the HARQ-ACK information. For example, the HARQ-ACK information may be HARQ-ACK information for the reception of the SPS PDSCH. For example, the HARQ-ACK information may be HARQ-ACK information for the release of the SPS PDSCH.

The PUCCH resource may be determined for the PUCCH transmission. For example, the PUCCH resource may be determined using the PUCCH resource indicator field (PUCCH resource indicator). The PUCCH resource may be determined for the PUCCH transmission. The PUCCH resource indicator field may be included in a DCI format for scheduling the PDSCH reception. One slot may be determined for the PUCCH transmission.

The terminal apparatus 1 may transmit one or two PUCCHs in one slot. For example, the terminal apparatus 1 may transmit two PUCCHs in different OFDM symbols in one slot. In a case that a Separate ACK/NACK feedback mode is not configured and in a case that the terminal apparatus 1 transmits two PUCCHs in one slot, one of the two PUCCHs may use a PUCCH format 0 or a PUCCH format 2. In a case that the Separate ACK/NACK feedback mode is configured, the terminal apparatus 1 may transmit two PUCCHs in different OFDM symbols in one slot.

The fact that First CORESETs are provided may mean that a CORESET pool index having the value 0 is provided for First CORESETs. The fact that First CORESETs are provided may mean that no CORESET pool index is provided. The fact that Second CORESETs are provided may mean that a CORESET pool index having the value 1 is provided for Second CORESETs. One or both of the First CORESETs and the Second CORESETs may be CORESETs in one or multiple serving cells and one or multiple active DL BWPs.

The fact that the Separate ACK/NACK feedback mode is configured may mean that a higher layer parameter, ackNackFeedbackMode, set to ‘separate’ is provided. The fact that a Joint ACK/NACK feedback mode is configured may mean that the higher layer parameter, ackNackFeedbackMode, set to ‘joint’ is provided.

In a case that First CORESETs are provided, and in a case that Second CORESETs are provided, and in a case that the Separate ACK/NACK feedback mode is configured, the terminal apparatus 1 may separately perform processing for reporting the HARQ-ACK information associated with First CORESETs and processing for reporting the HARQ-ACK information associated with Second CORESETs. The reporting of HARQ-ACK information may be associated with one CORESET through the PDCCH reception with a DCI format (DCI) that triggers the reporting of HARQ-ACK information.

The PUCCH resource set may be provided by a higher layer parameter. For example, a first PUCCH resource set may be provided by a higher layer parameter, PUCCH-ResourceSet, in a higher layer parameter, PUCCH-Config. For example, a second PUCCH resource set may be provided by a higher layer parameter, PUCCH-ResourceCommon. The second PUCCH resource set may be provided for transmitting the HARQ-ACK information in the PUCCH in an initial uplink BWP (Initial UL BWP). The terminal apparatus 1 may be configured with up to four PUCCH resource sets. For example, up to four PUCCH resource sets may be configured in one PUCCH configuration (the higher layer parameter, PUCCH-Config).

One PUCCH resource set may include up to 16 PUCCH resources. One PUCCH resource may correspond to some or all of one PUCCH format, one first OFDM symbol, one time period, one PRB offset, and one set of cyclic shift indices for the PUCCH transmission.

One PUCCH resource set may be provided by the higher layer parameter, PUCCH-ResourceSet. One PUCCH resource set may be associated with one PUCCH resource set index. One PUCCH resource set index may be provided by a higher layer parameter, pucch-ResourceSetId. One PUCCH resource set may be associated with a set of PUCCH resource indices. One set may be provided by a higher layer parameter, resourceList. One set may provide a set of pucch-Resourceld. One PUCCH resource set may be associated with the maximum number of UCI information bits. The maximum number of UCI information bits may be the maximum number of UCI information bits that the terminal apparatus 1 can transmit by using one PUCCH resource. The maximum number of UCI information bits may be provided by a higher layer parameter, maxPayloadSize.

The terminal apparatus 1 may be configured with the first PUCCH resource set, the second PUCCH resource set, a third PUCCH resource set, and a fourth PUCCH resource set. In the first PUCCH resource set, the maximum number of UCI information bits may be two. The maximum number of PUCCH resources in the first PUCCH resource set may be 32. The maximum number of PUCCH resources in each of the second, third, and fourth PUCCH resource sets may be eight.

One PUCCH resource may include some or all of a parameter 1, a parameter 2, a parameter 3, a parameter 4, a parameter 5, and a parameter 6. The parameter 1 may be a PUCCH resource index. The parameter 1 may be the higher layer parameter, pucch-Resourceld. The parameter 2 may be an index of a first leading PRB. The index of the first leading PRB may be an index of the leading PRB before frequency hopping. The parameter 2 may be a higher layer parameter, startingPRB. The parameter 3 may be an index of a second leading PRB. The index of the second leading PRB may be an index of the leading PRB after frequency hopping. The parameter 3 may be provided by a higher layer parameter, secondHopPRB. The parameter 4 may be an indication of intra-slot frequency hopping. The parameter 4 may be a higher layer parameter, intraSlotFrequencyHopping. The parameter 5 may be an index of an RB set. The parameter 5 may be a higher layer parameter, rb-SetIndex. The parameter 6 may be a PUCCH format or a configuration for the PUCCH format. The parameter 6 may be provided by a higher layer parameter, format.

The PUCCH format 0 may be provided for the terminal apparatus 1. The fact that the PUCCH format 0 is provided may mean that the higher layer parameter, format, indicates PUCCH-format 0. In a case that the PUCCH format 0 is provided, the PUCCH format configured for one PUCCH resource may be the PUCCH format 0. One PUCCH resource may include an index of an initial cyclic shift. One PUCCH resource may include the number of OFDM symbols for the PUCCH transmission. One PUCCH resource may include the first OFDM symbol for the PUCCH transmission. The index of the initial cyclic shift may be provided by a higher layer parameter, initialCyclicShift. The number of OFDM symbols may be provided by a higher layer parameter, nrofSymbols. The first OFDM symbol may be provided by a higher layer parameter, startingSymbolIndex.

The PUCCH format 1 may be provided for the terminal apparatus 1. The fact that the PUCCH format 1 is provided may mean that the higher layer parameter, format, indicates PUCCH-format 1. In a case that the PUCCH format 1 is provided, the PUCCH format configured for one PUCCH resource may be the PUCCH format 1. One PUCCH resource may include an index of an initial cyclic shift. One PUCCH resource may include the number of OFDM symbols for the PUCCH transmission. One PUCCH resource may include the first OFDM symbol for the PUCCH transmission. One PUCCH resource may include an index of an orthogonal cover code (OCC). The index of the OCC may be provided by a higher layer parameter, timeDomainOCC.

The PUCCH format 2 or a PUCCH format 3 may be provided for the terminal apparatus 1. The fact that the PUCCH format 2 or the PUCCH format 3 is provided may mean that the higher layer parameter, format, indicates PUCCH-format 2 or PUCCH-format3. In a case that the PUCCH format 2 is provided, the PUCCH format configured for one PUCCH resource may be the PUCCH format 2. In a case that the PUCCH format 3 is provided, the PUCCH format configured for one PUCCH resource may be the PUCCH format 3. One PUCCH resource may include the number of PRBs. One PUCCH resource may include the number of OFDM symbols for the PUCCH transmission. One PUCCH resource may include the first OFDM symbol for the PUCCH transmission. One PUCCH resource may include a length of the OCC and an index of the OCC. The number of PRBs may be provided by a higher layer parameter, nrofPRBs. The length of the OCC may be provided by a higher layer parameter, occ-Length. The index of the OCC may be provided by a higher layer parameter, occ-Index.

A PUCCH format 4 may be provided for the terminal apparatus 1. The fact that the PUCCH format 4 is provided may mean that the higher layer parameter, format, indicates PUCCH-format 4. In a case that the PUCCH format 4 is provided, the PUCCH format configured for one PUCCH resource may be the PUCCH format 4. One PUCCH resource may include the number of OFDM symbols for the PUCCH transmission, the length of the OCC, the index of the OCC, and the first OFDM symbol for the PUCCH transmission.

The terminal apparatus 1 may transmit the PUCCH using a first uplink transmission spatial filter. For example, the first uplink transmission spatial filter may be the same as an uplink transmission spatial filter for the PUCCH transmission scheduled by a random access response-uplink grant (Random Access Response UL grant: RAR UL grant). The uplink transmission spatial filter may be referred to as a spatial domain transmission filter.

The terminal apparatus 1 may provide the HARQ-ACK information in the PUCCH transmission. For example, the terminal apparatus 1 may provide the HARQ-ACK information in the PUCCH transmission in response to detecting the DCI format scheduling the PDSCH reception. The terminal apparatus 1 may determine the PUCCH resource. For example, in a case that the terminal apparatus 1 provides the HARQ-ACK information, the terminal apparatus 1 may determine the PUCCH resource based on the index of the PUCCH resource. The index of the PUCCH resource may be an integer from 0 to 15. The index of the PUCCH resource may be determined based on some or all of the number of CCEs in the CORESET, the index of the first CCE, and the PUCCH resource indicator field (PRI field).

The terminal apparatus 1 may transmit O_{UCI} bits. The O_{UCI} bits may be bits of the UCI information and may include the HARQ-ACK information bits. The terminal apparatus 1 may determine one PUCCH resource set based on the UCI information bits (O_{UCI}). In a case that O_{UCI} is equal to or less than 2, the terminal apparatus 1 may determine the first PUCCH resource set. The first PUCCH resource set may be a set of PUCCH resources in which pucch-ResourceSetId is set to 0. In the first PUCCH resource set, O_{UCI} may include one or two HARQ-ACK information bits, and may include a positive or negative SR.

In a case that O_{UCI} is more than 2 and equal to or less than N₂, the terminal apparatus 1 may determine the second PUCCH resource set. N₂ may be determined by a higher layer parameter. For example, N₂ may be the same as the higher layer parameter, maxPayloadSize, provided for the second PUCCH resource set. The second PUCCH resource set may be a set of PUCCH resources in which pucch-ResourceSetId is set to 1. N₂ may be 1706.

In a case that O_{UCI} is more than N₂ and equal to or less than N₃, the terminal apparatus 1 may determine the third PUCCH resource set. N3 may be determined by a higher layer parameter. For example, N₃ may be the same as the higher layer parameter, maxPayloadSize, provided for the third PUCCH resource set. The third PUCCH resource set may be a set of PUCCH resources in which pucch-ResourceSetId is set to 2. N₃ may be 1706.

In a case that O_{UCI} is more than N₃ and equal to or less than 1706, the terminal apparatus 1 may determine the fourth PUCCH resource set. The fourth PUCCH resource set may be a set of PUCCH resources in which pucch-ResourceSetId is set to 3.

The terminal apparatus 1 may determine one PUCCH resource. For example, the terminal apparatus 1 may determine one PUCCH resource based on the UCI information bits (O_{UCI}). The UCI information bits may include the HARQ-ACK information bits for one or both of the reception of the SPS PDSCH and the SR. The terminal apparatus 1 may be provided with SPS-PUCCH-AN-List. SPS-PUCCH-AN-List may indicate a list of PUCCH resources. For example, the SPS-PUCCH-AN-List may include up to four SPS-PUCCH-ANs. SPS-PUCH-AN may correspond to one sps-PUCCH-AN-ResourceID. sps-PUCCH-AN-ResourceID may be an ID (index) of the PUCCH resource. Therefore, one PUCCH resource may be provided by sps-PUCCH-AN-ResourceID.

The fact that the PUCCH format 0 is provided may mean that the terminal apparatus 1 transmits the UCI on the PUCCH using the PUCCH format 0. In a case that PUCCH format 0 is provided, the UCI transmission on the PUCCH may be over one OFDM symbol or two OFDM symbols. In the case that the PUCCH format 0 is provided, the HARQ-ACK information bits (the number of information bits) may be one or two. The HARQ-ACK information bits may involve a positive or negative SR.

The fact that the PUCCH format 1 is provided may mean that the terminal apparatus 1 transmits the UCI on the PUCCH using the PUCCH format 1. In a case that PUCCH format 1 is provided, the UCI transmission on the PUCCH may be over four or more OFDM symbols. In the case that the PUCCH format 1 is provided, the HARQ-ACK information bits may be one or two.

The fact that the PUCCH format 2 is provided may mean that the terminal apparatus 1 transmits the UCI on the PUCCH using the PUCCH format 2. In a case that PUCCH format 2 is provided, the UCI transmission on the PUCCH may be over one or two OFDM symbols. In the case that the PUCCH format 2 is provided, the number of UCI information bits (UCI bits) may be more than two.

The fact that the PUCCH format 3 is provided may mean that the terminal apparatus 1 transmits the UCI on the PUCCH using the PUCCH format 3. In a case that PUCCH format 3 is provided, the UCI transmission on the PUCCH may be over four or more OFDM symbols. In the case that the PUCCH format 3 is provided, the number of UCI information bits (UCI bits) may be more than two. In the case that the PUCCH format 3 is provided, the PUCCH resource may not include the OCC. The number of DMRS symbols for the PUCCH transmission using the PUCCH format 3 may be provided by a higher layer parameter (e.g., additionalDMRS). For the PUCCH transmission using the PUCCH format 3, π/2 BPSK may be used.

The fact that the PUCCH format 4 is provided may mean that the terminal apparatus 1 transmits the UCI on the PUCCH using the PUCCH format 4. In a case that PUCCH format 4 is provided, the UCI transmission on the PUCCH may be over four or more OFDM symbols. In the case that the PUCCH format 4 is provided, the number of UCI information bits (UCI bits) may be more than two. In the case that the PUCCH format 4 is provided, the PUCCH resource may include the OCC. The number of DMRS symbols for the PUCCH transmission using the PUCCH format 4 may be provided by a higher layer parameter (e.g., additionalDMRS). For the PUCCH transmission using the PUCCH format 4, π/2 BPSK may be used.

A spatial setting may be provided for the PUCCH transmission. The spatial setting may be provided by a TCI state. The TCI state may be TCI-State or TCI-UL-State. For example, the spatial setting may be provided by an indicated TCI state. The spatial setting may be the indicated TCI state. The spatial setting may be an uplink transmission spatial filter (UL Tx Spatial filter) or a setting for the uplink transmission spatial filter. The spatial setting may be a spatial domain filter or a setting for the spatial domain filter. In other words, the spatial domain filter may be referred to as the uplink transmission spatial filter.

The spatial setting may be provided by a higher layer parameter. For example, the spatial setting may be provided by a higher layer parameter, PUCCH-SpatialRelationInfo. In this case, the terminal apparatus 1 may be configured with one value for a higher layer parameter, pucch-SpatialRelationInfold. The spatial setting may be PUCCH-SpatialRelationInfo, The terminal apparatus 1 may be provided with multiple spatial settings.

The terminal apparatus 1 may apply the setting for the spatial domain filter or uplink transmission spatial filter. For example, the terminal apparatus 1 may apply the setting for the spatial domain filter or uplink transmission spatial filter to transmit a first PUCCH in the first slot. The first slot may be the first slot, slot k+3N^{subframe, μ}ₛₗₒₜ after. The slot k may be a slot in which a second PUCCH with first HARQ-ACK information corresponding to a first PDSCH reception is transmitted. The first PDSCH may provide the spatial setting (PUCCH-SpatialRelationInfo). The first HARQ-ACK information may involve an ACK.

In a case that the spatial setting provides a first index (e.g., ssb-Index) of the SS/PBCH block, the terminal apparatus 1 may transmit the PUCCH using a first spatial domain filter. The first spatial domain filter may be a spatial domain filter to receive an SS/PBCH block with a first index. For example, PUCCH-SpatialRelationInfo may provide ssb-Index. For example, the indicated TCI state may provide ssb-Index. For example, indicated TCI-UL-State may provide ssb-Index.

In a case that the spatial setting provides a second index (e.g., csi-RS-Index) of the CSI-RS, the terminal apparatus 1 may transmit the PUCCH by using a second spatial domain filter, The second spatial domain filter may be a spatial domain filter to receive a second CSI-RS with a second index. For example, PUCCH-SpatialRelation Info may provide csi-RS-Index. For example, the indicated TCI state may provide csi-RS-Index. For example, an indicated UL TCI state may provide csi-RS-Index. In a case that the indicated TCI state provides a reference signal (e.g., a second csi-rs) configured with qcl-Type set to typeD, the terminal apparatus 1 may transmit the PUCCH using the second spatial domain filter.

In a case that the spatial setting provides a third SRS, the terminal apparatus 1 may transmit the PUCCH using a third spatial domain filter. The third spatial domain filter may be a spatial domain filter to transmit the third SRS. The third SRS may involve one resource ID.

In a case that a condition 1 is satisfied, the spatial setting for a first PUCCH transmission may be the same as the spatial setting for a first PDCCH reception. The first PDCCH may be a PDCCH in a first CORESET in the active DL BWP of the PCell (primary cell). The first CORESET may involve the lowest ID. In a case that the first CORESET has two activated TCI states (first TCI state and second TCI state), the terminal apparatus 1 may determine the spatial setting for the first PUCCH transmission, based on the first TCI state. In a case that repetition is applied to the first PUCCH, the same spatial setting may be applied to the first PUCCH transmission in each of the multiple slots. The condition 1 may be some or all of the following: a higher layer parameter, pathlossReferenceRSs, is not provided in a higher layer parameter, PUCCH-PowerControl, a higher layer parameter, enableDefaultBeamPL-ForPUCCH is provided, the higher layer parameter, PUCCH-SpatialRelationInfo, is not provided, Second CORESETs or First CORESETs are not provided, and two TCI states are not mapped to the codepoint in the TCI field.

The repetition may be applied for the PUCCH. The fact that the repetition is applied for the PUCCH may mean that the terminal apparatus 1 transmits the PUCCH over N^{repear}_{PUCCH} slots. The terminal apparatus 1 may transmit one PUCCH in N^{repeat}_{PUCCH} slots using one PUCCH resource. One PUCCH resource may be indicated by the DCI format (DCI). In a case that one PUCCH resource is indicated by the DCI and in a case that one PUCCH resource includes the first number of repetitions, N^{repeat}_{PUCCH} may be provided by the first number of repetitions. In a case that one PUCCH resource is not indicated by the DCI, N^{repeat}_{PUCCH} may be provided by the second number of repetitions. In a case that one PUCCH resource does not include the first number of repetitions, N^{repeat}_{PUCCH} may be provided by the second number of repetitions. The first number of repetitions may be a higher layer parameter, pucch-RepetitionNrofSlots. The second number of repetitions may be a higher layer parameter, nrofSlots.

The fact that the repetition is applied for the PUCCH may mean that N^{repeat}_{PUCCH} is more than 1. In a case that N^{repeat}_{PUCCH} is more than 1, the terminal apparatus 1 may repeat the PUCCH transmission with the UCI in N^{repeat}_{PUCCH} slots. The PUCCH transmission in each of N^{repeat}_{PUCCH} slots may have the same number of OFDM symbols. The number of OFDM symbols may be provided by the higher layer parameter, nrofSymbols. The PUCCH transmission in each of N^{repeat}_{PUCCH} slots may have the same first OFDM symbol. The first OFDM symbol may be provided by the higher layer parameter, startingSymbolIndex.

One PUCCH resource may include two spatial settings. In a case that one PUCCH resource used for the repetition of the PUCCH transmission includes two spatial settings and in a case that N^{repeat}_{PUCCH} is 2, a first spatial setting may be used for a first repetition of the PUCCH transmission, and a second spatial setting may be used for a second repetition of the PUCCH transmission. In a case that one PUCCH resource used for the repetition of the PUCCH transmission includes two spatial settings, the terminal apparatus 1 may alternately switch between the first spatial setting and the second spatial setting for each of N^{switch}_{PUCCH} repetitions of the PUCCH transmission. For example, in cyclic mapping (cyclicMapping), N^{switch}_{PUCCH} may be 1. For example, in sequence mapping (sequentialMapping), N^{switch}_{PUCCH} may be 2.

The terminal apparatus 1 may be configured with a higher layer parameter TCI-State. For example, the terminal apparatus 1 may be configured with one list in the higher layer parameter PDSCH-Config. One list may include up to M higher layer parameters TCI-State. One list may be a list of up to M higher layer parameters TCI-State. The terminal apparatus 1 may be configured with one list in order to decode (receive) the PDSCH according to the PDCCH with the DCI. M may depend on the terminal capability (UE capability). For example, M may depend on the terminal capability maxNumberConfiguredTCIStatePerCC. TCI-State may be referred to as a TCI state.

Each TCI-State (i.e., higher layer parameter TCI-State) may include a parameter for configuring a QCL (quasi co-location (QCL relationship)). The QCL relationship may be a relationship between one or two downlink reference signals (downlink physical signals) and a DMRS (DMRS port) of a PDSCH. The QCL relationship may be a relationship between one or two downlink reference signals (downlink physical signals) and a DMRS (DMRS port) of a PDCCH. The QCL relationship may be a relationship between one or two downlink reference signals (downlink physical signals) and a CSI-RS (CSI-RS port) of one CSI-RS resource. For example, the QCL relationship between a channel/signal A and a channel/signal B may indicate that the channel/signal A is QCLed with the channel/signal B.

The QCL relationship may be configured by one or both of a higher layer parameter qcl-Type1 and a higher layer parameter qcl-Type2. For example, the QCL relationship may be configured by one or both of the higher layer parameter qcl-Type1 for a first downlink reference signal (DL RS) and the higher layer parameter qcl-Type2 for a second downlink reference signal. In a case that the first downlink reference signal and the second downlink reference signal are different from each other, a QCL type of qcl-Type1 need not be the same as a QCL type of qcl-Type2. A QCL type corresponding to each downlink reference signal may be given by a higher layer parameter qcl-Type in a higher layer parameter QCL-Info. The QCL type may be any one of typeA, typeB, typeC, and typeD.

The terminal apparatus 1 may be configured with a higher layer parameter DLorJointTCIState. For example, the terminal apparatus 1 may be configured with one list in the higher layer parameter PDSCH-Config. One list may include up to 128 higher layer parameters DLorJointTCIState (TCIState). One list may be a list of up to 128 higher layer parameters DLorJointTCIState (TCIState). One list may be configured to provide one reference signal. The higher layer parameter DLorJointTCIState (TCIState) may be configured to provide one reference signal. One reference signal may be a reference signal for the QCL for the DMRS of the PDSCH and the DMRS of the PDCCH. One reference signal may be a reference signal for the CSI-RS. One list may be configured to provide one reference. The higher layer parameter DLorJointTCIState may be configured to provide one reference. One reference may be used to determine an uplink transmission spatial filter (UL TX spatial filter). The uplink transmission spatial filter may be used for a PUSCH, a PUCCH, and an SRS. In other words, one reference may be provided to determine uplink transmission spatial filters for a PUSCH, a PUCCH, and an SRS. The TCI state may be DLorJointTCIState (TCIState). DLorJointTCIState may be referred to as a DL/Joint TCI state or a unified TCI state. One list may be dl-OrJoint-TCIStateList.

The terminal apparatus 1 may be configured with the higher layer parameter UL-TCIState. For example, the terminal apparatus 1 may be configured with one list in a higher layer parameter BWP-UplinkDedicated. One list may include up to 64 higher layer parameters UL-TCIState. One list may be a list of up to 64 higher layer parameters UL-TCIState. Each UL-TCIState (or UL-TCIState configuration) may include a parameter for configuring one reference signal. For example, each UL-TCIState may include one parameter for configuring one reference signal for determining the uplink transmission spatial filter for some or all of a PUSCH, a PUCCH, and an SRS. One list may be a higher layer parameter ul-TCI-StateList. The TCI state may be UL-TCIState. UL-TCIState may be referred to as a UL TCI state or a unified TCI state.

UL-TCIState may be a higher layer parameter TCI-UL-State. UL-TCIState may be configured by the higher layer parameter TCI-UL-State. The higher layer parameter TCI-UL-State may associate one or two downlink reference signals with a corresponding QCL type.

In a case that DLorJointTCIState or UL-TCIState is configured, the terminal apparatus 1 may transmit the PUSCH or PUCCH according to a spatial relation. For example, the spatial relationship may be a relationship with reference to one reference signal (RS). For example, one reference signal may be a reference signal for determining the uplink transmission spatial filter. One reference signal may be a reference signal configured with qcl-Type set to typeD in the “indicated TCI state”. The “indicated TCI state” may be indicated DLorJointTCIState or indicated UL-TCIState. A reference RS in indicated DLorJointTCIState may be a CSI-RS resource in a higher layer parameter NZP-CSI-RS-ResourceSet. A reference RS in the indicated UL-TCIState may be a CSI-RS resource in NZP-CSI-RS-ResourceSet. Indicated UL-TCIState (Indicated UL-TCIState) may be a TCI state, a UL TCI state, or a unified TCI state indicated by the DCI format 1_1 or the DCI format 1_2. Indicated DLorJointTCIState (Indicated DLorJointTCIState) may be a TCI state, a DL/Joint TCI state, or a unified TCI state indicated by the DCI format 1_1 or the DCI format 1_2.

DLorJointTCIState (e.g., higher layer parameter DLorJointTCIState) and UL-TCIState (e.g., higher layer parameter UL-TCIState) may be configured in one BWP of one component carrier. In a case that the configuration of DLorJointTCIState or the configuration of UL-TCIState is not performed in one BWP, the terminal apparatus 1 may apply the configuration of DLorJointTCIState or the configuration of UL-TCIState from the reference BWP.

The terminal apparatus 1 need not expect that both of a first higher layer parameter and a second higher layer parameter are configured. The first higher layer parameter may be any one of TCI-State, SpatialRelationInfo, and PUCCH-SpatialRelationInfo. The second higher layer parameter may be any one of DLorJointTCIState and UL-TCIState. In a case that TCI-State is configured in any component carrier in a certain list, the second higher layer parameter need not be configured in any component carrier in the same band in the certain list. The certain list may be configured by a higher layer parameter simultaneousTCI-UpdateList1, a higher layer parameter simultaaneousTCI-UpdateList2, a higher layer parameter simultaneousSpatial-UpdatedList1, or a higher layer parameter simultaneousSpatial-UpdatedList2.

The terminal apparatus 1 may receive an activation command. The activation command may be used for up to eight “one or both of TCI states and pairs of TCI states” to be mapped to codepoints of the DCI field ‘Transmission Configuration Indication’. A pair of TCI states may involve one TCI state for multiple downlink channels/signals (DL TCI state) and one TCI state for multiple uplink channels/signals (UL TCI state). The multiple downlink channels/signals may be part or all of the PDSCH, the PDCCH, and the CSI-RS. The multiple uplink channels/signals may be part or all of a PUSCH, a PUCCH, and an SRS. The DCI (DCI format) may include one or multiple DCI fields. For example, the DCI (DCI format) may include the TCI field (‘Transmission Configuration Indication’ field).

In a case that a first set of one or multiple TCI state IDs is activated in a second set, the first set may be applied for a downlink BWP in an indicated component carrier. In a case that the first set of one or multiple TCI state IDs is activated in a third set, the first set may be applied for the downlink BWP and an uplink BWP in the indicated component carrier. The second set may be a set of one or both of one or multiple component carriers and one or multiple downlink BWPs. The third set may be a set of some or all of one or multiple component carriers, one or multiple downlink BWPs, and one or multiple uplink BWPs.

In a case that the activation command maps one or both of DLorJointTCIState and UL-TCIState to one TCI codepoint (codepoint of the DCI field ‘Transmission Configuration Indication’), the terminal apparatus 1 may apply one or both of indicated DLorJointTCIState (Indicated DLorJointTCIState) and indicated UL-TCIState (Indicated UL-TCIState).

The terminal apparatus 1 may receive the DCI format 1_1/1_2 that provides indicated DLorJointTCIState or indicated UL-TCIState. The DCI format need not involve a downlink assignment. For example, in a case that the DCI format 1_1/1_2 does not involve the downlink assignment, the terminal apparatus 1 may assume some or all of the following: the CS-RNTI is used to scramble the CRC for the DCI, all redundancy versions (RVs) are 1, all MCSs are 1, the NDI is 0, all 0 is set for the FDRA type 0, and all 1 is set for the FDRA type 1.

The terminal apparatus 1 may receive the DCI format including the PRI field. The PRI field may select one or two TCI states from one or multiple “indicated TCI states”. The TCI state may be referred to as an “applied TCI state”. In a case that one TCI state is selected, one TCI state may be applied to a PDSCH, a PUSCH, a PUCCH, a CSI-RS, or an SRS scheduled according to the DCI format. In a case that two TCI states are selected, two TCI states may be applied to a PDSCH, a PUSCH, a PUCCH, a CSI-RS, or an SRS scheduled according to the DCI format. The “indicated TCI state” may be “indicated DLorJointTCIState” or “indicated UL-TCIState”. The DCI may be referred to as a DCI format.

N_{conf} TCI states may be configured. For example, N_{conf} TCI states may be configured in a radio resource control layer. For example, N_{conf} TCI states may be configured by a higher layer parameter. Each of N_{conf} TCI states may be referred to as a “configured TCI state”. N_{conf} may be an integer from 1 to 128. In a case that the TCI state is a DL TCI state or a Joint TCI state, N_{conf} may be an integer from 1 to 128. In case that the TCI state is a UL TCI state, N_{conf} may be an integer from 1 to 64.

Nact TCI states may be activated. For example, the N_{act} TCI states may be some or all of N_{conf} TCI states. For example, N_{act} TCI states may be activated in a medium access control layer. For example, N_{act} TCI states may be activated by the MAC CE. Each of N_{act} TCI states may be referred to as an “activated TCI state”. N_{act} may be an integer from 1 to 32.

N_{ind} TCI states may be indicated. For example, N_{ind} TCI states may be some or all of N_{act} TCI states. For example, N_{ind} TCI states may be indicated in the physical layer. For example, N_{ind} TCI states may be indicated by the DCI. For example, N_{ind} TCI states may be indicated by the TCI field in the DCI. Each of N_{ind} TCI states may be referred to as an “indicated TCI state”. The “indicated TCI state” may be applied to the PDSCH, the PDCCH, and the CSI-RS. The “indicated TCI state” may be applied to a PUSCH, a PUCCH and an SRS. The “indicated TCI state” may be applied to a PDSCH, a PDCCH, a CSI-RS, a PUSCH, a PUCCH, and an SRS. N_{ind} may be an integer from 1 to 4.

Nₐₚₚ TCI states may be indicated and applied. For example, Nₐₚₚ TCI states may be some or all of N_{ind} TCI states. For example, Nₐₚₚ TCI states may be indicated in the physical layer or the radio resource control layer. For example, Nₐₚₚ TCI states may be indicated by the DCI. For example, Nₐₚₚ TCI states may be indicated by the PRI field in the DCI Each of Nₐₚₚ TCI states may be referred to as an “applied TCI state”. Nₐₚₚ may be 1 or 2.

The terminal apparatus 1 may receive a higher layer configuration. After the “configured TCI state” is configured for the terminal apparatus 1 and before one “indicated TCI state” from the “configured TCI state” is applied to the terminal apparatus 1, the terminal apparatus 1 may assume that the DMRS of the PDSCH, the DMRS of the PDCCH, and the CSI-RS to which the “indicated TCI state” is applied are QCLed with the SS/PBCH block. For example, after the terminal apparatus 1 receives an initial configuration of multiple DLorJoint-TCIState and before one indicated TCI state from the configured TCI states is applied to the terminal apparatus 1, the terminal apparatus 1 may assume that the DMRS of the PDSCH, the DMRS of the PDCCH, and the CSI-RS to which the indicated TCI state is applied are QCLed with the SS/PBCH block.

The terminal apparatus 1 may receive a higher layer configuration. After the “configured TCI state” is configured for the terminal apparatus 1 and before one “indicated TCI state” from the “configured TCI state” is applied to the terminal apparatus 1, the terminal apparatus 1 may assume that the first uplink transmission spatial filter for the PUSCH, the PUCCH, and the SRS to which the “indicated TCI state” is applied is the same as the second uplink transmission spatial filter. For example, after the terminal apparatus 1 receives an initial configuration of multiple DLorJoint-TCIState or multiple UL-TCIState and before one indicated TCI state from the configured TCI states is applied to the terminal apparatus 1, the terminal apparatus 1 may assume that the first uplink transmission spatial filter (UL TX spatial filter) for the PUSCH, the PUCCH, and the SRS to which the indicated TCI state is applied is the same as the second uplink transmission spatial filter. The second uplink transmission spatial filter may be an uplink transmission spatial filter for a PUSCH transmission scheduled by a random access response grant in an initial access procedure.

After the terminal apparatus 1 receives a configuration of multiple DLorJoint-TCIState configurations (“configured TCI states”) and before one “indicated TCI state” from the configured TCI states is applied to the terminal apparatus 1, the DMRS of the PDSCH, the DMRS of the PDCCH, and the CSI-RS to which the indicated TCI state is applied may be QCLed with the SS/PBCH block or the CSI-RS resource. For example, the SS/PBCH block or the CSI-RS resource may be identified in a random access procedure initiated by a reconfiguration with sync. For example, the terminal apparatus 1 may receive the configuration of DLorJoint-TCIState as a part of the reconfiguration with sync.

After the terminal apparatus 1 receives a configuration of multiple DLorJoint-TCIState or multiple UL-TCIState (“configured TCI states”) and before one “indicated TCI state” from the configured TCI states is applied to the terminal apparatus 1, the terminal apparatus 1 may assume that the first uplink transmission spatial filter for the PUSCH, the PUCCH, and the SRS to which the indicated TCI state is applied is the same as the second uplink transmission spatial filter. The second uplink transmission spatial filter may be an uplink transmission spatial filter for a PUSCH transmission scheduled by a random access response grant in the random access procedure initiated by the reconfiguration with sync.

DLorJoint-TCIState may be used as an “indicated TCI state”. For example, the terminal apparatus 1 may acquire the QCL assumption (QCL relationship, QCL) from the “configured TCI states” for the DMRS of the PDSCH, the DMRS of the PDCCH, and the CSI-RS to which the “indicated TCI state” is applied”. The “indicated TCI state” may be applied to the DMRS of the PDSCH, the DMRS of the PDCCH, and the CSI-RS. The “indicated TCI state” may be applied to the DMRS of the PDSCH, the DMRS of the PDCCH, the CSI-RS, the PUSCH, the PUCCH, and the SRS.

UL-TCIState may be used as an “indicated TCI state”. For example, the terminal apparatus 1 may determine the uplink transmission spatial filter from the “configured TCI states” for the PUSCH, the PUCCH, and the SRS to which the “indicated TCI state” is applied.

In a case that the terminal apparatus 1 transmits a first channel and that a first “indicated TCI state” is different from a second “indicated TCI state”, the first “indicated TCI state” may be applied starting from the first slot. The first channel may be a PUCCH with HARQ-ACK information or a PUSCH with the HARQ-ACK information. The HARQ-ACK information may be HARQ-ACK information corresponding to a DCI conveying a TCI state indication without a downlink assignment. The HARQ-ACK information may be HARQ-ACK information corresponding to a PDSCH scheduled by the DCI conveying the TCI state indication. The second indicated TCI state may be indicated prior to (before) the first indicated TCI state. The first slot may be the first slot at least beam AppTime symbols after the last OFDM symbol in the first channel. BeamAppTime may be the number of OFDM symbols. BeamAppTime may be configured by a higher layer parameter. BeamAppTime may be determined according to the terminal capability. The indicated TCI state may be indicated DLorJointTCIState or indicated UL-TCIState. The indicated TCI state may be valid until the end of the PUCCH or PUSCH conveying the HARQ-ACK information.

In a case that the higher layer parameter PDCCH-Config includes two different values of the CORESET pool indices (CORESET Pool Index or coresetPoolIndex), the terminal apparatus 1 may receive an activation command (“activated TCI state”) for the CORESET associated with each CORESET pool index. The activation command may be used to map up to eight TCI states to the codepoints of the DCI field ‘Transmission Configuration Indication’. In a case that a set of TCI state IDs is activated for one CORESET pool index, an “activated TCI state” corresponding to the one CORESET pool index may be associated with one physical cell ID, and an “activated TCI state” corresponding to a CORESET pool index different from the one CORESET pool index may be associated with a physical cell ID different from the one physical cell ID. The activation command may be transmitted as a MAC CE command. One or multiple CORESETs may be configured in one BWP. One CORESET may correspond to a CORESET pool index of ‘0’ or ‘1’.

One codepoint of the DCI field ‘Transmission Configuration Indication’ may include up to four TCI states. For example, one of up to four TCI states may be a Joint TCI state. One of the up to four TCI states may be a DL TCI state. One of the up to four TCI states may be a UL TCI state. One codepoint of the DCI field ‘Transmission Configuration Indication’ may include two pairs of TCI states. The pair of TCI states may be a pair of a DL TCI state and a UL TCI state. The terminal apparatus 1 may receive an activation command. The activation command may be used to map up to eight combinations of four or less TCI states to the codepoints of the DCI field ‘Transmission Configuration Indication’. The activation command may be used to map up to eight combinations of one or two “pairs of TCI states” to a code map of the DCI field ‘Transmission Configuration Indication’. The terminal apparatus 1 need not expect to receive more than eight TCI states in the activation command. The terminal apparatus 1 need not expect to receive more than eight “pairs of TCI states” in the activation command.

In a case that the terminal apparatus 1 transmits a first PUCCH in the first slot, the mapping between the TCI state and the codepoints may be applied starting from the second slot. The first PUCCH may involve first HARQ-ACK information. The first PUCCH may be transmitted corresponding to a first PDSCH. The first PDSCH may convey an activation command.

In a case that the first higher layer parameter is configured, and that a first time offset is more than or equal to a first value, and after the terminal apparatus 1 receives the initial configuration of the TCI state (the configured TCI state) and before the activation command (the activated TCI state) is received, the DMRS port of the PDSCH may be QCLed with the SS/PBCH block with respect to the QCL typeA. The first higher layer parameter may be configured for a CORESET scheduling a PDSCH. The CORESET may schedule the PDSCH. The first time offset may be an offset between reception of the DL DCI and the PDSCH. The first value may be a timeDurationForQCL.

In the case that the first higher layer parameter is configured, the terminal apparatus 1 may assume that the TCI field is present in the DCI format for the PDCCH transmitted in the CORESET. The first higher layer parameter may be a tci-PresentInDCI set to ‘enabled’. The first higher layer parameter may be tei-PresentInDCI set to ‘enabled’ for the CORESET scheduling the PDSCH or the multicast PDSCH. The first higher layer parameter may be tei-PresentDCI-1-2.

In a case that a first terminal capability is indicated to the terminal apparatus 1, the terminal apparatus 1 may determine a spatial domain filter. The spatial domain filter may be used while an applicable channel access procedure prior to a UL transmission in the channel is performed. In a case that an SRI corresponding to a UL transmission is indicated, the terminal apparatus 1 may use the spatial domain filter the same as the spatial domain filter associated with the indicated SRL The terminal apparatus 1 may use the spatial domain filter the same as the spatial domain filter used to receive the DL reference signal associated with the indicated TCI state. For example, in a case that DLorJointTCIState or the TCI state configuration with UL-TCIState (configured TCI state) is configured, the terminal apparatus 1 may use the spatial domain filter the same as the spatial domain filter used to receive the DL reference signal associated with the indicated TCI state. The first terminal capability may be beam Correspondence WithoutUL-BeamSweeping set to ‘1’.

In the periodic CSI-RS and a semi-persistent CSI-RS, the indicated TCI state (e.g., indicated DLorJointTCIState) need not be applied.

The terminal apparatus 1 may receive a DMRS for a PDSCH scheduled by a PDCCH with the DCI format. In the case that two TCI states are indicated, and in a case the terminal apparatus 1 receives the DMRS for the PDSCH and the SS/PBCH block in the same OFDM symbol, at least one DMRS port for the PDSCH and the SS/PBCH block may be QCLed with the typeD (‘QCL-TypeD’). In a case that the first higher layer parameter is configured, and that multiple PDSCHs are overlapped by multiple PDCCHs in the time-frequency domain, different DMRS configurations need not be expected, and two TCI states need not indicate DMRS ports in one CDM group. The first higher layer parameter may be PDCCH-Config including two different CORESET pool indices.

In the downlink, up to 16 or 32 HARQ processes may be supported in one serving cell. The number of HARQ processes may be configured by a higher layer parameter. In a case that the higher layer parameter is not configured, the number of HARQ processes may be eight.

The terminal apparatus 1, in response to detecting a PDCCH with a DCI format, may receive (decode) the corresponding PDSCH as indicated by the DCI format.

The higher layer parameter may include values of two different CORESET pool indices. The PDCCHs scheduling two PDSCHs (first PDSCH and second PDSCH) may be associated with the CORESETs having the different values of the CORESET pool indices. The higher layer parameter may be PDCCH-Config. The terminal apparatus 1 may receive the first PDSCH and the second PDSCH.

The terminal apparatus 1 may assume that the DMRS port of the first PDSCH is QCLed with a first SS/PBCH block with respect to the first QCL parameter. The first PDSCH may be scheduled with the SI-RNTI, the P-RNTI, or a G-RNTI for broadcast. The terminal apparatus 1 may assume that the DMRS port of the second PDSCH is QCLed with a second SS/PBCH block or a second CSI-RS resource with respect to the first QCL parameter. The second SS/PBCH block or the second CSI-RS resource may be used for RACH association. The second PDSCH may be scheduled with the RA-RNTI, or an MSGB-RNTI. The terminal apparatus 1 may assume that a DMRS port of the first PDCCH order, a DMRS port of a third PDSCH are QCLed with the second SS/PBCH block or the second CSI-RS resource with respect to the first QCL parameter. The third PDSCH may be scheduled with the RA-RNTI for a random access procedure triggered by the first PDCCH order. The first QCL parameter may include some or all of Doppler shift, Doppler spread, average delay, delay spread, and spatial RX parameters.

In a case that the decoding of the PDCCH with the CRC scrambled by the CS-RNTI is configured by the higher layer, the terminal apparatus 1 may receive the PDSCH (SPS PDSCH) without the corresponding PDCCH.

In the case that the first higher layer parameter is configured, the terminal apparatus 1 may receive multiple PDCCHs. The first higher layer parameter may be PDCCH-Config. The first higher layer parameter may include values of two different CORESET pool indices. Multiple PDCCHs may schedule multiple PDSCHs. The multiple PDSCHs may or may not overlap in the time-frequency domain. In a case that the multiple PDCCHs are associated with different CORESETs, the terminal apparatus 1 may simultaneously receive the multiple PDSCHs. The different CORESETs may have values of different CORESET pool indices (coresetPoolIndex).

In a case that the CORESET (the higher layer parameter ControlResourceSet) does not involve the CORESET pool index (the higher layer parameter coresetPoolIndex), the terminal apparatus 1 may assume that the CORESET is assigned with the CORESET pool index of 0.

A first physical cell ID associated with the first CORESET may be different from a second physical cell ID associated with the second CORESET. For example, the first and second CORESETs may be associated with different physical cell IDs via the activated TCI state. The first and second CORESETs may correspond to different CORESET pool indices.

In a case that the PDCCH reception includes two PDCCH candidates from the search space set, one PDCCH monitoring occasion may be a union of the PDCCH monitoring occasions for the two PDCCH candidates. The start of the PDCCH reception may be the start of a previous PDCCH candidate. The end of the PDCCH reception may be the end of a subsequent PDCCH candidate.

In a case that no CORESET pool index is provided in one BWP in one serving cell, three or less CORESETS may be provided. In a case that the same CORESET pool index is provided for all CORESETs in one BWP in one serving cell, three or less CORESETs may be provided. In a case that a CORESET pool index 0 is provided for the first CORESET in one BWP in one serving cell and that a CORESET pool index 1 is provided for the second CORESET, five or less CORESETs may be provided.

In each CORESET, there may be provided at least a CORESET index by the first higher layer parameter, a QCL relationship (antenna port QCL) by the second higher layer parameter, and an indication of whether a TCI field is present by the third higher layer parameter. The first higher layer parameter may be controlResourceSetId. The second higher layer parameter may be TCI-State. The third higher layer parameter may be ti-PresentInDCI or tci-PresentDCI-1-2.

In a case that a value of 0 is provided for a search space ID, the terminal apparatus 1 may determine a search occasion for the PDCCH candidate. The search space ID may be searchSpaceID. The search space ID may be included in PDCCH-Config or PDCCH-ConfigCommon.

In a case that two TCI states are provided in one CORESET, the terminal apparatus 1 may assume QCL information indicated by both of the two TCI states for the PDCCH reception in one CORESET. The two TCI states may indicate the QCL information (QCL relationship) of the DMRS antenna port for the PDCCH reception.

In a case that a configuration of the TCI state is not provided in one CORESET, and that an initial configuration of two or more TCI states are provided, and that a MAC CE activation command is not received, the terminal apparatus 1 may assume that the DMRS antenna port related to the PDCCH reception is the QCLed with the SS/PBCH block. The SS/PBCH block may be identified by the terminal apparatus 1 at the time of an initial access procedure.

In a case that the configurations of two or more TCI states are provided by reconfiguration with synchronization (Reconfiguration with synch) in one CORESET, and that the MAC CE activation command is not received, the terminal apparatus 1 may assume that the DMRS antenna port related to the PDCCH reception is QCLed with the SS/PBCH block or the CSI-RS resource. The SS/PBCH block or the CSI-RS resource may be identified by the terminal apparatus 1 in the random access procedure initiated by the reconfiguration with sync.

In a case that the TCI state (for example, unified TCI state) is provided in the CORESET with the index of 0 and the unified TCI state is applied, the terminal apparatus 1 may assume that the DMRS antenna port (DMRS port) for a first PDCCH reception and the DMRS antenna port for a first PDSCH reception are QCLed with the reference signal indicated in the TCI state. The fact that the unified TCI state is applied may mean that followUnifiedTCIstate set to ‘enable’ is configured. The first PDSCH reception may be scheduled by the DCI format provided by the first PDCCH reception. The unified TCI state may be DLorJoint-TCIState.

In a case that the TCI state (for example, unified TCI state) is provided in the CORESET with the index of 0 and the unified TCI state is not applied, the terminal apparatus 1 and the DMRS antenna port (DMRS port) for the first PDCCH reception are QCLed with one or multiple reference signals according to the activated TCI state.

In a case that one TCI state is provided in a CORESET with an index of other than 0, or in a case that the MAC CE activation command is received for one or two provided TCI states, the terminal apparatus 1 may assume that the DMRS antenna port for the PDCCH reception is QCLed with one or multiple DL RSs configured by the TCI state. The TCI state indicated by the MAC CE activation command may be the “activated TCI state”.

In a case that the unified TCI state is provided, the DMRS antenna port for the PDCCH reception in one CORESET with the index of other than 0 and the DMRS antenna port for the PDSCH scheduled by the DCI format provided by the PDCCH reception may be QCLed with a reference signal provided by the indicated unified TCI state (“indicated TCI state”).

In a case that multiple (e.g., two) unified TCI states are provided (or indicated), the DMRS antenna port for the PDCCH reception in one CORESET with the index of other than 0 and the DMRS antenna port for the PDSCH scheduled by the DCI format provided by the PDCCH reception may be QCLed with a reference signal provided by one or both of the indicated unified TCI states (“indicated TCI states”).

In a case that the unified TCI state is applied, the DMRS antenna port for the PDCCH reception in one CORESET with the index of other than 0 and the DMRS antenna port for the PDSCH scheduled by the DCI format provided by the PDCCH reception may be QCLed with a reference signal provided by the indicated unified TCI state (“indicated TCI state”).

Ten or less search space sets may be provided in one BWP in one serving cell. For each search space set, at least a search space set index by the first higher layer parameter, the relationship between the search space set and the CORESET by the second higher layer parameter, and the search space set (search space set index) linked by the third higher layer parameter may be determined. The first higher layer parameter may be searchSpaceld. The second higher layer parameter may be controlResourceSetId. In a first search space set, a second search space set index may be provided by the third higher layer parameter. The third higher layer parameter may link the first search space set to the second search space set. The third higher layer parameter may be searchSpaceLinking. The fact that the third higher layer parameter is provided may mean that the search space linking is applied.

In a case that the first search space set is linked to the second search space set, the terminal apparatus 1 may perform monitoring in accordance with each search space set in the monitoring occasion in one slot. The count of PDCCH candidate corresponding to the first search space set and the second search space set may be 3. A CORESET pool index of the first CORESET associated with the first search space set may be different from a CORESET pool index of the second CORESET associated with the second search space set. The fact that the first search space set is linked to the second search space set may mean that the first search space set includes searchSpaceLinking with the second search space set and the second search space set includes searchSpaceLinking with the first search space set.

In a case that the first search space set is linked to the second search space set and that a third search space set is not linked, the terminal apparatus 1 may monitor a first PDCCH candidate corresponding to the first search space set and may monitor a second PDCCH candidate corresponding to the second search space set for the first DCI format. The terminal apparatus 1 may monitor a third PDCCH candidate corresponding to the third search space set for the second DCI format. In one CORESET and in the same symbol in one slot, the first PDCCH candidate corresponding to the first search space set or the second PDCCH candidate corresponding to the second search space set and the third PDCCH candidate corresponding to the third search space set may use the same set of CCEs and may be subjected to the same scrambling. The third PDCCH candidate corresponding to the third search space set need not be counted for monitoring. The detected DCI format need not be assumed to be the first DCI format.

In a case that the first search space set is linked to the second search space set, and that the third search space set is linked to a fourth search space set, and that sizes of the detected DCI formats are the same, the terminal apparatus 1 may expect different CCEs or different scrambling in one CORESET.

In a case that the terminal apparatus monitors multiple PDCCHs in the first CORESET and the second CORESET, the first CORESET may correspond to the CSS set with the smallest index or may correspond to the USS set with the smallest index. The second CORESET may have the same ‘typeD’ property as the first CORESET. The repetition may be applied for the PDCCH. The fact that the repetition is applied for the PDCCH may mean that two-QCLTypeDforPDCCHRepetition is provided.

In the case that the first search space set is linked to the second search space set, the terminal apparatus 1 may detect that one of two PDCCH receptions which ends later is the DCI format.

A MAC protocol data unit (PDU) may be a bit string that is byte aligned (in other words, a multiple of 8 bits) in length. A MAC service data unit (SDU) may be a bit string that is byte aligned (in other words, a multiple of 8 bits) in length. One MAC SDU may be included into one MAC PDU from the first bit onward. The MAC CE may be a bit string that is byte aligned (in other words, a multiple of 8 bits) in length. A MAC subheader may be a bit string that is byte aligned (in other words, a multiple of 8 bits) in length. Each MAC subheader may be placed immediately before the corresponding MAC SDU, MAC CE, or padding.

The MAC protocol data unit (PDU) may include one or multiple MAC subPDUs. Each MAC subPDU may include one MAC subheader. Each MAC subPDU may include one MAC subheader and one MAC service data unit (SDU). Each MAC subPDU may include one MAC subheader and one MAC CE. Each MAC subPDU may include one MAC subheader and padding. The MAC SDU may have a variable size. Each MAC subheader may correspond to one MAC SDU, one MAC CE, or padding. One MAC PDU may be one transport block.

A first MAC CE may be an activation command A. The first MAC CE may be a MAC CE for activation or deactivation of a TCI state for a PDSCH (a UE-specific PDSCH). The MAC CE for the activation/deactivation of the TCI state for the PDSCH may be identified by a first MAC subheader. For example, the first MAC subheader may involve a first Logical channel ID (LCID). For example, a value of the first LCID may be “TCI States Activation/Deactivation for UE-specific PDSCH”.

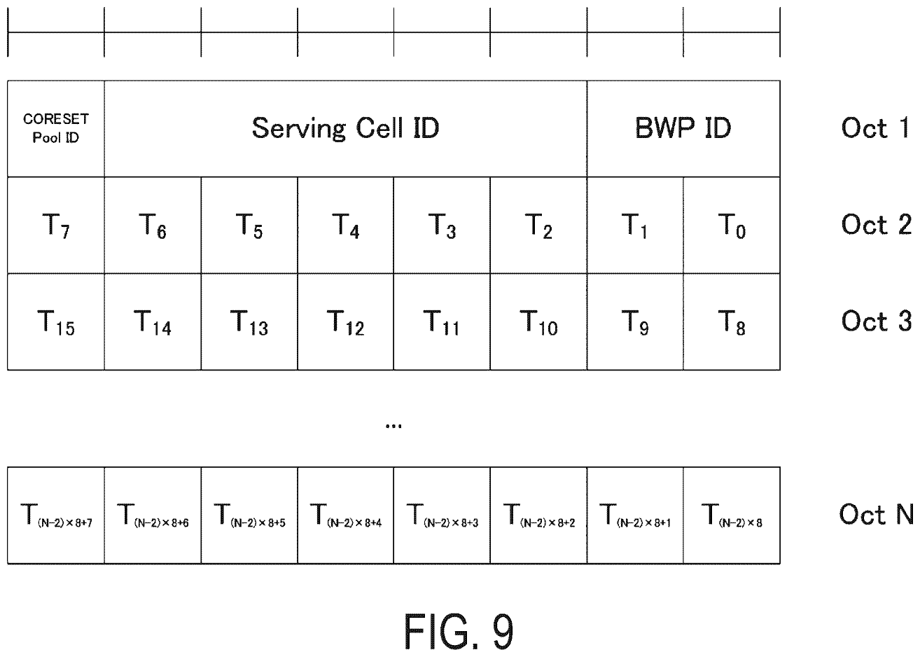

FIG. 9 is a diagram illustrating an example of the activation command A according to an aspect of the present embodiment. A field of a serving cell ID may indicate an identifier of a serving cell to which the first MAC CE is applied. A field of a BWP ID may indicate a DL BWP to which the MAC CE is applied as a codepoint of the ‘bandwidth part indicator field’ of the DCI In a case that the first MAC CE is applied to a set of multiple serving cells, the field of the BWP ID may be disregarded. A field of “Tᵢ” may indicate an activation/deactivation status of a TCI state with a TCI state ID i. The field of “Tᵢ” set to 1 may indicate that the TCI state with the TCI state ID i is activated. The field of “Tᵢ” set to 1 may indicate that the TCI state with the TCI state ID i is mapped to one codepoint of ‘Transmission Configuration Indication field’ of the DCI The field of “Tᵢ” set to 0 may indicate that the TCI state with the TCI state ID i is deactivated. The field of “Tᵢ” set to 1 may indicate that the TCI state with the TCI state ID i is not mapped to one codepoint of ‘Transmission Configuration Indication field’ of the DCI. i may be a TCI state ID (or TCI-StateID). The TCI state may involve a TCI state ID. A maximum number of “activated TCI states” may be eight. A field of the CORESET pool ID may indicate that first mapping is specific to a CORESET ID (ControlResourceSetId) configured with a CORESET pool ID (CORESET pool index). The first mapping may be mapping between the “activated TCI state” and the codepoint of the DCI ‘Transmission Configuration Indication’ set by the “Tᵢ” field. The field of the CORESET pool ID set to 1 may indicate that the first MAC CE is applied to a downlink transmission scheduled by the CORESET with the CORESET pool ID (CORESET pool index) having a value of 1. The field of the CORESET pool ID set to 0 may indicate that the first MAC CE is applied to a downlink transmission scheduled by the CORESET with the CORESET pool ID (CORESET pool index) having a value of 0. In a case that the CORESET pool index (coresetPoolIndex) is not configured, the field of the CORESET pool ID in the first MAC CE may be disregarded.

A second MAC CE may be an activation command B. The second MAC CE may be a MAC CE for activation or deactivation of a TCI state for a PDSCH (a UE-specific PDSCH). The MAC CE for the activation/deactivation of the TCI state for the PDSCH may be identified by a second MAC subheader. For example, the second MAC subheader may involve a second Logical channel ID (LCID). The second LCID may be an eLCID. For example, a value of the second LCID may be “Enhanced TCI States Activation/Deactivation for UE-specific PDSCH”.

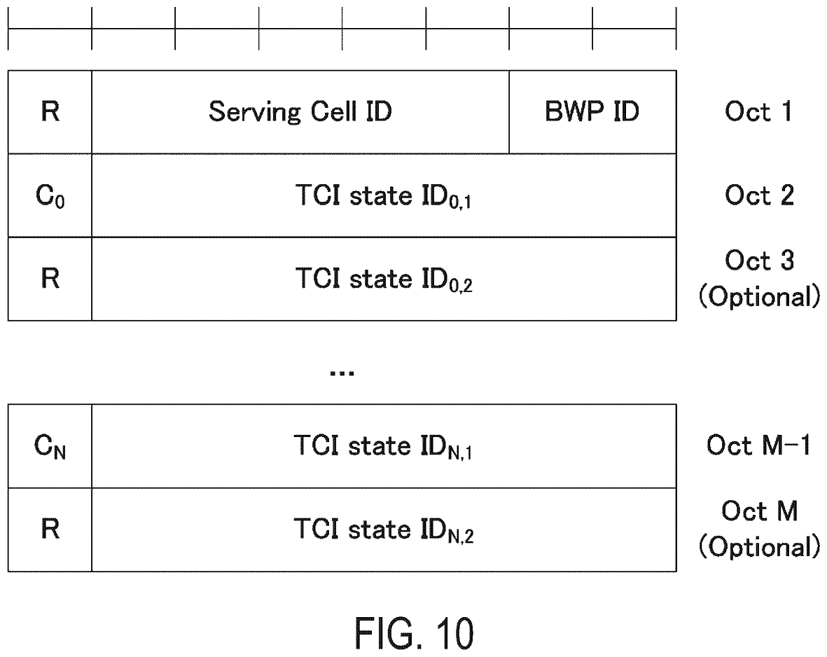

FIG. 10 is a diagram illustrating an example of the activation command B according to an aspect of the present embodiment. A field of “Cᵢ” may indicate whether an octet including the TCI state ID_{i, 2} is present. For example, in a case that the field of “Cᵢ” is set to 1, an octet including the TCI state ID_{i, 2} may be present. For example, in a case that the field of “Cᵢ” is set to 0, no octet including the TCI state ID_{i, 2} need not be present. The field of the TCI state ID_{i, j} may indicate a TCI state identified by the TCI state ID (TCI-Stateld). The TCI state ID_{i, j} may represent the j-th TCI state indicated for the i-th codepoint of the DCI ‘Transmission configuration indication’ field. The TCI state ID_{i, 2} may be optional based on the indication of the “Cᵢ” field. i may be an index of a codepoint of the DCI ‘Transmission configuration indicatin’ field. j may be 1 or 2.

A third MAC CE may be an activation command C. The third MAC CE may be a MAC CE for activation or deactivation of a unified TCI state. The MAC CE for the activation/deactivation of the unified TCI state may be identified by a third MAC subheader For example, the third MAC subheader may involve a third Logical channel ID (LCID). The third LCID may be an eLCID. For example, a value of the third LCID may be “Unified TCI States Activation/Deactivation MAC CE”.

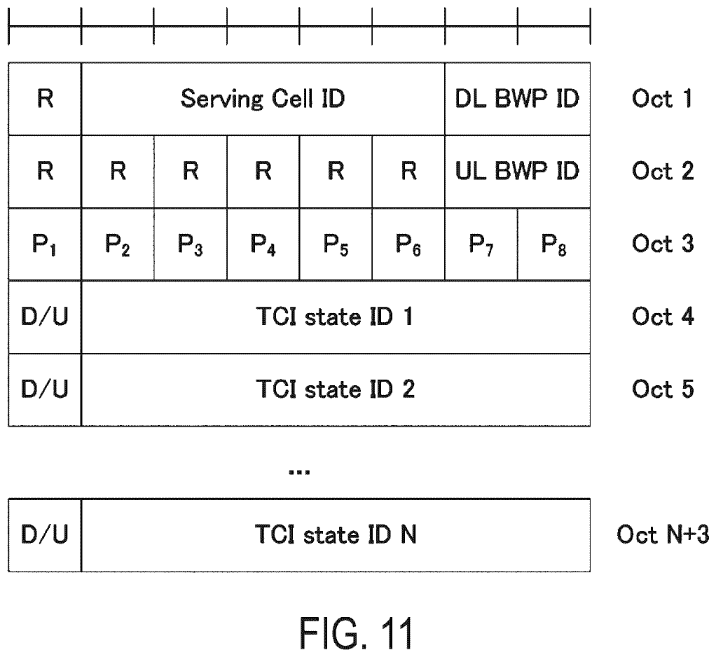

FIG. 11 is a diagram illustrating an example of the activation command C according to an aspect of the present embodiment. A field of a DL BWP ID may indicate one downlink BWP to which the MAC CE is applied as one codepoint of the DCI ‘bandwidth part indicator’ field. A field of a UL BWP ID may indicate one uplink BWP to which the MAC CE is applied as one codepoint of the DCI ‘bandwidth part indicator’ field. A field of “Pᵢ” may indicate whether each TCI codepoint has multiple TCI states or one TCI state. For example, in a case that the “Pᵢ” field is set to 1, the i-th TCI codepoint may include both the DL TCI state and the UL TCI state. For example, in a case that the “Pᵢ” field is set to 0, the i-th TCI codepoint may include one of the DL TCI state and the UL TCI state. A field of “D/U” may indicate whether the TCI state ID in the same octet is for joint (both DL and UL)/DL or UL. For example, in a case that the “D/U” field is set to 1, the TCI state ID in the same octet may be for DL/joint. For example, in a case that the “D/U” field is set to 0, the TCI state ID in the same octet may be for UL. A “TCI state ID” field may indicate a TCI state identified by the TCI state ID (TCI-Stateld). In a case that the “D/U” field is set to 1, a 7-bit long “TCI state ID” may be used. In a case that the “D/U” field is set to 0, the most significant bit of the “TCI state ID” may be regarded as reserved and the remaining 6 bits may indicate the ID of the UL-TCIState (UL-TCIState-Id). The DL TCI state may be a TCI state applied to some or all of the PDSCH, the PDCCH, and the CSI-RS. The UL TCI state may be a TCI state applied to some or all of the PUSCH, the PUCCH, and the SRS. The Joint TCI state may be a TCI state representing both the DL TCI state and the UL TCI state. DLorJointTCIState may be a DL TCI state or a Joint TCI state. UL-TCIState may be a UL TCI state. The DL TCI state may be a TCI state for DL. The Joint TCI state may be a TCI state for both DL and UL. The UL TCI state may be a TCI state for UL. The TCI codepoint may be a codepoint of the DCI ‘Transmission configuration indication’ field. An “R” field in the MAC CE may be a reserved bit. The reserved bit may be set to 0.

A fourth MAC CE may be an activation command D. A fifth MAC CE may be an activation command E. The fourth MAC CE may be a MAC CE for activation or deactivation of a unified TCI state. For example, the fourth MAC CE may be a MAC CE for activation or deactivation of an enhanced unified TCI state. The fifth MAC CE may be a MAC CE for activation or deactivation of a unified TCI state. For example, the fifth MAC CE may be a MAC CE for activation or deactivation of an enhanced unified TCI state. The MAC CE for the activation/deactivation of the unified TCI state may be identified by a fourth MAC subheader. The MAC CE for the activation/deactivation of the unified TCI state may be identified by a fifth MAC subheader. For example, the fourth MAC subheader may involve a fourth Logical channel ID (LCID). For example, the fifth MAC subheader may involve a fifth Logical channel ID (LCID). The fourth LCID may be an eLCID. The fifth LCID may be an eLCID. For example, a value of the fourth LCID may be “Enhanced unified TCI States Activation/Deactivation MAC CE 1”. For example, a value of the fifth LCID may be “Enhanced unified TCI States Activation/Deactivation MAC CE 2”.

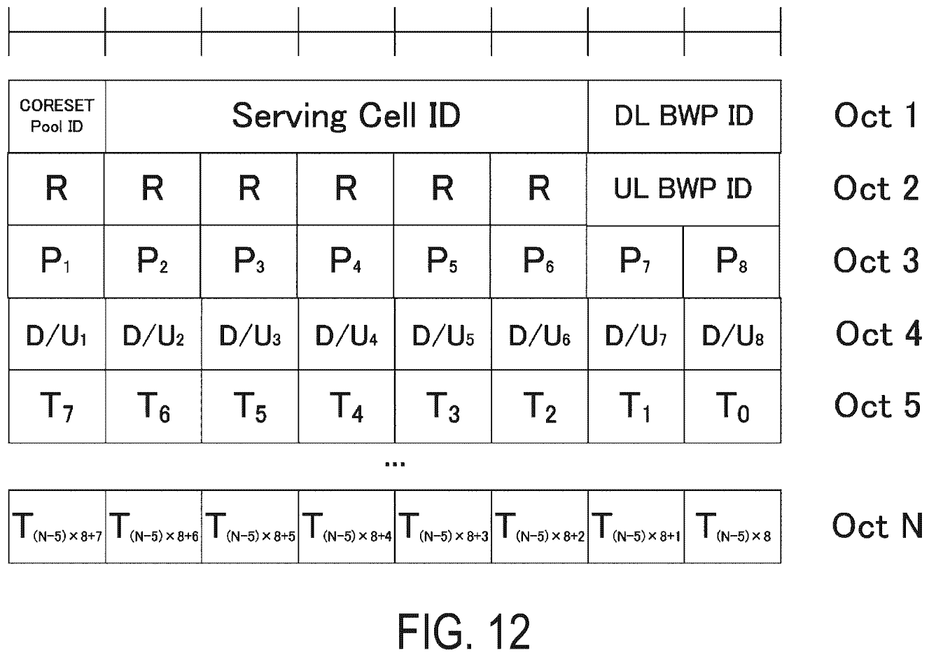

FIG. 12 is a diagram illustrating an example of the activation command D according to an aspect of the present embodiment. A field of a serving cell ID may indicate an identifier of a serving cell to which the fourth MAC CE is applied. A field of a DL BWP ID may indicate one downlink BWP to which the fourth MAC CE is applied. A field of a DL BWP ID may indicate one downlink BWP to which the fourth MAC CE is applied as one codepoint of the DCI ‘bandwidth part indicator’ field. A field of a UL BWP ID may indicate one uplink BWP to which the fourth MAC CE is applied. A field of a UL BWP ID may indicate one uplink BWP to which the fourth MAC CE is applied as one codepoint of the DCI ‘bandwidth part indicator’ field. A field of “Pᵢ” may indicate whether each TCI codepoint has multiple TCI states or one TCI state. For example, in a case that the “Pᵢ” field is set to 1, the i-th TCI codepoint may include both the DL TCI state and the UL TCI state. For example, in a case that the “Pᵢ” field is set to 0, the i-th TCI codepoint may include one of the DL TCI state and the UL TCI state. A field of “D/Uᵢ” may indicate whether each TCI codepoint is for joint (both DL and UL)/DL or UL. For example, in a case that the “D/Uᵢ” field is set to 1, the i-th TCI codepoint may be for DL/joint. For example, in a case that the “D/Uᵢ” field is set to 0, the i-th TCI codepoint may be for UL. A field of “Tⱼ” may indicate an activation/deactivation status of a TCI state with a TCI state ID j. The field of “Tⱼ” set to 1 may indicate that the TCI state with the TCI state ID j is activated. The field of “Tⱼ” set to 1 may indicate that the TCI state with the TCI state ID j is mapped to one codepoint of ‘Transmission Configuration Indication field’ of the DCI. The field of “Tⱼ” set to 0 may indicate that the TCI state with the TCI state ID j is deactivated. The field of “Tⱼ” set to 1 may indicate that the TCI state with the TCI state ID j is not mapped to one codepoint of ‘Transmission Configuration Indication field’ of the DCI. j may be a UL TCI state ID (UL-TCIState-Id) or a DL/Joint TCI state ID (DLorJoint-TCIState-Id). The number of UL TCI state IDs may be up to 64. The number of DL/Joint TCI state IDs may be up to 128. j may be {0, . . . , 63}. j may be {0, . . . , 127}. j may be {0, . . . , 191}. For example, in a case that the i-th TCI codepoint corresponds to a UL TCI state, the field of “Tⱼ” may indicate an activation/deactivation status of a TCI state with the TCI state ID j-128. For example, in a case that the i-th TCI codepoint corresponds to a DL TCI state or a Joint TCI state, the field of “Tⱼ” may indicate an activation/deactivation status of a TCI state with the TCI state ID j-64. For example, in the case that the i-th TCI codepoint corresponds to a UL TCI state, the field of “Tⱼ” set to 1 may indicate that the TCI state with the TCI state ID j-128 is activated. For example, in the case that the i-th TCI codepoint corresponds to a UL TCI state, the field of “Tⱼ” set to 1 may indicate that the TCI state with the TCI state ID j-128 is mapped to the i-th TCI codepoint. For example, in the case that the i-th TCI codepoint corresponds to a DL TCI state or a Joint TCI state, the field of “Tⱼ” set to 1 may indicate that the TCI state with the TCI state ID j-64 is activated. For example, in the case that the i-th TCI codepoint corresponds to a DL TCI state or a Joint TCI state, the field of “Tⱼ” set to 1 may indicate that the TCI state with the TCI state ID j-64 is mapped to the i-th TCI codepoint. The field of the CORESET pool ID may indicate that second mapping is specific to a CORESET ID (ControlResourceSetId) configured with a CORESET pool ID (CORESET pool index). The second mapping may be mapping between the “activated TCI state” and the codepoint of the DCI ‘Transmission Configuration Indication’ set by the “Tᵢ” field. The field of the CORESET pool ID set to 1 may indicate that the MAC CE is applied to a downlink or uplink transmission scheduled by the CORESET with the CORESET pool ID (CORESET pool index) having a value of 1. The field of the CORESET pool ID set to 0 may indicate that the MAC CE is applied to a downlink or uplink transmission scheduled by the CORESET with the CORESET pool ID (CORESET pool index) having a value of 0. In the case that the CORESET pool index (coresetPoolIndex) is not configured, the field of the CORESET pool ID in the fourth MAC CE may be disregarded.

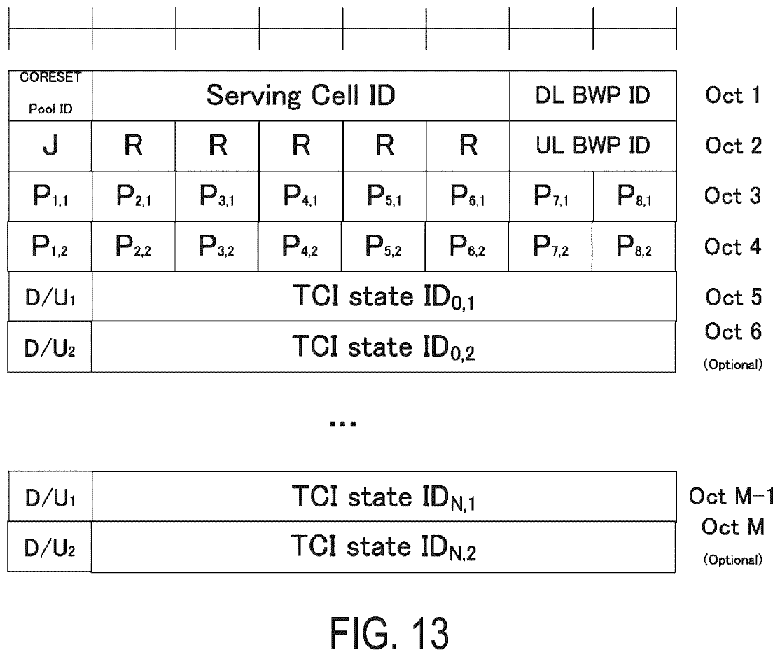

FIG. 13 is a diagram illustrating an example of the activation command E according to an aspect of the present embodiment. A field of a CORESET pool ID in FIG. 13 may be reserved. A field of “P_{i, j}” may indicate whether each TCI codepoint has multiple TCI states or one TCI state. For example, in a case that the “P_{i, j}” field is set to 1, the j-th TCI state in the i-th TCI codepoint may include two TCI states (e.g., DL TCI state and UL TCI state). For example, in a case that the “P_{i, j}” field is set to 0, the j-th TCI state in the i-th TCI codepoint may include one TCI state (e.g., DL TCI state or UL TCI state). A field of “D/Uⱼ” may indicate whether the TCI state ID in the same octet is for joint (both DL and UL)/DL or UL. The field of “D/Uⱼ” may indicate whether the TCI state ID in the same octet is for joint (both DL and UL)/DL or UL. For example, in a case that the “D/Uⱼ” field is set to 1, the TCI state ID in the same octet may be for DL/joint. For example, in a case that the “D/Uⱼ” field is set to 0, the TCI state ID in the same octet may be for UL. A “TCI state ID_{i, j}” field may indicate a TCI state identified by the DL/Joint TCI state ID (TCI-StateId) or the UL TCI state ID (UL-TCIState-Id). In a case that the “D/Uⱼ” field is set to 1, a 7-bit long “TCI state ID_{i, j}” may be used. In a case that the “D/Uⱼ” field is set to 0, the most significant bit of the “TCI state ID_{i, j}” may be regarded as reserved and the remaining 6 bits may indicate the ID of the UL-TCIState (UL TCI state, UL-TCIState-Id).

j in FIG. 13 may correspond to a CORESET pool ID (CORESET pool index). For example, j=1 may correspond to a CORESET pool ID (CORESET pool index)=0. For example, j=2 may correspond to a CORESET pool ID (CORESET pool index)=1. For example, j=0 may correspond to a CORESET pool ID (CORESET pool index)=0. For example, j=1 may correspond to a CORESET pool ID (CORESET pool index)=1. Whether j corresponds to a CORESET pool ID (CORESET pool index) may be determined according to the “J” field. For example, in a case that the “J” field is set to 1, j may correspond to a CORESET pool ID (CORESET pool index). For example, in a case that the “J” field is set to 0, j may correspond to an index of a TCI state in one codepoint. The field of “P_{i, j}” may indicate whether each TCI codepoint of the DCI associated with the CORESET pool ID corresponding to j has multiple TCI states or one TCI state. For example, in a case that the “P_{i, j}” field is set to 1, the i-th TCI codepoint of the DCI associated with the CORESET pool ID corresponding to j may correspond to both the DL TCI state and the UL TCI state. For example, in a case that the “P_{i, j}” field is set to 0, the i-th TCI codepoint of the DCI associated with the CORESET pool ID corresponding to j may correspond to one of the DL TCI state and the UL TCI state. In a case that the CORESET pool index (higher layer parameter coresetPoolIndex) is not configured, j need not correspond to the CORESET pool ID.

An activation command F may be a MAC CE for TCI state indication for a PDCCH. The activation command F may include a 5-bit serving cell ID, a 4-bit CORESET ID, and a 7-bit TCI state ID.

An activation command G may be a MAC CE for TCI state indication for a PDCCH. The activation command G may include a 5-bit serving cell ID, a 4-bit CORESET ID, a first 7-bit TCI state ID, and a second 7-bit TCI state ID. In a case that one or multiple CORESETs in one BWP are configured with different CORESET pool index values, the activation command G need not be applied to the one or multiple CORESETs. In a case that the SEN is applied for the PDCCH, the activation command G may be applied. The fact that the SFN for the PDCCH is applied may mean that sfnSchemePdcch is configured.

The terminal apparatus 1 may receive an activation command. The activation command may be a general term for the activation commands A, B, C, D, E, F, and G.

One TCI state enables the beam management of one or both of multiple uplink channels/signals (e.g., PUSCH, PUCCH, SRS) and multiple downlink channels/signals (e.g., PDSCH, PDCCH, and CSI-RS). In other words, applying one TCI state to multiple channels/signals allows efficiency of the beam management to be expected to be improved. However, in the case of the Multi-TRP (Multiple Transmission and Reception Points), it is difficult to switch beams for each TRP by applying one TCI state to multiple channels/signals. Thus, a problem is that one TCI state needs to be applied to multiple channels/signals and each TRP. Accordingly, efficient communication and efficient beam management may be expected. In addition, efficient beam management is expected in consideration of the time from when a beam is indicated to when the beam is applied. The present invention may be used for the beam management for a physical channel in consideration of some or all switching times of the “configured TCI state”, the “activated TCI state”, the “indicated TCI state”, and the “applied TCI state” as a means for solving the problem.

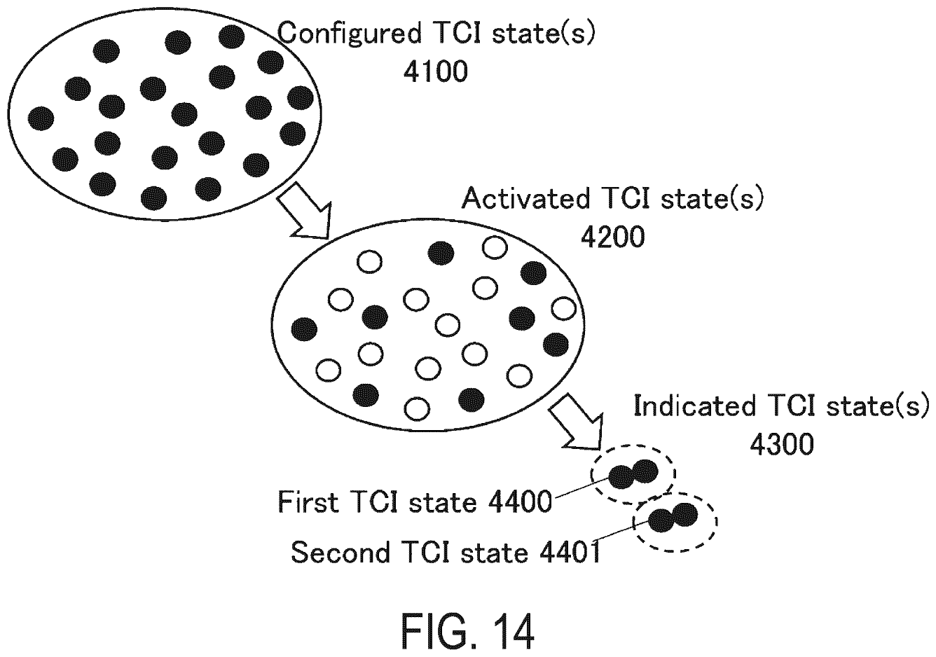

FIG. 14 is a diagram illustrating an example of management of the TCI state according to an aspect of the present embodiment. A black circle in FIG. 14 may be one TCI state.

One or multiple TCI states 4100 may be configured by the higher layer parameter For example, one or multiple UL TCI states (UL-TCIState) may be configured by the higher layer parameter for each uplink BWP (BWP-UplinkDedicated). For example, one or multiple DL/Joint TCI states (DLorJointTCIState) may be configured by the higher layer parameter for each PDSCH configuration (PDSCH-Config). One TCI state may be associated with one TCI state ID. For example, one UL TCI state may be associated with one UL TCI state ID (TCI-UL-State-Id, UL-TCIState-Id). For example, one DL/Joint TCI state may be associated with one TCI state ID (TCI-stateld). One or multiple TCI states configured by the higher layer parameter may be the configured TCI states 4100.

One or multiple TCI states 4200 may be activated by the MAC CE (e.g., activation command). The first PDSCH may convey the first transport block. The first transport block may be one MAC PDU. One MAC PDU may include an activation command or a MAC CE referred to as an activation command. For example, the activation command may be the activation command D or the activation command E. One or both of the one or multiple TCI states and the one or multiple “pairs of TCI states” may be mapped to one or multiple codepoints. For example, one or both of the one or multiple TCI states and the “pairs of TCI states” may be mapped to one or multiple codepoints by the activation command. Each TCI state or each pair of TCI states may be mapped to one codepoint. For example, each TCI state or each pair of TCI states may be mapped to one codepoint by the activation command. The codepoint to which the TCI state or the pair of TCI states is mapped may be a codepoint in the TCI field. The codepoint to which the TCI state or the pair of TCI states is mapped may be a codepoint in the TCI field in the DCI format 1_1 or DCI format 1_2. The codepoint to which the TCI state or the pair of TCI states is mapped may be a codepoint in a TCI field in DCI. The TCI state activated by the MAC CE may be the activated TCI state 4200. The TCI state mapped to the codepoint in the TCI field may be the activated TCI state 4200.

In a case that the CORESET pool index (coresetPoolIndex) is not configured in one or multiple CORESETS (ControlResourceSet), the activation command E may be used. In a case that the CORESET pool index (coresetPoolIndex) is configured in one or multiple CORESETS (ControlResourceSet), the activation command D or the activation command E may be used. For example, in a case that First CORESETs and Second CORESETs are provided, the activation command D or the activation command E may be used. For example, in the single-DCI mode, the activation command E may be used. For example, in the multi-DCI mode, the activation command D may be used. For example, in the single-DCI mode and the multi-DCI mode, the activation command E may be used.

One or multiple TCI states 4300 may be indicated by the first DCI The first DCI may be the DCI format 1_1 or the DCI format 1_2. The first DCI may include the TCI field (Transmission Configuration Indication field). The TCI field may indicate one or multiple (e.g., two or four) TCI states. For example, one value of the TCI field may correspond to one codepoint in the TCI field. The TCI state indicated by the first DCI format may be the indicated TCI state 4300. The indicated TCI state 4300 may be some or all of a UL TCI state, a DL TCI state, and a Joint TCI state. The UL TCI state may be a TCI state for a PUSCH, a PUCCH, and an SRS. The DL TCI state may be a TCI state for a PDSCH, a PDCCH, and a CSI-RS. The Joint TCI state may be a TCI state for a PUSCH, a PUCCH, an SRS, a PDSCH, a PDCCH, and a CSI-RS.

One or multiple TCI states 4300 may be indicated by the first DCI and second DCI. Each of the first DCI and the second DCI may be the DCI format 1_1 or the DCI format 1_2. The first DCI or the PDCCH to which the first DCI is mapped may correspond to or be associated with the CORESET pool index 0. The second DCI or the PDCCH to which the second DCI is mapped may correspond to or be associated with the CORESET pool index 1. Each of the first DCI and the second DCI may include the TCI field (Transmission Configuration Indication field). The TCI states indicated by the first DCI and the second DCI format may be the indicated TCI states 4300. For example, a first TCI state 4400 of the indicated TCI states 4300 may be indicated by the first DCI. For example, a second TCI state 4401 of the indicated TCI states 4300 may be indicated by the second DCI.

The number of indicated TCI states 4300 may be four. For example, the indicated TCI states 4300 may include a first pair of a first UL TCI state and a first DL TCI state, and a second pair of a second UL TCI state and a second DL TCI state. The first pair may be associated with a first TRP. The second pair may be associated with a second TRP.

The number of indicated TCI states 4300 may be three. For example, the indicated TCI states 4300 may include the first pair of the first UL TCI state and the first DL TCI state, and a third DL/UL/Joint TCI state. The first pair may be associated with the first TRP and the third DL/UL/Joint TCI state may be associated with the second TRP. The first pair may be associated with the second TRP and the third DL/UL/Joint TCI state may be associated with the first TRP.

The number of indicated TCI states 4300 may be two. For example, the indicated TCI states 4300 may include a first DL/UL/Joint TCI state and a second DL/UL/Joint TCI state. The first DL/UL/Joint may be associated with the first TRP and the second DL/UL/Joint TCI state may be associated with the second TRP.

The number of indicated TCI states 4300 may be two. For example, the indicated TCI states 4300 may include the first pair of the first DL TCI state and the first UL TCI state. The first pair may be associated with the first TRP. The first pair may be associated with the second TRP.

The number of indicated TCI states 4300 may be one. For example, the indicated TCI states 4300 may include the first DL/UL/Joint TCI state. The first DL/UL/Joint need not be associated with a TRP. The first DL/UL/Joint TCI state may be associated with the first TRP. The first DL/UL/Joint TCI state may be associated with the second TRP.

The indicated TCI states 4300 may include one or both of the first TCI state 4400 and the second TCI state 4401.

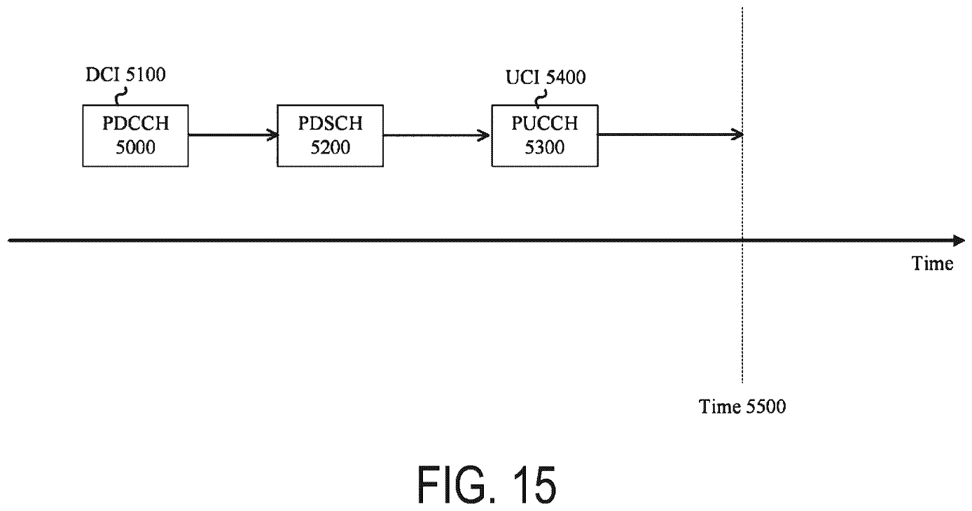

FIG. 15 is a diagram illustrating an example of applying the “indicated TCI state” according to an aspect of the present embodiment. The terminal apparatus 1 may receive a PDCCH 5000. The terminal apparatus 1 may receive the PDCCH 5000 to which DCI 5100 (or DCI format 5100) is mapped. The terminal apparatus 1 may receive the DCI 5100. The DCI 5100 may correspond to the DCI format 1_1 or the DCI format 1_2. The DCI 5100 may include the TCI field. The TCI states 4300 may be indicated by the DCI 5100 or the TCI field in the DCI 5100. The DCI 5100 may convey an indication of the TCI state. The DCI 5100 may include the PUCCH resource indicator field. The DCI 5100 may include the PDSCH_HARQ feedback timing indicator field.

The terminal apparatus 1 may receive a PDSCH 5200. For example, the terminal apparatus 1 may receive the PDSCH 5200 scheduled by the DCI 5100. The DCI 5100 may schedule the PDSCH 5200 or a reception of the PDSCH 5200. The DCI 5100 may indicate the reception of the PDSCH 5200.

The terminal apparatus 1 may transmit a PUCCH 5300. The terminal apparatus 1 may transmit the PUCCH 5300 with UCI 5400. The terminal apparatus 1 may transmit or provide the UCI 5400. The UCI 5400 may include the HARQ-ACK, the HARQ-ACK information, or the HARQ-ACK information bit. The UCI 5400 may be the HARQ-ACK, the HARQ-ACK information, or the HARQ-ACK information bit. For example, the UCI 5400 may be the PDSCH 5200 or HARQ-ACK information for the reception of PDSCH 5200. For example, the UCI 5400 may be HARQ-ACK information corresponding to the DCI 5100. For example, the terminal apparatus 1 may transmit the PUCCH 5300 in response to detecting the DCI format 5100. For example, the terminal apparatus 1 may provide the UCI 5400 in the transmission of the PUCCH 5300 in response to detecting the DCI format 5100. For example, the DCI 5100 may schedule the PUCCH 5300 or the transmission of the PUCCH 5300. For example, the DCI 5100 may indicate the transmission of the PUCCH 5300.

At a time 5500 or from the time 5500, the terminal apparatus 1 may apply the indicated TCI state 4300. The time 5500 may be a slot or an OFDM symbol. For example, the time 5500 may be the first slot N_{symb} symbols after the last OFDM symbol of the PUCCH 5300. N_{symb} may be determined by BeamAppTime.

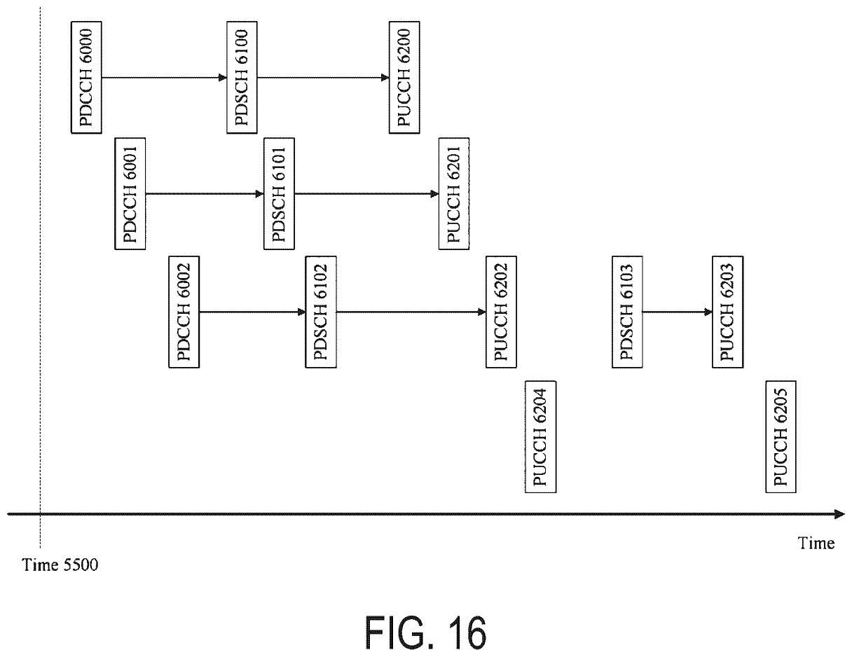

FIG. 16 is a diagram illustrating an example of the PUCCH transmission according to an aspect of the present embodiment.

FIG. 16 may be an example in the Single-DCI mode. The terminal apparatus 1 may receive a PDCCH 6000. The terminal apparatus 1 may receive the PDCCH 6000 in a CORESET 6300. The CORESET pool index (higher layer parameter, CORESETPoolIndex) need not be provided in the CORESET 6300 corresponding to the PDCCH 6000. The indicated TCI states 4300 may be applied for the CORESET 6300 corresponding to the PDCCH 6000 or for the PDCCH 6000. For example, one or both of the first TCI state 4400 and the second TCI state 4401 may be applied for the CORESET 6300 or the PDCCH 6000. For example, one higher layer parameter may provide or give any one of a first indication, a second indication, a third indication, and a fourth indication. For example, one higher layer parameter may provide or give any one of the first indication, the second indication, the third indication, and the fourth indication for the PDCCH 6000. One higher layer parameter may be configured or provided for the CORESET 6300.

In a case that the first indication is given, the first TCI state 4400 may be applied to the CORESET 6300 or the PDCCH 6000. In a case that the second indication is given, the second TCI state 4401 may be applied to the CORESET 6300 or the PDCCH 6000. In a case that the third indication or the fourth indication is given, both the first TCI state 4400 and the second TCI state 4401 may be applied to the CORESET 6300 or PDCCH 6000.

The terminal apparatus 1 may receive a PDSCH 6100. DCI 6400 mapped to the PDCCH 6000 may schedule the PDSCH 6100 or a reception of the PDSCH 6100. The indicated TCI states 4300 may be applied to the PDSCH 6100. For example, one or both of the first TCI state 4400 and the second TCI state 4401 may be applied to the PDSCH 6100. For example, the DCI 6400 or one field in the DCI 6400 may provide or give any one of the first indication, the second indication, the third indication, and the fourth indication. For example, the DCI 6400 or one field in the DCI 6400 may provide or give any one of the first indication, the second indication, the third indication, and the fourth indication for the PDSCH 6100.

In the case that the first indication is given, the first TCI state 4400 may be applied to the PDSCH 6100. In the case that the second indication is given, the second TCI state 4401 may be applied to the PDSCH 6100. In the case that the third indication or the fourth indication is given, both the first TCI state 4400 and the second TCI state 4401 may be applied to the PDSCH 6100.

The terminal apparatus 1 may transmit a PUCCH 6200. The terminal apparatus 1 may transmit (or report) UCI 6500. The DCI 6400 may schedule the PUCCH 6200 or a transmission of the PUCCH 6200. The UCI 6500 may be included in or mapped to the PUCCH 6200. The UCI 6500 may be the HARQ-ACK or the HARQ-ACK information. For example, the UCI 6500 may be the HARQ-ACK information for the PDSCH 6100, a transport block conveyed by the PDSCH 6100, or detection of the DCI 6400 scheduling the PDSCH 6100. A PUCCH resource 6600 corresponding to the PUCCH 6200 may be determined or indicated by the DCI 6400.

The indicated TCI states 4300 may be applied to the PUCCH 6200. For example, one or both of the first TCI state 4400 and the second TCI state 4401 may be applied to the PUCCH 6200. For example, the PUCCH resource 6600 or a higher layer parameter in the PUCCH resource 6600 may provide or give any one of the first indication, the second indication, the third indication, and the fourth indication. For example, the PUCCH resource 6600 or a higher layer parameter, TCI-selectionForPUCCH, in the PUCCH resource 6600 may provide or give any one of the first indication, the second indication, the third indication, and the fourth indication for the PUCCH 6200. In a case that UL-TCIState or DLorJointTCIState is configured (provided), the higher layer parameter TCI-selectionForPUCCH need not be expected to be not configured (provided). In a case that PUCCH-SpatialRelationInfo is configured (provided), the higher layer parameter, TCI-selectionForPUCCH need not be expected to be configured (provided).

In the case that the first indication is given, the first TCI state 4400 may be applied to the PUCCH 6200. In the case that the second indication is given, the second TCI state 4401 may be applied to the PUCCH 6200. In the case that the third indication or the fourth indication is given, both the first TCI state 4400 and the second TCI state 4401 may be applied to the PUCCH 6200. In the case that the first indication is given, one spatial setting may be determined based on the first TCI state 4400. In the case that the second indication is given, one spatial setting may be determined based on the second TCI state 4401. The PUCCH resource 6600 may correspond to one spatial setting, or may include one spatial setting. In the case that the third indication is given, the first TCI state 4400 may correspond to a first spatial setting 6700, and the second TCI state 4401 may correspond to a second spatial setting 6701. In the case that the fourth indication is given, the first TCI state 4400 may correspond to the second spatial setting 6701, and the second TCI state 4401 may correspond to the first spatial setting 6700. For example, the PUCCH resource 6600 may correspond to the first spatial setting 6700 and the second spatial setting 6701, and may include the first spatial setting 6700 and the second spatial setting 6701.

In a case that TCI-selectionForPUCCH is not provided for the PUCCH resource 6600, a spatial setting for the PUCCH 6200 or PUCCH 6200 transmission may be a default spatial setting. In a case that the PUCCH resource 6600 is a common PUCCH resource (PUCCH resource provided by pucch-ResourceCommon), the spatial setting for the PUCCH 6200 or PUCCH 6200 transmission may be the default spatial setting. That is, TCI-selectionForPUCCH need not configured or need not be expected to be configured for the common PUCCH resource. In a case that the number of OFDM symbols (offset) from the last OFDM symbol of the PDCCH 6000 to the first OFDM symbol of the PUCCH 6200 is equal to or less than a threshold, the spatial setting for the PUCCH 6200 or PUCCH 6200 transmission may be the default spatial setting. In a case that the number of OFDM symbols (offset) from the last OFDM symbol of the PDSCH 6100 to the first OFDM symbol of the PUCCH 6200 is equal to or less than a threshold, the spatial setting for the PUCCH 6200 or PUCCH 6200 transmission may be the default spatial setting.

The default spatial setting may be determined based on the indicated TCI states 4300. For example, the default spatial setting may be the same as the spatial setting for the PDCCH 6000 or PDCCH 6000 reception. For example, the default spatial setting may be determined based on the first TCI state 4400 or the second TCI state 4401.

FIG. 16 may be an example in the Multi-DCI mode. The terminal apparatus 1 may receive a PDCCH 6001. The terminal apparatus 1 may receive the PDCCH 6001 in a CORESET 6301. The terminal apparatus 1 may receive the PDCCH 6000 in the CORESET 6300 and the PDCCH 6001 in the CORESET 6301. The CORESET 6300 may be different from the CORESET 6301. The CORESET pool index 0 (CORESET pool index set to 0) may be provided for the CORESET 6300. The CORESET pool index 1 (CORESET pool index set to 1) may be provided for the CORESET 6301. The indicated TCI states 4300 may be applied for the CORESET 6300 or the PDCCH 6000. The indicated TCI states 4300 may be applied for the CORESET 6301 or the PDCCH 6001. For example, one or both of the first TCI state 4400 and the second TCI state 4401 may be applied for the CORESET 6300 or the PDCCH 6000. For example, one or both of the first TCI state 4400 and the second TCI state 4401 may be applied for the CORESET 6301 or the PDCCH 6001.

The first TCI state 4400 may correspond to or be associated with the CORESET pool index 0. The second TCI state 4401 may correspond to or be associated with the CORESET pool index 1. For example, the first TCI state 4400 may be included in the TCI state activated by the MAC CE corresponding to the CORESET pool index 0. For example, the second TCI state 4401 may be included in the TCI state activated by the MAC CE corresponding to the CORESET pool index 1. In a case that the CORESET pool index 0 is provided for the CORESET 6300, the first TCI state 4400 may be applied to the PDCCH 6000 in the CORESET 6300. In a case that the CORESET pool index 1 is provided for the CORESET 6301, the second TCI state 4401 may be applied to the PDCCH 6001 in the CORESET 6301.

The terminal apparatus 1 may receive the PDSCH 6100 and PDSCH 6101. The DCI 6400 mapped to the PDCCH 6000 may schedule the PDSCH 6100 or a reception of the PDSCH 6100. DCI 6401 mapped to the PDCCH 6001 may schedule the PDSCH 6101 or a reception of the PDSCH 6101. The indicated TCI states 4300 may be applied to the PDSCH 6100 and the PDSCH 6101. For example, the first TCI state 4400 may be applied to the PDSCH 6100, For example, the first TCI state 4401 may be applied to the PDSCH 6101.

In a case that the CORESET pool index 0 is provided for the CORESET 6300 corresponding to the PDCCH 6000 and in a case that the PDSCH 6100 is scheduled by the DCI 6400 mapped to the PDCCH 6000, the first TCI state 4400 may be applied to the PDSCH 6100. In a case that the CORESET pool index 1 is provided for the CORESET 6301 corresponding to the PDCCH 6001 and in a case that the PDSCH 6101 is scheduled by the DCI 6401 mapped to the PDCCH 6001, the second TCI state 4401 may be applied to the PDSCH 6101.

The terminal apparatus 1 may transmit the PUCCH 6200 and a PUCCH 6201. The terminal apparatus 1 may transmit (or report) the UCI 6500 and UCI 6501. The DCI 6400 may schedule the PUCCH 6200 or a transmission of the PUCCH 6200. The DCI 6401 may schedule the PUCCH 6201 or a transmission of the PUCCH 6201. The UCI 6500 may be included in or mapped to the PUCCH 6200. The UCI 6501 may be included in or mapped to the PUCCH 6201. Each of the UCI 6500 and the UCI 6501 may be the HARQ-ACK or the HARQ-ACK information. For example, the UCI 6500 may be the HARQ-ACK information for the PDSCH 6100, a transport block conveyed by the PDSCH 6100, or detection of the DCI 6400 scheduling the PDSCH 6100. For example, the UCI 6501 may be the HARQ-ACK information for the PDSCH 6101, a transport block conveyed by the PDSCH 6101, or detection of the DCI 6401 scheduling the PDSCH 6101. A PUCCH resource 6600 corresponding to the PUCCH 6200 may be determined or indicated by the DCI 6400. A PUCCH resource 6601 corresponding to the PUCCH 6201 may be determined or indicated by the DCI 6401.

The first TCI state 4400 may correspond to or be associated with the CORESET pool index 0. The second TCI state 4401 may correspond to or be associated with the CORESET pool index 1. The first TCI state 4400 may correspond to the first spatial setting 6700. The second TCI state 4401 may correspond to the second spatial setting 6701. The first spatial setting 6700 may correspond to the CORESET pool index 0. The second spatial setting 6701 may correspond to the CORESET pool index 1.

A means 1 and a means 2 may be used to determine a spatial setting applied to each of the PUCCH 6200 and the PUCCH 6201.

In the means 1, TCI-selectionForPUCCH may be configured (provided) for each of the PUCCH resource 6600 and the PUCCH resource 6601. In a case that TCI-selectionForPUCCH for the PUCCH resource 6600 gives the first indication, the PUCCH resource 6600 may be associated with the CORESET pool index 0. In a case that TCI-selectionForPUCCH for the PUCCH resource 6600 gives the second indication, the PUCCH resource 6600 may be associated with the CORESET pool index 1. In a case that TCI-selectionForPUCCH for the PUCCH resource 6600 gives the third indication or the fourth indication, the PUCCH resource 6600 may be associated with the CORESET pool index 0 and the CORESET pool index 1. In a case that TCI-selectionForPUCCH for the PUCCH resource 6601 gives the first indication, the PUCCH resource 6601 may be associated with the CORESET pool index 0. In a case that TCI-selectionForPUCCH for the PUCCH resource 6601 gives the second indication, the PUCCH resource 6601 may be associated with the CORESET pool index 1. In a case that TCI-selectionForPUCCH for the PUCCH resource 6601 gives the third indication or the fourth indication, the PUCCH resource 6601 may be associated with the CORESET pool index 0 and the CORESET pool index 1.

In a first case, the first spatial setting 6700 may be used for the PUCCH 6200. The first case may be that the CORESET 6300 corresponding to the PDCCH 6000 to which the DCI 6400 scheduling the PUCCH 6200 is mapped is associated with the CORESET pool index 0, and TCI-selectionForPUCCH for the PUCCH resource 6600 indicated by the DCI 6400 gives the second indication. That is, in a case that the CORESET 6300 is associated with the CORESET pool index 0, the first spatial setting 6700 may be used for the PUCCH 6200. In a second case, the second spatial setting 6701 may be used for the PUCCH 6201. The second case may be that the CORESET 6301 corresponding to the PDCCH 6001 to which the DCI 6401 scheduling the PUCCH 6201 is mapped is associated with the CORESET pool index 1, and TCI-selectionForPUCCH for the PUCCH resource 6601 indicated by the DCI 6401 gives the first indication. That is, in a case that the CORESET 6301 is associated with the CORESET pool index 1, the second spatial setting 6701 may be used for the PUCCH 6201. For example, in a case that the DCI 6400 schedules the PUCCH 6200 (transmission of the PUCCH 6200), TCI-selectionForPUCCH in the PUCCH resource 6600 for the PUCCH 6200 may be ignored. For example, in a case that the DCI 6401 schedules the PUCCH 6201 (transmission of the PUCCH 6201), TCI-selectionForPUCCH in the PUCCH resource 6601 for the PUCCH 6201 may be ignored.

In the means 2, TCI-selectionForPUCCH need not be expected to be configured (provided) for each of the PUCCH resource 6600 and the PUCCH resource 6601. Specifically, TCI-selectionForPUCCH need not be configured (provided) for each of the PUCCH resource 6600 and the PUCCH resource 6601. In a case that the PUCCH resource 6600 is indicated by the DCI 6400, TCI-selectionForPUCCH need not be expected to be configured (provided) for the PUCCH resource 6600. In a case that the PUCCH resource 6601 is indicated by the DCI 6401, TCI-selectionForPUCCH need not be expected to be configured (provided) for the PUCCH resource 6601.

In the case that the CORESET 6300 is associated with the CORESET pool index 0, the first spatial setting 6700 may be used for the PUCCH 6200. In the case that the CORESET 6301 is associated with the CORESET pool index 1, the second spatial setting 6701 may be used for the PUCCH 6201.

The terminal apparatus 1 may receive a PDCCH 6002. The terminal apparatus 1 may receive the PDCCH 6002 in a CORESET 6302. The CORESET pool index 0 (CORESET pool index set to 0) or the CORESET pool index 1 (CORESET pool index set to 1) may be provided for the CORESET 6302, The indicated TCI states 4300 may be applied for the CORESET 6302 or the PDCCH 6002. For example, one or both of the first TCI state 4400 and the second TCI state 4401 may be applied for the CORESET 6302 or the PDCCH 6002.

In a case that the CORESET pool index 0 is provided for the CORESET 6302, the first TCI state 4400 may be applied to the CORESET 6302 or the PDCCH 6002 in the CORESET 6302. In a case that the CORESET pool index 1 is provided for the CORESET 6302, the second TCI state 4401 may be applied to the CORESET 6302 or the PDCCH 6002 in the CORESET 6302.

The terminal apparatus 1 may receive a PDSCH 6102. The PDSCH 6102 may be an SPS PDSCH. The PDCCH 6002 may be a DL SPS assignment PDCCH. For example, the PDCCH 6002 may be validated for the SPS PDSCH 6102. For example, a CRC of DCI 6402 in the PDCCH 6002 may be scrambled by a CS-RNTI. For example, the DCI 6402 may provide the configured downlink assignment. The DCI 6402 mapped to the PDCCH 6002 may activate the PDSCH 6102 or a reception of the PDSCH 6102. The reception of the PDSCH 6102 may be considered to be with no corresponding PDCCH. The indicated TCI states 4300 may be applied to the PDSCH 6102. For example, the first TCI state 4400 and the second TCI state 4401 may be applied to the PDSCH 6102.

In a case that the CORESET pool index 0 is provided for the CORESET 6302, the first TCI state 4400 may be applied to the PDSCH 6102. In a case that the CORESET pool index 1 is provided for the CORESET 6302, the second TCI state 4401 may be applied to the PDSCH 6102.

The terminal apparatus 1 may transmit a PUCCH 6202. The terminal apparatus 1 may transmit (or report) UCI 6502. The DCI 6402 may activate the PUCCH 6202 or a transmission of the PUCCH 6202. The UCI 6502 may be included in or mapped to the PUCCH 6202. The UCI 6502 may be the HARQ-ACK or the HARQ-ACK information. For example, the UCI 6502 may be a reception of the SPS PDSCH 6102 or HARQ-ACK information for a transport block conveyed by the PDSCH 6102. The UCI 6502 may be HARQ-ACK information corresponding to the PDSCH 6102 reception without a corresponding PDCCH.

A PUCCH resource 6602 corresponding to the PUCCH 6202 may be determined based on a higher layer parameter. The higher layer parameter may be SPS-PUCCH-AN-List or n1PUCCH-AN. For example, in a case that SPS-PUCCH-AN-List is not provided, the PUCCH resource 6602 for the PUCCH 6202 may be provided by n1PUCCH-AN. The higher layer parameter may provide one PUCCH resource ID (PUCCHResourceId).

A means 3a, a means 3b, and a means 4 may be used to determine a spatial setting to be applied to the PUCCH 6202.

In the means 3a and the means 3b, TCI-selectionForPUCCH may be configured (provided) for the PUCCH resource 6602. In a case that TCI-selectionForPUCCH for the PUCCH resource 6602 gives the first indication, the PUCCH resource 6602 may be associated with the CORESET pool index 0. In a case that TCI-selectionForPUCCH for the PUCCH resource 6602 gives the second indication, the PUCCH resource 6602 may be associated with the CORESET pool index 1. In a case that TCI-selectionForPUCCH for the PUCCH resource 6602 gives the third indication or the fourth indication, the PUCCH resource 6602 may be associated with the CORESET pool index 0 and the CORESET pool index 1.

In the means 3a, in a case that the CORESET 6302 is associated with the CORESET pool index 0 and in a case that TCI-selectionForPUCCH for the PUCCH resource 6602 gives the first indication, the first spatial setting 6700 may be used for the PUCCH 6202. In the case that the CORESET 6302 is associated with the CORESET pool index 0 and in the case that TCI-selectionForPUCCH for the PUCCH resource 6602 gives the second indication, the second spatial setting 6701 may be used for the PUCCH 6202. In a case that the CORESET 6302 is associated with the CORESET pool index 1 and in the case that TCI-selectionForPUCCH for the PUCCH resource 6602 gives the first indication, the first spatial setting 6700 may be used for the PUCCH 6202. In the case that the CORESET 6302 is associated with the CORESET pool index 1 and in the case that TCI-selectionForPUCCH for the PUCCH resource 6602 gives the second indication, the second spatial setting 6701 may be used for the PUCCH 6202. That is, in a case that TCI-selectionForPUCCH gives the first indication, the first spatial setting 6700 may be used for the PUCCH 6202. That is, in a case that TCI-selectionForPUCCH gives the second indication, the second spatial setting 6701 may be used for the PUCCH 6202. For example, in a case that TCI-selectionForPUCCH is provided for the PUCCH resource 6602, the CORESET pool index of the CORESET 6302 may be ignored.

In the means 3b, in the case that the CORESET 6302 is associated with the CORESET pool index 0 and in the case that TCI-selectionForPUCCH for the PUCCH resource 6602 gives the first indication, the first spatial setting 6700 may be used for the PUCCH 6202. In the case that the CORESET 6302 is associated with the CORESET pool index 0 and in the case that TCI-selectionForPUCCH for the PUCCH resource 6602 gives the second indication, the first spatial setting 6700 may be used for the PUCCH 6202. In the case that the CORESET 6302 is associated with the CORESET pool index 1 and in the case that TCI-selectionForPUCCH for the PUCCH resource 6602 gives the first indication, the second spatial setting 6701 may be used for the PUCCH 6202. In the case that the CORESET 6302 is associated with the CORESET pool index 1 and in the case that TCI-selectionForPUCCH for the PUCCH resource 6602 gives the second indication, the second spatial setting 6701 may be used for the PUCCH 6202. That is, in the case that the CORESET 6302 is associated with the CORESET pool index 0, the first spatial setting 6700 may be used for the PUCCH 6202. That is, in the case that the CORESET 6302 is associated with the CORESET pool index 1, the second spatial setting 6701 may be used for the PUCCH 6202. For example, TCI-selectionForPUCCH for the PUCCH resource 6602 may be ignored.

In the means 4, TCI-selectionForPUCCH need not be expected to be configured (provided) for the PUCCH resource 6602. Specifically, TCI-selectionForPUCCH need not be configured (provided) for the PUCCH resource 6602. In a case that the PUCCH resource 6602 is provided by SPS-PUCCH-AN-List or n1PUCCH-AN, TCI-selectionForPUCCH need not be expected to be configured (provided) for the PUCCH resource 6602. In the case that the CORESET 6302 is associated with the CORESET pool index 0, the first spatial setting 6700 may be used for the PUCCH 6202. In the case that the CORESET 6302 is associated with the CORESET pool index 1, the second spatial setting 6701 may be used for the PUCCH 6202.

The terminal apparatus 1 may receive a PDSCH 6103. Each of the PDSCH 6102 and the PDSCH 6103 may be an SPS PDSCH. For example, the PDSCH 6102 may be the first SPS PDSCH. For example, the PDCCH 6102 reception may be a reception of a leading SPS PDSCH. The PDSCH 6103 need not be a leading SPS PDSCH. The PDSCH 6102 may be associated with an activation DCI 6402 (Activation DCI). The PDCCH 6002 may be validated for the SPS PDSCH 6102 and the SPS PDSCH 6103. The DCI 6402 mapped to the PDCCH 6002 may activate the PDSCH 6103 or a reception of the PDSCH 6103. The reception of the PDSCH 6103 may be considered to be with no corresponding PDCCH. The indicated TCI states 4300 may be applied to the PDSCH 6103. For example, the first TCI state 4400 and the second TCI state 4401 may be applied to the PDSCH 6103.

In the case that the CORESET pool index 0 is provided for the CORESET 6302, the first TCI state 4400 may be applied to the PDSCH 6103. In the case that the CORESET pool index 1 is provided for the CORESET 6302, the second TCI state 4401 may be applied to the PDSCH 6103.

The terminal apparatus 1 may transmit a PUCCH 6203. The terminal apparatus 1 may transmit (or report) UCI 6503. The DCI 6402 may activate the PUCCH 6203 or a transmission of the PUCCH 6203. The UCI 6503 may be included in or mapped to the PUCCH 6203. The UCI 6503 may be the HARQ-ACK or the HARQ-ACK information. For example, the UCI 6503 may be a reception of the SPS PDSCH 6103 or HARQ-ACK information for a transport block conveyed by the PDSCH 6103. The UCI 6503 may be HARQ-ACK information corresponding to the PDSCH 6103 reception without a corresponding PDCCH.

A PUCCH resource 6603 corresponding to the PUCCH 6203 may be determined based on a higher layer parameter. The PUCCH resource 6603 may be the PUCCH resource 6602. The higher layer parameter may be SPS-PUCCH-AN-List or n1PUCCH-AN. For example, in the case that SPS-PUCCH-AN-List is not provided, the PUCCH resource 6603 for the PUCCH 6203 may be provided by n1PUCCH-AN. The higher layer parameter may provide one PUCCH resource ID (PUCCHResourceId).

The means 3a, the means 3b, and the means 4 may be used to determine a spatial setting to be applied to the PUCCH 6203.

In the means 3a and the means 3b, TCI-selectionForPUCCH may be configured (provided) for one or both of the PUCCH resource 6602 and the PUCCH resource 6603. In a case that TCI-selectionForPUCCH for the PUCCH resource 6603 gives the first indication, the PUCCH resource 6603 may be associated with the CORESET pool index 0. In a case that TCI-selectionForPUCCH for the PUCCH resource 6603 gives the second indication, the PUCCH resource 6603 may be associated with the CORESET pool index 1. In a case that TCI-selectionForPUCCH for the PUCCH resource 6603 gives the third indication or the fourth indication, the PUCCH resource 6603 may be associated with the CORESET pool index 0 and the CORESET pool index 1.

In the means 3a, in the case that the CORESET 6302 is associated with the CORESET pool index 0 and in the case that TCI-selectionForPUCCH for the PUCCH resource 6603 gives the first indication, the first spatial setting 6700 may be used for the PUCCH 6203. In the case that the CORESET 6302 is associated with the CORESET pool index 0 and in the case that TCI-selectionForPUCCH for the PUCCH resource 6603 gives the second indication, the second spatial setting 6701 may be used for the PUCCH 6203. In the case that the CORESET 6302 is associated with the CORESET pool index 1 and in the case that TCI-selectionForPUCCH for the PUCCH resource 6603 gives the first indication, the first spatial setting 6700 may be used for the PUCCH 6203. In the case that the CORESET 6302 is associated with the CORESET pool index 1 and in the case that TCI-selectionForPUCCH for the PUCCH resource 6603 gives the second indication, the second spatial setting 6701 may be used for the PUCCH 6203. That is, in the case that TCI-selectionForPUCCH gives the first indication, the first spatial setting 6700 may be used for the PUCCH 6203. That is, in the case that TCI-selectionForPUCCH gives the second indication, the second spatial setting 6701 may be used for PUCCH 6203. For example, in a case that TCI-selectionForPUCCH is provided for the PUCCH resource 6603, the CORESET pool index of the CORESET 6302 may be ignored.

In the means 3b, in the case that the CORESET 6302 is associated with the CORESET pool index 0 and in the case that TCI-selectionForPUCCH for the PUCCH resource 6603 gives the first indication, the first spatial setting 6700 may be used for the PUCCH 6203. In the case that the CORESET 6302 is associated with the CORESET pool index 0 and in the case that TCI-selectionForPUCCH for the PUCCH resource 6603 gives the second indication, the first spatial setting 6700 may be used for the PUCCH 6203. In the case that the CORESET 6302 is associated with the CORESET pool index 1 and in the case that TCI-selectionForPUCCH for the PUCCH resource 6603 gives the first indication, the second spatial setting 6701 may be used for the PUCCH 6203. In the case that the CORESET 6302 is associated with the CORESET pool index 1 and in the case that TCI-selectionForPUCCH for the PUCCH resource 6603 gives the second indication, the second spatial setting 6701 may be used for the PUCCH 6203. That is, in the case that the CORESET 6302 is associated with the CORESET pool index 0, the first spatial setting 6700 may be used for the PUCCH 6203. That is, in the case that the CORESET 6302 is associated with the CORESET pool index 1, the second spatial setting 6701 may be used for the PUCCH 6203. For example, TCI-selectionForPUCCH for the PUCCH resource 6603 may be ignored.

In the means 4, TCI-selectionForPUCCH need not be expected to be configured (provided) for the PUCCH resource 6603. Specifically, TCI-selectionForPUCCH need not be configured (provided) for the PUCCH resource 6603. In a case that the PUCCH resource 6603 is provided by SPS-PUCCH-AN-List or n1PUCCH-AN, TCI-selectionForPUCCH need not be expected to be configured (provided) for the PUCCH resource 6603. In the case that the CORESET 6302 is associated with the CORESET pool index 0, the first spatial setting 6700 may be used for the PUCCH 6203. In the case that the CORESET 6302 is associated with the CORESET pool index 1, the second spatial setting 6701 may be used for the PUCCH 6203.

The terminal apparatus 1 may receive one or both of a PUCCH 6204 and a PUCCH 6205. The terminal apparatus 1 may transmit (or report) one or both of UCI 6504 and UCI 6505. The UCI 6504 may be included in or mapped to the PUCCH 6204. The UCI 6505 may be included in or mapped to the PUCCH 6205. The UCI 6504 may include an SR, an LRR, or CSI The UCI 6505 may include an SR, an LRR, or CSI. The PUCCH 6204 need not be scheduled by the DCL The PUCCH 6205 need not be scheduled by the DCI A PUCCH resource 6604 for the PUCCH 6204 need not be indicated by the DCI. A PUCCH resource 6605 for the PUCCH 6205 need not be indicated by the DCI. The PUCCH resource 6604 may correspond to or be associated with the PUCCH 6204. The PUCCH resource 6605 may correspond to or be associated with the PUCCH 6205. The PUCCH resource 6604 may be configured for a transmission of the CSI (or a report of the CSI). The PUCCH resource 6605 may be configured for a transmission of the CSI (or a report of the CSI). The PUCCH resource 6604 may be provided by a higher layer parameter. The PUCCH resource 6605 may be provided by a higher layer parameter. The PUCCH resource 6604 may be provided by a higher layer parameter, pucch-CSI-ResourceList, or a higher layer parameter, multi-CSI-PUCCH-ResourceList. The PUCCH resource 6605 may be provided by the higher layer parameter, pucch-CSI-ResourceList, or the higher layer parameter, multi-CSI-PUCCH-ResourceList. The PUCCH 6204 may involve CSI reporting. However, the PUCCH 6204 need not involve Semi-persistent CSI (SP-CSD). The PUCCH 6205 may involve CSI reporting. However, the PUCCH 6204 need not involve Semi-persistent CSI (SP-CSI). The PUCCH 6204 may involve a CSI report bit O_{CSI}. The PUCCH 6205 may involve a CSI report bit O_{CSI}. A CSI report configuration may be a configuration for transmission of CSI reporting. The CSI report configuration may be configured in the higher layer parameter, PUCCH-Config. The CSI report configuration may be a higher layer parameter, CSI-ReportConfig. The PUCCH resource 6604 may be configured in the higher layer parameter CSI-ReportConfig. The PUCCH resource 6605 may be configured in the higher layer parameter CSI-ReportConfig. The PUCCH resource 6604 may correspond to a Periodic CSI resource. The PUCCH resource 6605 may correspond to a Periodic CSI resource. The CSI reporting may be performed in the PUCCH 6204. The CSI reporting may be performed in the PUCCH 6205.

A means 5 may be used to determine a spatial setting applied to one or both of the PUCCH 6204 and the PUCCH 6205.

In the means 5, TCI-selectionForPUCCH may be configured (provided) for one or both of the PUCCH resource 6604 and the PUCCH resource 6605. In a case that TCI-selectionForPUCCH for the PUCCH resource 6604 gives the first indication, the PUCCH resource 6604 may be associated with the CORESET pool index 0. In a case that TCI-selectionForPUCCH for the PUCCH resource 6604 gives the second indication, the PUCCH resource 6604 may be associated with the CORESET pool index 1. In a case that TCI-selectionForPUCCH for the PUCCH resource 6604 gives the third indication or the fourth indication, the PUCCH resource 6604 may be associated with the CORESET pool index 0 and the CORESET pool index 1. In the case that TCI-selectionForPUCCH for the PUCCH resource 6604 gives the first indication, the PUCCH resource 6604 may be associated with the first spatial setting 6700 or the first TCI state 4400. In the case that TCI-selectionForPUCCH for the PUCCH resource 6604 gives the second indication, the PUCCH resource 6604 may be associated with the second spatial setting 6701 or the second TCI state 4401. In a case that TCI-selectionForPUCCH for the PUCCH resource 6604 gives the third indication or the fourth indication, the PUCCH resource 6604 may be associated with the first spatial setting 6700 and the second spatial setting 6701. In a case that TCI-selectionForPUCCH for the PUCCH resource 6604 gives the third indication or the fourth indication, the PUCCH resource 6604 may be associated with the first TCI state 4400 and the second TCI state 4401.

In the means 5, in the case that TCI-selectionForPUCCH for the PUCCH resource 6604 gives the first indication, the first spatial setting 6700 may be used for the PUCCH 6204. In the case that TCI-selectionForPUCCH for the PUCCH resource 6604 gives the second indication, the second spatial setting 6701 may be used for the PUCCH 6204. In the case that TCI-selectionForPUCCH for the PUCCH resource 6604 gives the first indication, the first spatial setting 6700 or the first TCI state 4400 may be applied to the PUCCH 6204. In the case that TCI-selectionForPUCCH for the PUCCH resource 6604 gives the second indication, the second spatial setting 6701 or the second TCI state 4401 may be applied to the PUCCH 6204. In a case that TCI-selectionForPUCCH for the PUCCH resource 6605 gives the first indication, the first spatial setting 6700 may be used for the PUCCH 6205. In a case that TCI-selectionForPUCCH for the PUCCH resource 6605 gives the second indication, the second spatial setting 6701 may be used for the PUCCH 6205. In the case that TCI-selectionForPUCCH for the PUCCH resource 6605 gives the first indication, the first spatial setting 6700 or the first TCI state 4400 may be applied to the PUCCH 6205. In the case that TCI-selectionForPUCCH for the PUCCH resource 6605 gives the second indication, the second spatial setting 6705 or the second TCI state 4401 may be applied to the PUCCH 6205.

In the means 5, in a case that TCI-selectionForPUCCH is not provided for the PUCCH resource 6604, the default spatial setting may be applied to the PUCCH 6204. In a case that TCI-selectionForPUCCH is not provided for the PUCCH resource 6605, the default spatial setting may be applied to the PUCCH 6205. Alternatively, TCI-selectionForPUCCH need not be expected to be provided for the PUCCH 6604. TCI-selectionForPUCCH need not be expected to be provided for the PUCCH 6605.

The default spatial setting may be determined based on the indicated TCI states 4300. For example, the default spatial setting may correspond to the first TCI state 4400 or may be the first spatial setting 6700.

The terminal apparatus 1 may receive a first PDCCH to which the first DCI is mapped. The terminal apparatus 1 may receive a second PDCCH to which the second DCI is mapped. The terminal apparatus 1 may receive a first PDSCH scheduled by the first DCI. The terminal apparatus 1 may receive a second PDSCH (SPS PDSCH) activated by the second DCI.

The terminal apparatus 1 may transmit a first PUCCH, a second PUCCH, and a third PUCCH. The first DCI may schedule or indicate the first PUCCH or a first PUCCH transmission. The second DCI may activate or indicate the second PUCCH or a second PUCCH transmission. The third PUCCH or a third PUCCH transmission may be configured by a higher layer parameter. The third PUCCH or the third PUCCH transmission need not be scheduled or activated by the DCI.

For example, the first PUCCH transmission may be a PUCCH transmission for the first PDSCH reception, and may involve the HARQ-ACK information for the first PDSCH reception. For example, the second PUCCH transmission may be a PUCCH transmission corresponding to the second SPS PDSCH reception, and may involve the HARQ-ACK information for the second PDSCH reception. For example, the third PUCCH transmission may be a PUCCH transmission for the CSI reporting, and may involve the UCI for the CSI.

The first PUCCH resource for the first PUCCH may be indicated by the first DCI. The second PUCCH resource for the second PUCCH may be provided by the first higher layer parameter. The third PUCCH resource for the third PUCCH may be provided by the second higher layer parameter.

TCI-selectionForPUCCH need not be expected to be configured (provided) in the first PUCCH resource. TCI-selectionForPUCCH configured (provided) in the first PUCCH resource may be ignored. TCI-selectionForPUCCH need not be expected to be configured (provided) in the second PUCCH resource. TCI-selectionForPUCCH configured (provided) in the second PUCCH resource may be ignored. TCI-selectionForPUCCH may be configured (provided) in the third PUCCH resource. TCI-selectionForPUCCH may include a value of a CORESET pool index, mapping information of a spatial setting, or mapping information of a TCI state. The mapping information of the spatial setting may indicate whether the first or second spatial setting is used. The mapping information of the TCI state may indicate whether the first or second TCI state is used.

First beam information applied to the first PUCCH may be determined based on a value of a first CORESET pool index. Second beam information applied to the second PUCCH may be determined based on a value of a second CORESET pool index. Third beam information applied to the third PUCCH may be determined based on a value of a third CORESET pool index, mapping information of the spatial setting by TCI-selectionForPUCCH, or mapping information of the TCI state by TCI-selectionForPUCCH.

The value of the first CORESET pool index may be the same as the value of the CORESET pool index of the CORESET corresponding to the first PDCCH or the first DCI The value of the second CORESET pool index may be the same as the value of the CORESET pool index of the CORESET corresponding to the second PDCCH or the second DCI The value of the third CORESET pool index may be included in TCI-selectionForPUCCH.

Each of the first beam information, the second beam information, and the third beam information may be the TCI state (for example, indicated TCI state) or the spatial setting. The spatial setting may be associated with the TCI state (e.g., indicated TCI state). The TCI state (e.g., indicated TCI state) may be associated with a value of one CORESET pool index

Various aspects of apparatuses according to an aspect of the present embodiment will be described below.

Each of programs running on the base station apparatus 3 and the terminal apparatus 1 according to the present invention may be a program that controls a central processing unit (CPU) and the like (a program causing a computer to function) to realize the functions of the above-described embodiment according to the present invention. The information handled in these apparatuses is temporarily loaded into a Random Access Memory (RAM) while being processed, is then stored in a Hard Disk Drive (HDD) and various types of Read Only Memory (ROM) such as a Flash ROM, and is read, modified, and written by the CPU, as necessary.

Note that the terminal apparatus 1 and the base station apparatus 3 according to the above-described embodiment may be partially implemented by a computer. In that case, this configuration may be implemented by recording a program for implementing such control functions on a computer-readable recording medium and causing a computer system to read the program recorded on the recording medium for execution.

Note that it is assumed that the “computer system” mentioned here refers to a computer system built into the terminal apparatus 1 or the base station apparatus 3, and the computer system includes an OS and hardware components such as peripheral devices. In addition, the “computer-readable recording medium” refers to a portable medium such as a flexible disk, a magneto-optical disk, a ROM, and a CD-ROM, and a storage apparatus such as a hard disk built into the computer system.

Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a certain period of time, such as a volatile memory included in the computer system functioning as a server or a client in such a case. In addition, the above-described program may be one for implementing some of the above-described functions, and also may be one capable of implementing the above-described functions in combination with a program already recorded in a computer system.

Furthermore, the base station apparatus 3 according to the aforementioned embodiment may be implemented as an aggregation (apparatus group) including multiple apparatuses. Each of the apparatuses included in such an apparatus group may include a part or all of each function or each functional block of the base station apparatus 3 according to the aforementioned embodiment. As the apparatus group, it is only necessary to have all of functions or functional blocks of the base station apparatus 3. Moreover, the terminal apparatus 1 according to the aforementioned embodiment can also communicate with the base station apparatus as the aggregation.

Also, the base station apparatus 3 according to the aforementioned embodiment may be an Evolved Universal Terrestrial Radio Access Network (EUTRAN) and/or a NextGen RAN (NG-RAN or NR RAN). Moreover, the base station apparatus 3 according to the aforementioned embodiment may have a part or all of the functions of a higher node for an eNodeB and/or a gNB.

Also, a part or all portions of each of the terminal apparatus 1 and the base station apparatus 3 according to the aforementioned embodiment may be implemented as an LSI, which is typically an integrated circuit, or may be implemented as a chip set. The functional blocks of each of the terminal apparatus 1 and the base station apparatus 3 may be individually implemented as a chip, or a part or all of the functional blocks may be integrated into a chip. Furthermore, a circuit integration technique is not limited to the LSI and may be implemented with a dedicated circuit or a general-purpose processor. Moreover, in a case that a circuit integration technology that substitutes an LSI appears with the advance of the semiconductor technology, it is also possible to use an integrated circuit based on the technology.

In addition, although the aforementioned embodiments have described the terminal apparatus as an example of a communication apparatus, the present invention is not limited to such a terminal apparatus, and is also applicable to a terminal apparatus or a communication apparatus that is a stationary type or a non-movable type electronic apparatus installed indoors or outdoors, for example, such as an AV device, a kitchen device, a cleaning or washing machine, an air-conditioning device, office equipment, a vending machine, and other household appliances.

Although the embodiments of the present invention have been described in detail above referring to the drawings, the specific configuration is not limited to the embodiments and includes, for example, design changes within the scope that do not depart from the gist of the present invention. Furthermore, in the present invention, various modifications are possible within the scope of the claims, and embodiments that are made by suitably combining technical means disclosed according to the different embodiments are also included in the technical scope of the present invention. In addition, a configuration in which elements described in the respective embodiments and having mutually similar effects are substituted for one another is also included.

### INDUSTRIAL APPLICABILITY

The present invention is applicable to a mobile phone, a personal computer, and the like. REFERENCE SIGNS LIST
1 (1A, 1B, 1C) Terminal apparatus
3 Base station apparatus
10, 30 Radio transmission and/or reception unit
10a, 30a Radio transmission unit
10b, 30b Radio reception unit
11, 31 Antenna unit
12, 32 RF unit
13, 33 Baseband unit
14, 34 Higher layer processing unit
15, 35 Medium access control layer processing unit
16, 36 Radio resource control layer processing unit
91, 92, 93, 94 Search space set
300 Component carrier
301 Primary cell
302, 303 Secondary cell
700 Set of resource elements for PSS
710, 711, 712, 713 Set of resource elements for PBCH and DMRS for PBCH
720 Set of resource elements for SSS
3000 Point
3001, 3002 Resource grid
3003, 3004 BWP
3011, 3012, 3013, 3014 Offset
3100, 3200 Common resource block set
4100 Configured TCI state
4200 Activated TCI state
4300 Indicated TCI state
4400, 4401 First TCI state, second TCI state
5000, 6000, 6001, 6002 PDCCH
5100, 6400, 6401, 6402 DCI
5200, 6100, 6101, 6102, 6103 PDSCH
5300, 6200, 6201, 6202, 6203, 6204, 6205 PUCCH
5400, 6500, 6501, 6502, 6503, 6504, 6505 UCI
5500 Time
6300, 6301, 6302 CORESET
6600, 6601, 6602, 6603, 6604, 6605 PUCCH resource
6700, 6701 Spatial setting

1. A terminal apparatus comprising:
a receiver configured to receive a physical downlink control channel (PDCCH) to which downlink control information (DCI) is mapped; and
a transmitter configured to transmit a first physical uplink control channel (PUCCH) and a second PUCCH scheduled by the DCI, wherein
a first PUCCH resource for the first PUCCH is indicated by the DCI,
a second PUCCH resource for the second PUCCH is configured by a first higher layer parameter,
a value of a first control resource set (CORESET) pool index corresponds to a CORESET for the PDCCH, and
a value of a second CORESET pool index corresponds to a second higher layer parameter,
first beam information applied to the first PUCCH is determined based on the value of the first CORESET pool index,
second beam information applied to the second PUCCH is determined based on the second higher layer parameter in the second PUCCH resource.

2-3. (canceled)

4. A base station apparatus comprising:
a transmitter configured to transmit a physical downlink control channel (PDCCH) to which downlink control information (DCI) is mapped; and
a receiver configured to receive a first physical uplink control channel (PUCCH) and a second PUCCH scheduled by the DCI, wherein
a first PUCCH resource for the first PUCCH is indicated by the DCI,
a second PUCCH resource for the second PUCCH is configured by a first higher layer parameter,
a value of a first control resource set (CORESET) pool index corresponds to a CORESET for the PDCCH, and
a value of a second CORESET pool index corresponds to a second higher layer parameter,
first beam information applied to the first PUCCH is determined based on the value of the first CORESET pool index,
second beam information applied to the second PUCCH is determined based on the second higher layer parameter in the second PUCCH resource.

5-6. (canceled)

7. A communication method for a terminal apparatus, the communication method comprising:
receiving a physical downlink control channel (PDCCH) to which downlink control information (DCI) is mapped; and
transmitting a first physical uplink control channel (PUCCH) and a second PUCCH scheduled by the DCI, wherein
a first PUCCH resource for the first PUCCH is indicated by the DCI,
a second PUCCH resource for the second PUCCH is configured by a first higher layer parameter,
a value of a first control resource set (CORESET) pool index corresponds to a CORESET for the PDCCH, and
a value of a second CORESET pool index corresponds to a second higher layer parameter,
first beam information applied to the first PUCCH is determined based on the value of the first CORESET pool index,
second beam information applied to the second PUCCH is determined based on the second higher layer parameter in the second PUCCH resource.
